(19) United States
(12) Patent Application Publication
(10) Pub. No.: US 2026/0174010 A1
(43) Pub. Date: Jun. 25, 2026

(54) LAWN MOWER APPARATUS

(71) Applicant: Greenworks (Jiangsu) Co., Ltd, Changzhou (CN)

(72) Inventors: Yi Xie, Changzhou (CN); Chaoqun Wang, Changzhou (CN); Qunli Wei, Changzhou (CN); Jun Fan, Changzhou (CN); Qing Wu, Changzhou (CN); Yu Mei, Changzhou (CN); Min Ding, Changzhou (CN); Liang Peng, Changzhou (CN); Shu Zhang, Changzhou (CN); Yanqiang Wang, Changzhou (CN)

(21) Appl. No.: 19/537,604

(22) Filed: Feb. 12, 2026

Related U.S. Application Data
(63) Continuation of application No. PCT/CN2024/124803, filed on Oct. 14, 2024.

(30) Foreign Application Priority Data
Oct. 15, 2023 (CN) 202322757338.9
Oct. 15, 2023 (CN) 202322757401.9
Oct. 15, 2023 (CN) 202322757694.0
Oct. 15, 2023 (CN) 202322758226.5
Oct. 15, 2023 (CN) 202322762300.0
Oct. 15, 2023 (CN) 202322764543.8
Oct. 15, 2023 (CN) 202322767991.3
Feb. 7, 2024 (CN) 202420289892.0
Feb. 7, 2024 (CN) 202420289923.2

(51) Int. Cl. A01D 43/063; A01D 34/74

(52) U.S. Cl. CPC A01D 43/063; A01D 34/74; A01D 43/0635

(57) ABSTRACT

A lawn mower apparatus includes a frame, a cutting deck, a cutting blade and a switching mechanism. The cutting deck is mounted on the frame. The cutting deck forms a grass cutting chamber internally. The grass cutting chamber has a first grass discharge opening. The cutting blade is rotatably mounted within the grass cutting chamber for performing grass cutting operations. The switching mechanism is mounted on the cutting deck. The switching mechanism has a first state and a second state. In the first state, the switching mechanism closes the first grass discharge opening to prevent grass clippings from discharging through the first grass discharge opening. In the second state, the switching mechanism opens the first grass discharge opening to allow grass clippings to discharge through the first grass discharge opening for grass collection operations.

### CROSS REFERENCE TO RELATED APPLICATIONS

The present application is a Continuation Application of PCT Application No. PCT/CN2024/124803 filed on Oct. 14, 2024, which claims the benefit of Chinese Patent Application Nos. 202322757338.9, 202322757694.0, 202322757401.9, 202322764543.8, 202322758226.5, 202322762300.0, 202322767991.3 filed on Oct. 15, 2023, and 202420289892.0 and 202420289923.2 filed on Feb. 7, 2024. All the above are hereby incorporated by reference in their entirety.

### FIELD

The present invention is related to a lawn mower apparatus, and more particularly related to a lawn mower apparatus with flexible design.

### BACKGROUND

A lawn mower is a mechanical device used to cut grass to an even height, typically powered by either electricity or gasoline. It comes in various forms, from the simple manual reel mowers to more advanced ride-on mowers that are suited for larger lawns. The basic functionality of a lawn mower involves spinning blades that shear the grass as the machine moves over the lawn. For American households, maintaining a lawn has become a symbol of pride and aesthetic appeal, with lush, well-manicured lawns seen as part of the ideal suburban life.

In America, lawn maintenance is more than just a personal preference; it is deeply integrated into community standards and social norms. Many neighborhoods have homeowner associations that set specific guidelines for lawn care, making mowing an essential regular task. Well-kept lawns contribute to curb appeal, which is important for property values and overall neighborhood satisfaction. The simple act of mowing the lawn can also serve as a form of outdoor exercise and a way to enjoy some fresh air.

Despite its importance, mowing the lawn can be a time-consuming task, especially when life gets busy. Many Americans juggle full-time jobs, family responsibilities, and other personal commitments, leaving little time for chores like lawn care. For those with larger yards or more complex landscapes, maintaining the lawn can quickly become overwhelming. During peak growing seasons, lawns need frequent mowing, adding pressure to an already packed schedule. This has led many to seek professional help, hiring landscaping services to keep their lawns in check.

The professional lawn care industry plays a vital role in helping busy homeowners manage this responsibility. Professionals have the tools, experience, and efficiency to quickly mow lawns and handle additional services like edging, trimming, and fertilizing. By outsourcing this task, people can focus on other aspects of their life, knowing their lawn will still look its best. This service-based industry has flourished across the U.S., providing jobs and improving quality of life for millions.

One area where innovation can make a difference is in the design of new, more efficient lawn mowers. Traditional lawn mowers, while effective, often require significant manual effort and maintenance. They are sometimes noisy, can be expensive to operate due to fuel costs, and aren't always environmentally friendly. However, recent advancements in electric and robotic lawn mowers are changing the landscape of lawn care. These innovations reduce the physical strain, energy consumption, and environmental impact associated with traditional mowers.

The introduction of robotic lawn mowers, much like robotic vacuums, allows homeowners to automate the process of mowing. These machines can be programmed to cut the lawn on a set schedule, requiring minimal intervention from the user. While they still need to be emptied or maintained periodically, their ability to handle regular mowing tasks can save homeowners hours of time each week. As technology improves, these robots could become even more intelligent, navigating complex landscapes and learning how to optimize the mowing pattern for maximum efficiency.

Furthermore, designing innovative lawn mowers that cater to professional landscapers can make their work easier and more productive. For instance, commercial-grade mowers with advanced navigation systems and automatic sensors could help landscapers tackle large lawns more quickly and safely. Features such as adaptive cutting heights, integrated mulching systems, and energy-efficient engines could significantly reduce operational costs and environmental impact for professionals.

For the average American, a well-designed lawn mower that offers convenience and efficiency could improve daily life in subtle but meaningful ways. It would reduce the amount of time spent on a necessary chore, allowing people to enjoy their weekends without the looming task of lawn care. It would also alleviate the burden on older homeowners or those with mobility issues, giving them greater independence in maintaining their properties.

Ultimately, the evolution of lawn mowers can greatly enhance human life by offering time-saving solutions and contributing to more sustainable, eco-friendly practices. With continued innovation, lawn care could become less of a chore and more of a seamless part of daily life, allowing Americans to maintain the beauty of their homes with minimal effort. An innovative lawn machine that addresses these needs could have a profound impact on how people approach outdoor maintenance, making life a little easier for everyone.

### SUMMARY

In some embodiments, a lawn mower apparatus includes a frame, a cutting deck, a cutting blade and a switching mechanism.

The cutting deck is mounted on the frame.

The cutting deck forms a grass cutting chamber internally.

The grass cutting chamber has a first grass discharge opening.

The cutting blade is rotatably mounted within the grass cutting chamber for performing grass cutting operations.

The switching mechanism is mounted on the cutting deck. The switching mechanism has a first state and a second state.

In the first state, the switching mechanism closes the first grass discharge opening to prevent grass clippings from discharging through the first grass discharge opening.

In the second state, the switching mechanism opens the first grass discharge opening to allow grass clippings to discharge through the first grass discharge opening for grass collection operations.

In some embodiments, the switching mechanism includes a baffle plate and a rotating shaft.

The rotating shaft is rotatably mounted on the cutting deck.

The baffle plate is fixedly connected to the rotating shaft.

When rotated to a first position, the baffle plate blocks the first grass discharge opening.

When rotated away from the first position, the baffle plate opens the first grass discharge opening.

In some embodiments, a positioning structure is provided between the baffle plate and the first grass discharge opening.

In some embodiments, the switching mechanism further includes a handle.

The handle is located on an outer wall of the first grass discharge opening.

The handle is fixedly connected to the rotating shaft.

In some embodiments, the switching mechanism further includes a first limiting portion.

When the baffle plate is in the first position, the handle abuts against the first limiting portion to prevent the baffle plate from leaving the first position.

In some embodiments, the switching mechanism further includes a second limiting portion.

A supporting portion is provided at the first grass discharge opening.

When the baffle plate is in a second position, the baffle plate abuts against the supporting portion.

The handle abuts against the second limiting portion to limit the baffle plate in the second position.

In some embodiments, the handle includes a first connecting portion and a second connecting portion.

One end of the first connecting portion is fixedly connected to the rotating shaft.

The second connecting portion is foldably connected to another end of the first connecting portion.

In some embodiments, an elastic member is provided between the first connecting portion and the second connecting portion.

The elastic member provides a supporting force when the second connecting portion is opened relative to the first connecting portion.

In some embodiments, the cutting deck further has a second grass discharge opening.

The second grass discharge opening is in communication with the grass cutting chamber.

In some embodiments, the second part is electrically connected to a plug-in terminal.

In some embodiments, a first support plate is provided on the steering wheel bracket.

The plug-in terminal is detachably mounted on the first support plate.

In some embodiments, the steering wheel is connected to the steering wheel bracket through a steering wheel shaft.

The steering wheel shaft is fixedly connected to the steering wheel.

A wire harness fixing frame is provided on the steering wheel shaft.

In some embodiments, a support frame is fixedly mounted on the steering wheel bracket.

The second part is positioned above the support frame and abuts against a top wall of the support frame.

In some embodiments, an elongated hole is provided on a top portion of the support frame.

The second part has a mounting portion with a mounting hole.

The mounting hole is connected to the elongated hole through a connecting member.

In some embodiments, a side of the mounting hole penetrates through a side wall of the mounting portion to accommodate position adjustment of the connecting member within the mounting hole.

In some embodiments, the display component includes a display screen.

Display icons showing the status of the lawn mower apparatus are provided on the display screen.

In some embodiments, the display component includes control buttons provided around the periphery of the display screen.

In some embodiments, the switching mechanism includes a baffle plate, a handle, and a locking component.

The baffle plate is rotatably mounted within the cutting deck and has a first position that opens the first grass discharge opening and a second position that closes the first grass discharge opening.

The handle is rotatably mounted on an outer wall of the cutting deck and drives the baffle plate to rotate.

The locking component is provided on the baffle plate and/or the cutting deck and locks the baffle plate in the first position and the second position respectively.

In some embodiments, a first opening and a cover plate are provided on the cutting deck.

The first opening is in communication with the first grass discharge opening.

The baffle plate is positioned below the first opening.

The cover plate is capable of covering the first opening.

### BRIEF DESCRIPTION OF DRAWINGS

FIG. 1 illustrates a lawn mower apparatus embodiment.

FIG. 2 illustrates a cutter component example.

FIG. 3 illustrates a side view of the component in FIG. 2.

FIG. 4 illustrates another view of the component in FIG. 2.

FIG. 5 illustrates another view of the component in FIG. 2.

FIG. 6 illustrates a zoom-up view of the component in FIG. 2.

FIG. 7 illustrates another zoom up view of a component in the example of FIG. 2.

FIG. 8 illustrates a component in the example of FIG. 2.

FIG. 9 illustrates a zoom-up view of a component in FIG. 2.

FIG. 10 illustrates a zoom-up view of another component in FIG. 2.

FIG. 11 illustrates a zoom-up view of another component in FIG. 2.

FIG. 12 illustrates a lawn mower apparatus.

FIG. 13 illustrates a zoom-up view of an area of a lawn mower apparatus.

FIG. 14 illustrates a zoom-up view of another area of the lawn mower apparatus in FIG. 1.

FIG. 15 illustrates a zoom-up view of another area of the lawn mower apparatus in FIG. 1.

FIG. 16 illustrates a top view of lawn mower apparatus.

FIG. 17 illustrates a component in the example.

FIG. 18 illustrates a lawn mower embodiment.

FIG. 19 illustrates a lawn mower embodiment loading with an additional component.

FIG. 20 illustrates a lawn mower embodiment that carries another component.

FIG. 21 illustrates a component of the example in FIG. 19.

FIG. 22 illustrates another view of the component in FIG. 21.

FIG. 23 illustrates is a partial enlarged view of the area A in FIG. 22.

FIG. 24 illustrates is a schematic diagram of the grass collection bag in one embodiment of the utility model lawn mower.

FIG. 25 illustrates is a schematic diagram of the installation of the mounting plate and the supporting member in one embodiment of the utility model lawn mower.

FIG. 26 illustrates is a side view of FIG. 25.

FIG. 27 illustrates is a schematic diagram of the supporting member in one embodiment of the utility model lawn mower.

FIG. 28 illustrates is a side view of FIG. 27.

FIG. 29 illustrates is a schematic diagram of the overall structure of the installed cover plate in one embodiment of the utility model lawn mower.

FIG. 30 illustrates is a schematic diagram of an exemplary lawn mower in this application.

FIG. 31 illustrates is a schematic diagram of an exemplary lawn mower from another angle in this application.

FIG. 32 illustrates is a schematic diagram of the grass conveying tube connected to the lawn mower in this application.

FIG. 33 illustrates is a schematic diagram of an exemplary mounting plate in this application.

FIG. 34 illustrates is a schematic diagram of an exemplary grass conveying tube structure in this application.

FIG. 35 illustrates is a schematic diagram of an exemplary fixing device when the first buckle is in the first position in this application.

FIG. 36 illustrates is a schematic diagram of an exemplary fixing device from another angle when the first buckle is in the first position in this application.

FIG. 37 illustrates is a top view of an exemplary fixing device when the first buckle is in the first position in this application.

FIG. 38 illustrates is a sectional view of A-A in FIG. 37 in this application.

FIG. 39 illustrates is a schematic diagram of an exemplary fixing device when the first buckle is in the second position in this application.

FIG. 40 illustrates is a schematic diagram of an exemplary fixing device from another angle when the first buckle is in the second position in this application.

FIG. 41 illustrates is a top view of an exemplary fixing device when the first buckle is in the first position in this application.

FIG. 42 illustrates is a sectional view of B-B in FIG. 41 in this application.

FIG. 43 illustrates is a schematic diagram of an exemplary first buckle in this application.

FIG. 44 illustrates is a schematic diagram of an exemplary main body part in this application.

FIG. 45 illustrates is a schematic diagram of an exemplary lawn mower in this application.

FIG. 46 illustrates is a schematic diagram of an exemplary lawn mower from another angle in this application.

FIG. 47 illustrates is a schematic diagram of a partial structure of an exemplary lawn mower in this application.

FIG. 48 illustrates is a schematic diagram of a partial structure of an exemplary lawn mower after removing the casing in this application.

FIG. 49 illustrates is a schematic diagram of the front partial structure of an exemplary lawn mower in this application.

FIG. 50 illustrates is a schematic diagram of the front partial structure of an exemplary lawn mower from another angle in this application.

FIG. 51 illustrates is an enlarged view of area A in FIG. 50 in this application.

FIG. 52 illustrates is a schematic diagram of an exemplary support frame in this application.

FIG. 53 illustrates is an enlarged view of area B in FIG. 47 in this application.

FIG. 54 illustrates is a schematic diagram of an exemplary display screen showing indications in this application.

FIG. 55 illustrates is a schematic diagram of an exemplary display screen showing the power interface icon lighting up in this application.

FIG. 56 illustrates is a schematic diagram of an exemplary display screen when the lights are on in this application.

FIG. 57 illustrates is a schematic diagram of the structure of a parking device in one embodiment of the utility model.

FIG. 58 illustrates is a schematic diagram of the connection between the connecting arm, link, and cantilever in one embodiment of the parking device in the utility model.

FIG. 59 illustrates is a schematic diagram of the cooperation between the first locking member and the second locking member in one embodiment of the parking device in the utility model.

FIG. 60 illustrates is a schematic diagram of the overall structure of a lawn mower vehicle in one embodiment of the utility model.

FIG. 61 illustrates is a schematic diagram of the installation position of the parking device after removing some structures in the lawn mower vehicle in one embodiment of the utility model.

FIG. 62 illustrates is an enlarged view of area A in FIG. 61 in this application.

FIG. 63 illustrates is a three-dimensional overall structure diagram of a lawn mower system in one embodiment of the utility model.

FIG. 64 illustrates is a schematic diagram of the cutting deck structure in one embodiment of the lawn mower in the utility model.

FIG. 65 illustrates is another angle view of the cutting deck structure in one embodiment of the lawn mower in the utility model.

FIG. 66 illustrates is a schematic diagram of the structure when the baffle is in the first position in one embodiment of the lawn mower in the utility model.

FIG. 67 illustrates is a schematic diagram of the structure with part of the first side wall removed when the baffle is in the first position in one embodiment of the lawn mower in the utility model.

FIG. 68 illustrates is a partial enlarged view of area A in FIG. 67 in the utility model.

FIG. 69 illustrates is a partial structure diagram when the first locking member is in the first limit position in one embodiment of the lawn mower in the utility model.

FIG. 70 illustrates is a partial structure diagram when the first locking member is in the second limit position in one embodiment of the lawn mower in the utility model.

FIG. 71 illustrates is a partial enlarged view of area B in FIG. 70 in the utility model.

FIG. 72 illustrates is a schematic diagram of the structure when the baffle is in the second position in one embodiment of the lawn mower in the utility model.

FIG. 73 illustrates is a sectional view of the partial structure when the baffle is in the second position in one embodiment of the lawn mower in the utility model.

FIG. 74 illustrates is a partial enlarged view of area C in FIG. 73 in the utility model.

FIG. 75 illustrates is a schematic diagram of the installation position of the locking assembly on the baffle in one embodiment of the lawn mower in the utility model.

FIG. 76 illustrates is a partial structure diagram of the locking assembly in one embodiment of the lawn mower in the utility model.

FIG. 77 illustrates is a schematic diagram of the pressing part in the retracted state within the accommodating cavity in one embodiment of the lawn mower in the utility model.

FIG. 78 illustrates is a partial sectional view of the installation structure of the rotary arm on the handle in one embodiment of the lawn mower in the utility model.

FIG. 79 illustrates is a schematic diagram of the first opening position in one embodiment of the lawn mower in the utility model.

FIG. 80 illustrates is a schematic diagram of the connection between the baffle and the handle in one embodiment of the lawn mower in the utility model.

FIG. 81 illustrates is a three-dimensional overall structure diagram of a lawn mowing system in one embodiment of the utility model.

FIG. 82 illustrates is a schematic diagram of the structure when the side discharge port on the cutting deck is open in one embodiment of the lawn mower in the utility model.

FIG. 83 illustrates is a schematic diagram of the structure when the side discharge port on the cutting deck is closed in one embodiment of the lawn mower in the utility model.

FIG. 84 illustrates is a schematic diagram of the installation position between the baffle and the handle when the baffle is in the open state in one embodiment of the lawn mower in the utility model.

FIG. 85 illustrates is a partial sectional view when the baffle is in the closed state in one embodiment of the lawn mower in the utility model.

FIG. 86 illustrates is a partial enlarged view of area A in FIG. 82 in the utility model.

FIG. 87 illustrates is a partial structure diagram of the first slot on the grass discharge duct in one embodiment of the lawn mower in the utility model.

FIG. 88 illustrates is a partial structure diagram of the handle in one embodiment of the lawn mower in the utility model.

FIG. 89 illustrates is a partial sectional view when the baffle is in the open state in one embodiment of the lawn mower in the utility model.

FIG. 90 illustrates is a partial enlarged view of area C in FIG. 89 in the utility model.

FIG. 91 illustrates is a schematic diagram of the installation position between the handle and the support base in one embodiment of the lawn mower in the utility model.

FIG. 92 illustrates is a partial enlarged view of area B in FIG. 84 in the utility model.

FIG. 93 illustrates is a partial structure diagram of the support slope set on the baffle in one embodiment of the lawn mower in the utility model.

FIG. 94 illustrates is a schematic diagram of another angle of the installation position between the handle and the support base in one embodiment of the lawn mower in the utility model.

FIG. 95 illustrates is a schematic diagram of the installation position of the side discharge port on the housing in one embodiment of the lawn mower in the utility model.

FIG. 96 illustrates is a three-dimensional overall structure diagram of a lawn mowing system in one embodiment of the utility model.

FIG. 97 illustrates is a three-dimensional structure diagram of the side discharge port in the open state in one embodiment of the lawn mower in the utility model.

FIG. 98 illustrates is a schematic diagram of the structure of the baffle opening the grass discharge duct in one embodiment of the lawn mower in the utility model.

FIG. 99 illustrates is a schematic diagram of the structure of the baffle closing the grass discharge duct in one embodiment of the lawn mower in the utility model.

FIG. 100 illustrates is a schematic diagram of the position where the mounting through hole is provided on the grass discharge duct in one embodiment of the lawn mower in the utility model.

FIG. 101 illustrates is a partial sectional view of the baffle opening the grass discharge duct in one embodiment of the lawn mower in the utility model.

FIG. 102 illustrates is a partial enlarged view of area A in FIG. 101 in the utility model.

FIG. 103 illustrates is a schematic diagram of the installation position between the handle and the baffle in one embodiment of the lawn mower in the utility model.

FIG. 104 illustrates is a partial view of the installation position between the handle, the first locking body, and the baffle in one embodiment of the lawn mower in the utility model.

FIG. 105 illustrates is a schematic diagram of the installation position of the first elastic reset member on the handle in one embodiment of the lawn mower in the utility model.

FIG. 106 illustrates is a partial sectional view of the baffle closing the grass discharge duct in one embodiment of the lawn mower in the utility model.

FIG. 107 illustrates is a partial enlarged view of area B in FIG. 105 in the utility model.

FIG. 108 illustrates is a schematic diagram of the position of the side discharge port on the housing in one embodiment of the lawn mower in the utility model.

### DETAILED DESCRIPTION

An embodiment of the lawn mower apparatus includes a switching mechanism mounted on the cutting deck. The switching mechanism has a first state and a second state. When the switching mechanism is in the first state, the first grass discharge opening is disconnected from the grass collection bag, preventing grass clippings from discharging through the first grass discharge opening. This allows for mulching operations or side discharge operations. When the switching mechanism is in the second state, the first grass discharge opening is connected to the grass collection bag for grass collection operations.

With this configuration, the lawn mower can switch between different working modes by simply transitioning the switching mechanism between the first state and the second state. During the transition, only the switching mechanism as a whole needs to be operated, rather than manipulating multiple parts individually. This reduces the time required to switch between working modes, thereby improving the mowing efficiency of the lawn mower.

Furthermore, since the switching mechanism is mounted on the cutting deck, there is no need to repeatedly install and remove the switching mechanism when changing working modes. This further saves time and improves the operational efficiency of the lawn mower.

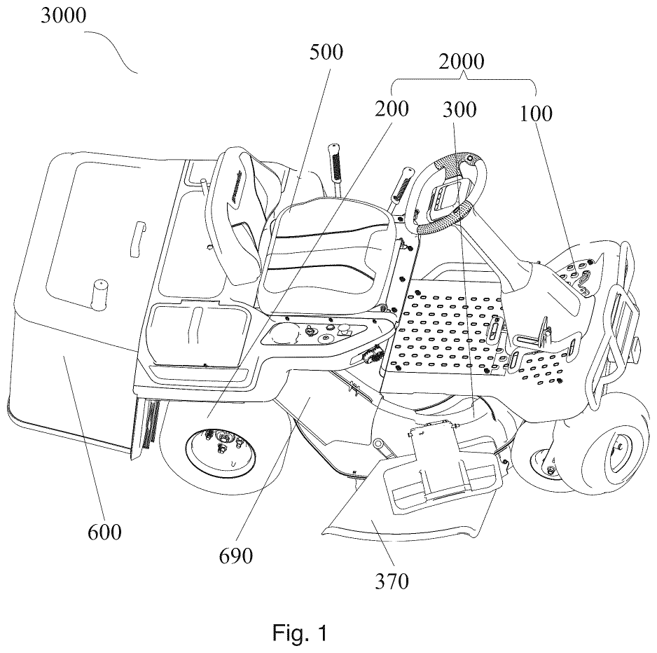

Please refer to FIG. 1 to FIG. 11. An embodiment provides a lawn mower 2000 and a lawn mowing system 3000. The lawn mower 2000 includes a switching mechanism 340 mounted on the cutting deck 300. When the switching mechanism 340 is in the first state, it closes the first grass discharge opening 311 to prevent grass clippings from discharging through the first grass discharge opening 311. When the switching mechanism 340 is in the second state, it opens the first grass discharge opening 311 for grass collection operations. This configuration allows the lawn mower 2000 to save time when switching between different working modes, thereby improving its operational efficiency.

Please refer to FIG. 1. The embodiment provides a lawn mowing system that includes a lawn mower 2000 and a grass collection bag 600. The grass collection bag 600 is installed on the lawn mower 2000 and connected to it. The connection can be made through an interface on the grass collection bag 600 itself, or through an interface extending from the lawn mower 2000, or by setting up an additional grass discharge chute 690. The grass discharge chute 690 connects one end to the grass collection bag 600 and the other end to the lawn mower 2000, allowing grass clippings cut by the lawn mower 2000 to be transported through the grass discharge chute 690 into the grass collection bag 600 for centralized processing. This lawn mowing system 3000 integrates the lawn mower 2000 and grass collection bag 600 into a compact structure, capable of automatically processing grass clippings generated during mowing, thereby reducing the workload of on-site workers. It should be noted that the specific installation structure of the grass collection bag 600 and grass discharge chute 690 on the frame can refer to existing structures and will not be described further here.

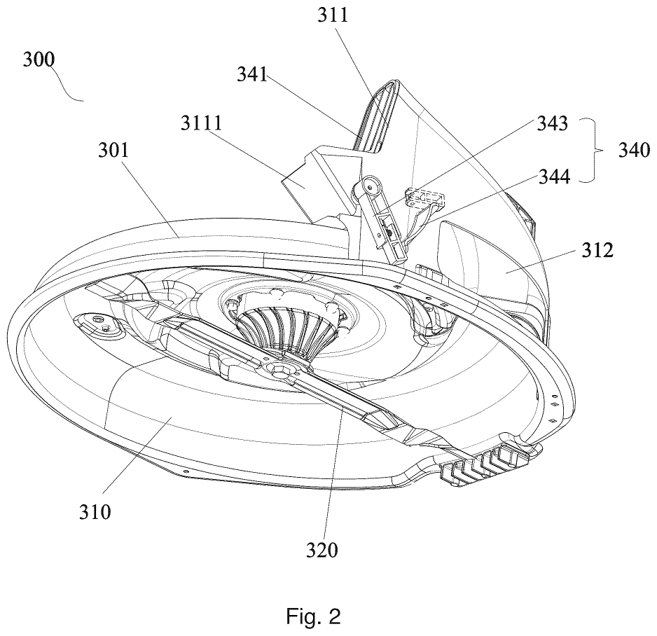

Please refer to FIG. 1 and FIG. 2 for a further description of the lawn mower 2000 in the above embodiment. The lawn mower 2000 includes: a frame 100, a cutting assembly, and a switching mechanism 340. The cutting assembly includes a cutting deck 300 and a cutting blade 320. The frame 100 is equipped with a walking mechanism 200, and may or may not have a seat 500 installed. In this embodiment, to improve the driver's comfort, a seat 500 is installed on the frame 100; the specific structure of the frame 100 is not limited. The walking mechanism 200 is installed on the frame 100 to drive the frame's movement. It may include components such as a drive unit and a power supply unit. The power supply unit provides energy to the drive unit and can be a battery, a diesel engine, a gasoline engine, or a hybrid engine. The drive unit provides power for the rotation of the walking wheels and can be an electric motor, an electric motor+reducer, an electric motor+gear rack transmission mechanism, or an electric motor+screw and nut transmission mechanism, or any transmission mechanism that meets the requirements. The walking mechanism 200 controls the corresponding walking actions of the frame 100. The cutting deck 300 is installed on the frame 100 for corresponding mowing operations. The installation position of the cutting deck 300 on the frame 100 is not limited; for example, it can be installed at the front end of the frame 100, in the middle of the frame 100, or at the rear end of the frame 100, as long as it meets the installation requirements for mowing operations.

Please refer to FIG. 2 to FIG. 4 for a further description of the cutting deck 300. The cutting deck 300 includes a housing 301, which is fixedly connected to the bottom of the frame by, but not limited to, bolts. The interior of the housing 301 forms a grass cutting chamber 310, and a first grass discharge opening 311 is provided on the grass cutting chamber 310. The first grass discharge opening 311 can be set on the side wall of the grass cutting chamber 310 or on the top wall of the grass cutting chamber 310, which is not restricted. In this embodiment, the first grass discharge opening 311 is set on the top wall of the grass cutting chamber 310. The specific cross-sectional shape and area of the first grass discharge opening 311 are not limited, as long as it allows the discharge of cut grass clippings.

The cutting blade 320 is rotatably mounted on the housing 301 and located inside the grass cutting chamber 310. The rotatable mounting method is not limited and can be through an electric motor rotation, an electric motor+reducer rotation, or an electric motor+gear transmission rotation, etc. When the cutting blade 320 rotates, it cuts the grass inside the grass cutting chamber 310 to perform the mowing operation. The switching mechanism 340 is installed on the housing 301, near the position of the first grass discharge opening 311. The switching mechanism 340 has a first state and a second state. In the first state, the switching mechanism 340 closes the first grass discharge opening 311 to prevent grass clippings from discharging through the first grass discharge opening. In the second state, the switching mechanism 340 opens the first grass discharge opening 311 for grass collection operations. The method of switching between the first state and the second state is not limited. For example, the switching mechanism 340 can rotate a certain angle from the first state to become the second state, or it can translate a certain distance from the first state to become the second state, as long as it ensures that the switching mechanism 340 can close the first grass discharge opening 311 in the first state and open the first grass discharge opening 311 in the second state.

By setting up the switching mechanism 340 on the housing 301, the lawn mower 2000 can switch between different operating modes by simply controlling the switching mechanism 340 to transform between the first state and the second state. This setup only requires operating the switching mechanism 340 as a whole during operation, without the need to operate multiple parts individually in sequence, thus saving time in switching between different operating modes. Correspondingly, it can improve the mowing efficiency of the lawn mower 2000. At the same time, because the switching mechanism 340 is set on the housing 301, there is no need to repeatedly install and disassemble the switching mechanism 340 during the conversion process between different working modes, so it can further save time and improve the operational efficiency of the lawn mower 2000.

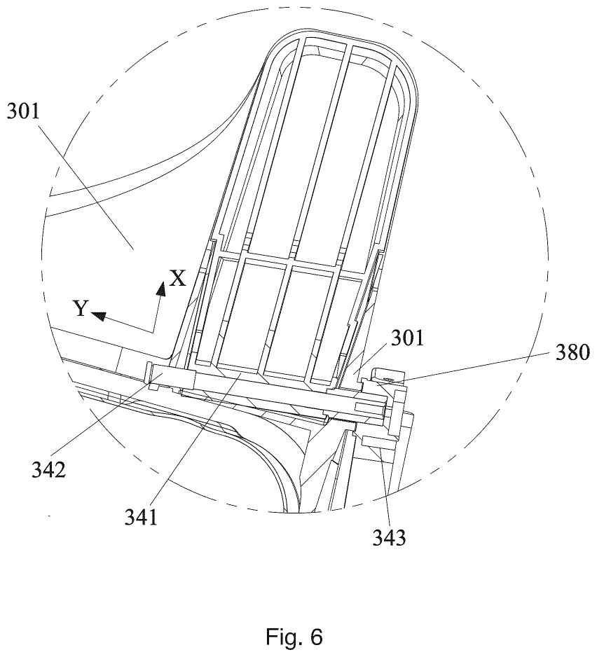

Please refer to FIG. 2 to FIG. 6. In one example of this embodiment of the lawn mower 2000, the switching mechanism 340 includes a baffle plate 341 and a rotating shaft 342. The rotating shaft 342 is rotatably installed on the housing 301, and the rotating shaft 342 passes through the side wall of the first grass discharge opening 311 along its length direction. The rotatable installation method is not limited; it can be through bearing rotation connection or shaft-hole clearance fit rotation connection, etc. In this embodiment, along the height direction of the cutting deck 300, the rotating shaft 342 is positioned at the lower edge of the first grass discharge opening 311. The middle part of the rotating shaft 342 in the length direction is inside the first grass discharge opening 311, and the middle part of the rotating shaft 342 is fixedly connected to one end of the baffle plate 341 in the length direction (as shown by the X-axis in FIG. 6). The fixed connection method is not limited; it can be welding connection or bolt connection, or it can be an integrated molding connection or injection molding connection, etc. Both ends of the rotating shaft 342 in the length direction extend to the outside of the side wall of the first grass discharge opening 311 in the width direction (as shown by the Y-axis in FIG. 6).

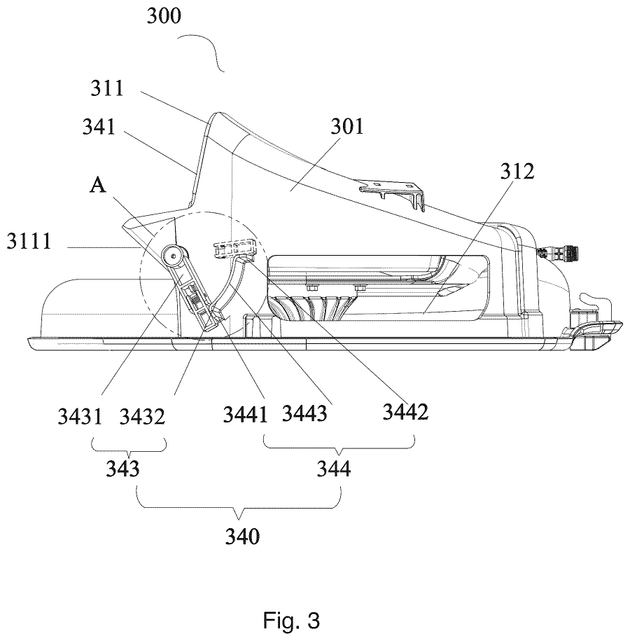

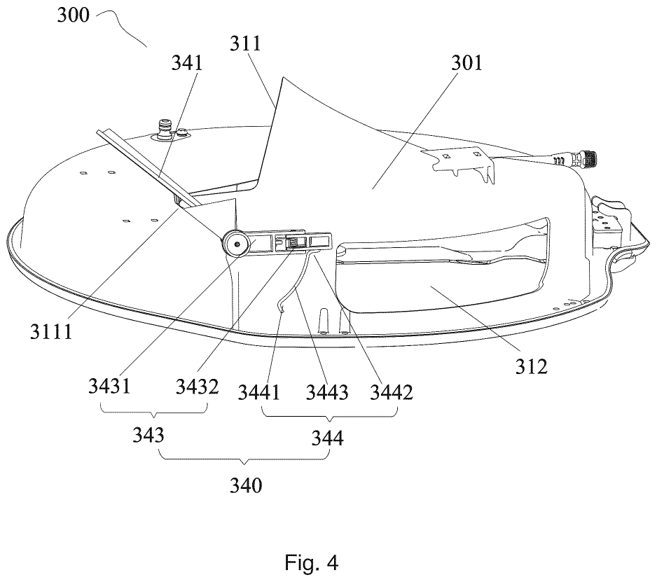

In this embodiment, the baffle plate 341 is rotatably installed near the position of the first grass discharge opening 311, which facilitates the movement of the baffle plate 341 relative to the first grass discharge opening 311. The baffle plate 341 has at least a first position and a second position on the housing 301. When the baffle plate 341 is in the first position (as shown in FIG. 3), correspondingly, the switching mechanism 340 is in the first state. At this time, the baffle plate 341 completely blocks the first grass discharge opening 311 to prevent grass clippings from discharging through the first grass discharge opening 311, causing the lawn mower 2000 to stop grass collection operations. When the baffle plate rotates away from the first position, it opens the first grass discharge opening. When the baffle plate 341 is in the second position (as shown in FIG. 4), correspondingly, the switching mechanism 340 is in the second state. At this time, the baffle plate 341 completely opens the first grass discharge opening 311, and the first grass discharge opening 311 is in its maximum open state, allowing the lawn mower 2000 to enter the grass collection operation mode.

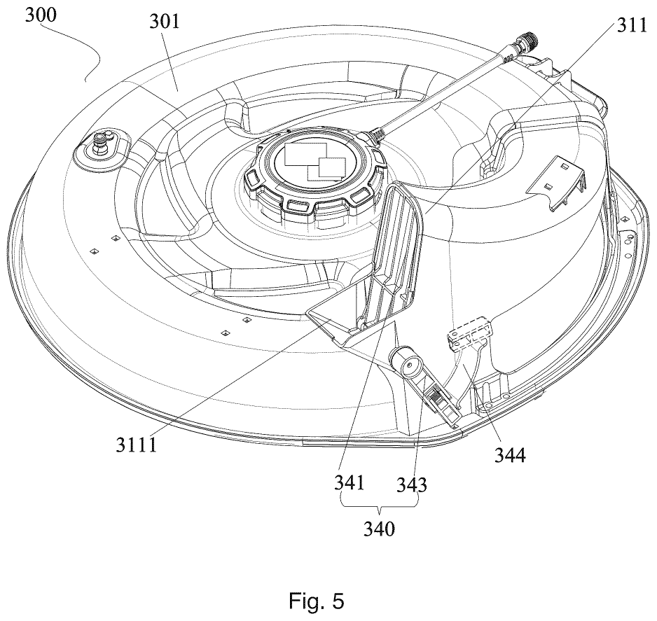

Referring to FIG. 5 to FIG. 8, in this example of the practical new lawnmower 2000, a positioning structure 350 is set between the baffle plate 341 and the first grass discharge port 311. The positioning structure 350 can be set on the baffle plate 341, or on the shell 301 at the first grass discharge port 311, or partially on the baffle plate 341 and partially on the shell 301 at the first grass discharge port 311. The positioning structure 350 can be a protrusion and groove interlocking structure, or a cone surface and cone hole positioning structure 350, or any structure that can provide positioning when the baffle plate 341 blocks the first grass discharge port 311. In this embodiment, the positioning structure 350 includes a blocking edge 351, which is set around the circumferential side wall of the baffle plate 341. The blocking edge 351 can be an integral structure or multiple block structures, as long as it can serve as a stop. In this embodiment, the blocking edge 351 is a semi-enclosed structure continuously set along the circumferential side wall of the baffle plate 341; and when the baffle plate 341 is in the first position, the blocking edge 351 abuts against the end face of the first grass discharge port 311, limiting the baffle plate 341 to the end face position of the first grass discharge port 311, thus playing a positioning role when the baffle plate 341 blocks the first grass discharge port 311, which can ensure the blocking effect of the blocking edge 351 on the first grass discharge port 311.

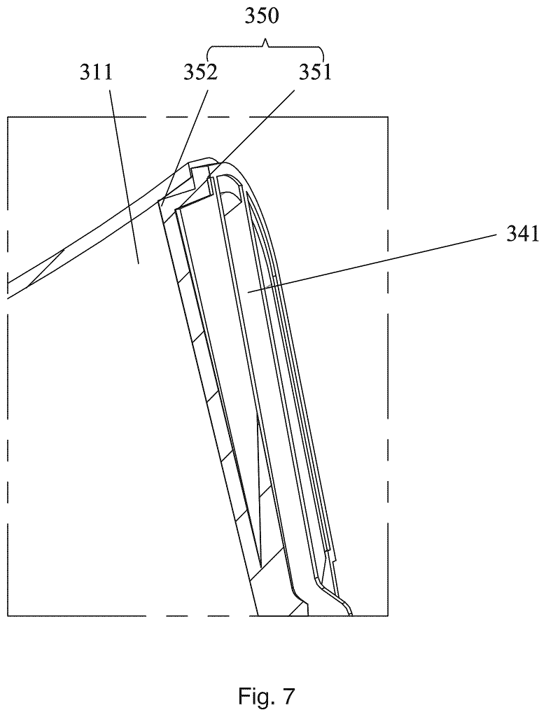

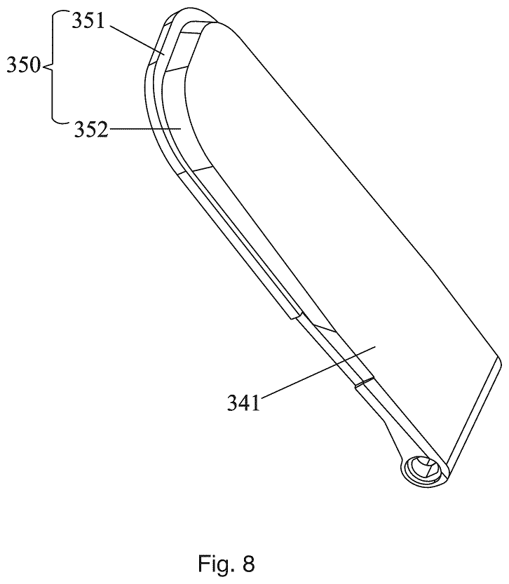

Furthermore, referring to FIG. 7 and FIG. 8, the positioning structure 350 also includes a protrusion 352. Along the extension direction of the protrusion 352, its cross-section gradually decreases, and the end with a larger cross-section of the protrusion 352 is connected to the side of the baffle plate 341 facing the first grass discharge port 311. When the baffle plate 341 is in the first position, the protrusion 352 interlocks with the inner side wall of the first grass discharge port 311. By setting up the protrusion 352, it can serve as a guide when the baffle plate 341 contacts the first grass discharge port 311, providing a positioning calibration during the rotation of the baffle plate 341, reducing lateral deviation during the rotation of the baffle plate 341, ensuring both the smoothness of the blocking edge 351's rotation and the repeated blocking precision of the baffle plate 341 on the first grass discharge port 311.

Referring to FIG. 3, in this example of the practical new lawnmower 2000, the switching mechanism 340 also includes a first limiting part 3441, which is fixedly connected to the shell 301 by means such as bolts, and installed near the handle 343 position. When the baffle plate 341 is in the first position, the handle 343 abuts against the first limiting part 3441, and the first limiting part 3441 exerts a first torque on the handle 343 that presses the baffle plate 341 tightly against the end face of the first grass discharge port 311, thus preventing the baffle plate 341 from leaving the first position. The specific structure of the first limiting part 3441 is not limited, as long as it serves to abut against the handle 343 when the baffle plate 341 is in the first position. By setting up the first limiting part 3441, the baffle plate 341 can be kept in the first position, reducing the probability of the baffle plate 341 shifting from the first position when the lawnmower 2000 is subjected to external forces during operation, thereby ensuring the grass-mulching effect.

Referring to FIG. 4, in this example of the practical new lawn mower 2000, the switching mechanism 340 also includes a second limiting part 3442. The second limiting part 3442 is fixedly connected to the housing 301 by means such as bolts, and is installed near the handle 343 position. The first grass discharge port 311, near the lower end of the mowing deck 300, is also provided with a support part 3111. The support part 3111 is integrally formed with the housing 301. The support part 3111 and the end face of the first grass discharge port 311 are set at an angle along the axis of the rotating shaft 342. When the baffle plate 341 is in the second position, the baffle plate 341 abuts against the support part 3111, thereby causing the support part 3111 to generate an upward supporting force under the baffle plate 341, preventing the baffle plate 341 from rotating downward under gravity. At the same time, the handle 343 abuts against the second limiting part 3442, and the second limiting part 3442 produces a second torque on the handle 343 that presses the baffle plate 341 against the support part 3111, thereby limiting the baffle plate 341 to the second position. The specific structure of the second limiting part 3442 is not limited, as long as it provides a supporting effect on the handle 343 when the baffle plate 341 is in the second position. By setting up the second limiting part 3442, the baffle plate 341 can be maintained in the second position, reducing the probability of the baffle plate 341 lifting off and displacing from the support part 3111 at the second position when the lawn mower 2000 is subjected to external forces during operation. This ensures the stability of the opening size of the first grass discharge port 311, thereby maintaining consistent grass discharge efficiency.

It should be noted that the first limiting part 3441 and the second limiting part 3442 can be separate parts installed individually on the housing, or they can be two portions of a single part. Any structure that can fixedly connect the first limiting part 3441 and the second limiting part 3442 to the housing is acceptable. In this embodiment, for ease of installation, the switching structure includes a limiting member 344. The limiting member 344 includes a main body part 3443, with the first limiting part 3441 and the second limiting part 3442 fixedly connected to the main body part 3443. The fixed connection method can be welding, bolt connection, or integral bending formation, or any other fixed connection structure. In this embodiment, the first limiting part 3441 and the second limiting part 3442 are connected to the main body part 3443 through bending formation.

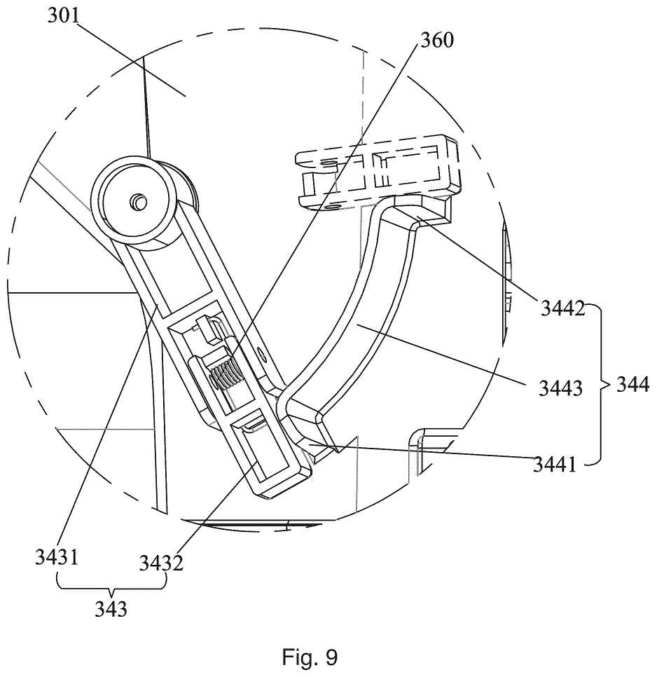

Please refer to FIG. 6 and FIG. 9. In this example of the practical new lawn mower 2000, the handle 343 includes a first connecting part 3431 and a second connecting part 3432. One end of the first connecting part 3431 is fixedly connected to the rotating shaft 342. The fixed connection method is not limited and can be welded, bolted, integrally formed, or injection molded, etc. The second connecting part 3432 is foldably connected to the other end of the first connecting part 3431, allowing it to fold and avoid the limiting member 344 during the switching process between the first state and the second state, and then open to abut against the first limiting portion 3441 or the second limiting portion 3442 for positioning after switching is complete.

There are multiple options for the foldable connection method. For example, it can be a folding connection through a rotating shaft+slot, a hinged folding connection, or a multi-link telescopic folding connection. This embodiment does not impose specific restrictions on this.

The folding direction of the second connecting part 3432 relative to the first connecting part 3431 can be along the rotation direction of the rotating shaft 342 or perpendicular to the rotation direction of the rotating shaft 342. In this embodiment, the second connecting part 3432 folds relative to the first connecting part 3431 in a direction perpendicular to the rotation axis of the rotating shaft 342. This arrangement ensures that when the second connecting part 3432 abuts against the first limiting portion 3441 or the second limiting portion 3442, the resulting abutting force is perpendicular to the plane of the folding and opening direction of the second connecting part 3432. Consequently, it does not affect the folding and opening effect, thereby ensuring the stability of the second connecting part 3432 when it is opened relative to the first connecting part 3431, and guaranteeing the limiting effect between the limiting member 344 and the handle 343.

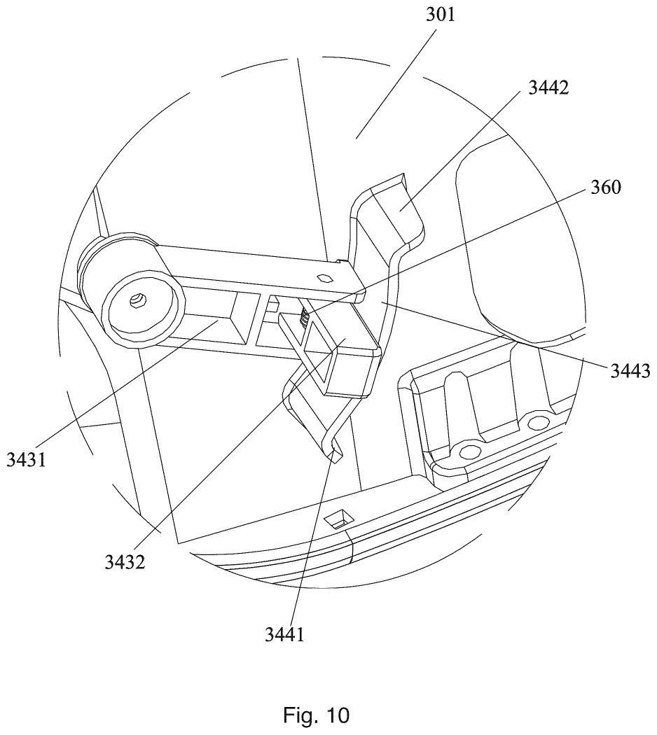

Please refer to FIG. 9 and FIG. 10. Specifically, in this embodiment, the main body 3443 of the limiting member 344 has an arc-shaped structure, with the center of the arc structure located on the rotational axis of the rotating shaft 342. The radial distance L from the inner wall of the arc structure to the rotating shaft 342 is greater than the radial length of the handle 343 when the second connecting part 3432 is in a folded state, but less than the radial length of the handle 343 when the second connecting part 3432 is opened. This allows the handle 343 to rotate inside the arc structure when the second connecting part 3432 is folded. When the baffle 341 reaches the first position or the second position, the second connecting part 3432 is opened, allowing the second connecting part 3432 on the handle 343 to abut against the first limiting portion 3441 or the second limiting portion 3442. This arrangement makes the structure more compact and aesthetically pleasing.

Referring to FIG. 9 and FIG. 10, in this example of the utility model lawn mower 2000, an elastic member 360 is set between the first connecting part 3431 and the second connecting part 3432. The elastic member 360 provides support force when the second connecting part 3432 is opened relative to the first connecting part 3431. The elastic member 360 can be any elastic component such as a tension spring, compression spring, leaf spring, or torsion spring, as long as it can provide support force when the second connecting part 3432 is opened. In this embodiment, the elastic member 360 is a torsion spring. The end of the second connecting part 3432 near the first connecting part 3431 has a receiving cavity, and the torsion spring is set in the receiving cavity. The two ends of the torsion spring have two arm bodies, one of which is hooked on the first connecting part 3431, and the other is engaged with the second connecting part 3432. The torsion axis of the torsion spring is the folding axis of the second connecting part 3432 relative to the first connecting part 3431. When the second connecting part 3432 is in the open state, the torsion spring releases torsion, which provides support force to the second connecting part 3432, keeping it in the open state. When the second connecting part 3432 is in the folded state, the torsion spring stores torsion to provide support force when the second connecting part 3432 is in the open state. By setting up a torsion spring, the second connecting part 3432 can freely switch between folded and open states relative to the first connecting part 3431, with a simple structure and low procurement cost.

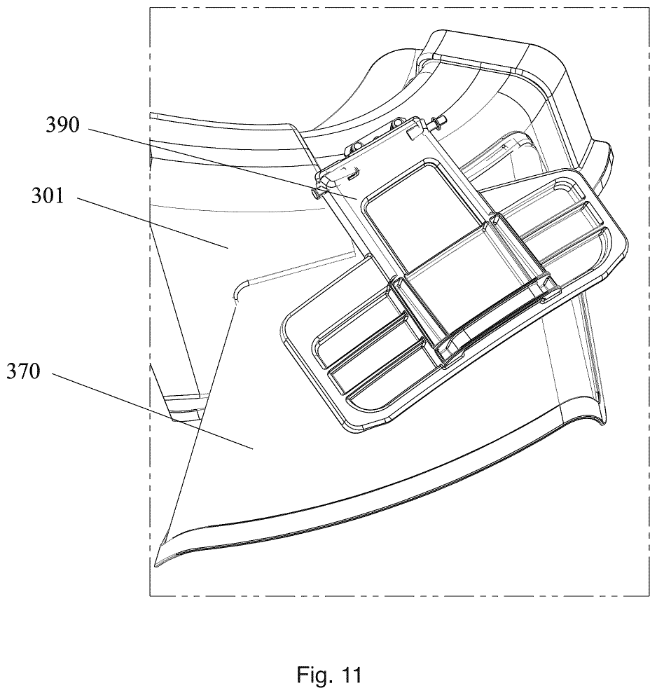

Typically, the bottom of the grass-cutting chamber is an open structure. During the mowing operation of the lawn mower 2000, the grass clippings after cutting can be directly discharged to the working surface through the open bottom of the grass-cutting chamber. However, preferably, referring to FIG. 2, in this example of the utility model lawn mower 2000, the side wall of the shell 301 also has a second grass discharge port 312, which is connected to the grass-cutting chamber 310. The size and specific shape of the second grass discharge port 312 are determined by the specific grass discharge requirements of the lawn mower 2000, which are not specifically restricted here. In this embodiment, the position of the second grass discharge port 312 on the shell 301 is close to the position of the first grass discharge port 311. In other embodiments, it can also be set in other positions. Preferably, referring to FIG. 1, FIG. 2, FIG. 10, and FIG. 11, in this embodiment, a cover 370 and a side baffle 390 are also set at the position of the second grass discharge port 312. The cover 370 is fixedly connected to the shell 301 above the second grass discharge port 312 by, but not limited to, bolts, and extends in the direction away from the outer side wall of the shell 301, thus forming a certain degree of shielding above the second grass discharge port 312. This can reduce the probability of grass clippings and dust splashing during the discharge of grass clippings from the second grass discharge port 312, thereby reducing the dust phenomenon during grass discharge. The side baffle 390 is rotatably connected to the shell 301 above the second grass discharge port 312. The side baffle 390 has a first position and a second position relative to the second grass discharge port 312. When the side baffle 390 is in the first position, it blocks the second grass discharge port 312; when the side baffle 390 is in the second position, it opens the second grass discharge port 312.

In this utility model, when the lawn mower 2000 needs to stop grass collection operation, the second connecting part 3432 of the handle 343 is folded upwards, causing the second connecting part 3432 to disengage from the limiting member 344. The handle 343 is rotated, driving the rotation shaft 342 to turn, which in turn causes the baffle plate 341 to rotate inside the first grass discharge opening 311, with its end face approaching the first grass discharge opening 311. During this approach, the protrusion 352 gradually extends into the first grass discharge opening 311. When the blocking edge 351 abuts against the end face of the first grass discharge opening 311, the baffle plate 341 reaches the first position, blocking the first grass discharge opening 311, putting the switching mechanism 340 in the first state. At this point, the second connecting part 3432 is opened to make it abut against the first limiting part 3441, thereby maintaining the baffle plate 341 in the first position.

If the side baffle plate 390 is rotated to the first position at this time, grass clippings produced during the operation of the lawn mower 2000 can be discharged from the second grass discharge opening 312, facilitating side discharge. It should be noted that when the side baffle plate 390 is rotated to the first position, grass clippings may or may not be discharged from the second grass discharge opening 312, depending on the operational requirements of the lawn mower.

If the side baffle plate 390 is rotated to the second position, the lawn mower 2000 can enter the mulching mode. It should be noted that at this time, the lawn mower may not necessarily enter the mulching mode; it can directly discharge grass clippings from the bottom opening of the grass cutting chamber 310 onto the ground. Whether to engage the mulching mode depends on the mowing operation requirements.

When the lawn mower 2000 needs to perform grass collection operation, the second connecting part 3432 of the handle 343 is folded upwards again, causing it to disengage from the first limiting part 3441. The handle 343 is rotated, driving the rotation shaft 342 to turn, which in turn causes the baffle plate 341 to rotate inside the first grass discharge opening 311, rotating away from the end face of the first grass discharge opening 311. When the baffle plate 341 rotates downward and abuts against the supporting part 3111, it reaches the second position, fully opening the first grass discharge opening 311, putting the switching mechanism 340 in the second state. At this point, the second connecting part 3432 is opened again to make it abut against the second limiting part 3442, thereby maintaining the baffle plate 341 in the second position.

Simultaneously, the side baffle plate 390 is rotated to the second position, blocking the second grass discharge opening 312, and the lawn mower 2000 begins grass collection operation.

This lawn mower 2000, through the setting of the switching mechanism 340 and its coordination with the position of the side baffle plate 390, can achieve conversion between three working modes: grass collection, mulching, and side discharge.

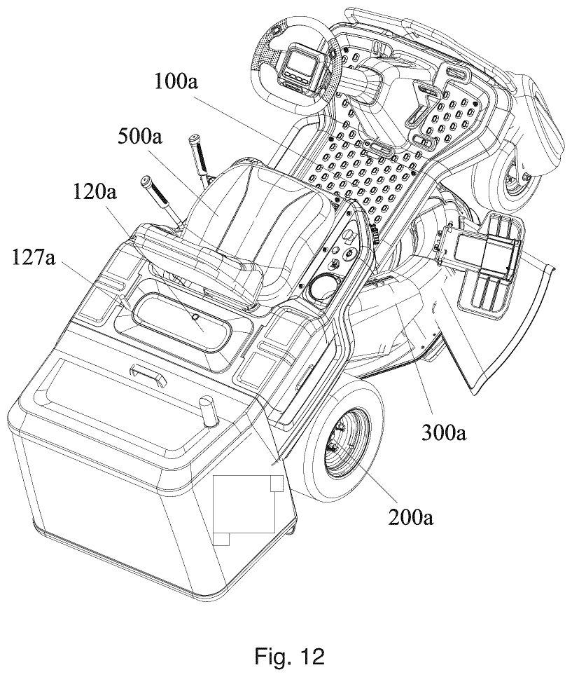

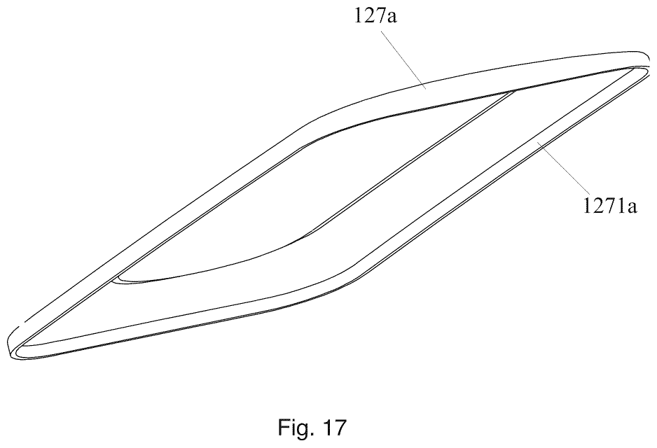

FIG. 12 to FIG. 17 show an embodiment providing a lawn mower and garden tool. A receiving cavity 120a is formed on the frame 100a behind the seat 500a. By placing a spare battery 810a in the receiving cavity 120a, power can continue to be supplied to the lawn mower when its endurance is insufficient, thus reducing efficiency loss due to insufficient battery endurance. Additionally, this arrangement reduces the probability of damage to the spare battery 810a in the receiving cavity 120a, thereby improving the safety of installing the spare battery 810a on the lawn mower.

FIG. 12 shows the lawn mower comprising: a frame 100a, a walking mechanism 200a, and a cutting platform assembly 300a. A seat 500a is arranged on the frame 100a, with the specific structure of the frame 100a being unrestricted. The walking mechanism 200a is installed on the frame 100a to drive the frame 100a's movement. The walking mechanism 200a may include components such as a drive unit and a power supply unit. The power supply unit provides energy to the drive unit and can be a battery, diesel engine, gasoline engine, or hybrid engine. The drive unit provides power for the rotation of the walking wheels and can be an electric motor, electric motor with reducer, electric motor with gear-rack transmission mechanism, or electric motor with screw-nut transmission mechanism, or any transmission mechanism that meets the requirements. The walking mechanism 200a controls the corresponding walking actions of the frame 100a. The cutting platform assembly 300a is installed on the frame 100a to perform corresponding grass-cutting operations. The installation position of the cutting platform assembly 300a on the frame 100a is not limited and can be at the front, middle, or rear of the frame 100a, as long as it meets the installation requirements for grass-cutting operations.

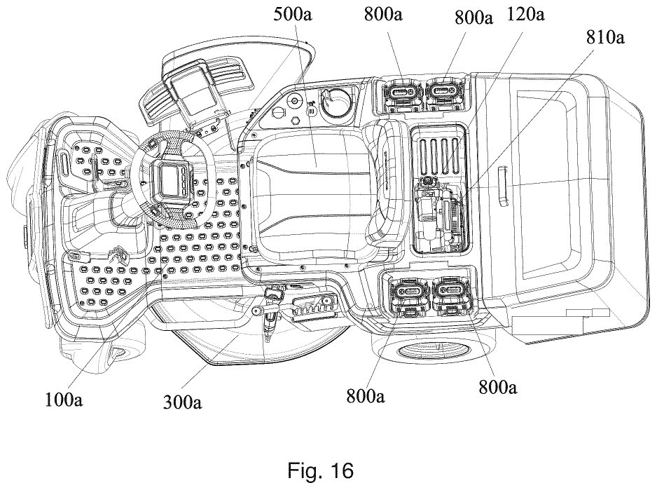

In this embodiment, refer to FIG. 16. The main battery pack 800a is mounted on the frame. The main battery 800a can be set as one or multiple units. In this embodiment, there are four main battery packs 800a, symmetrically arranged on both sides of the seat 500a, with the four main battery packs 800a connected in parallel. The main battery pack 800a provides power for the walking mechanism 200a and the mowing operation of the header assembly 300a. Continuing to refer to FIG. 12 to FIG. 15, a storage cavity 120a is provided on the frame 100a behind the seat 500a in this embodiment. The storage cavity 120a can accommodate at least one spare battery 810a. The spare battery 810a can serve as a range extender battery pack, selectively electrically connected to the main battery pack during the mower's operation to power the entire machine. The spare battery 810a can also be removed from the storage cavity 120a to power other tools as needed, such as handheld mowing tools, handheld sweeping tools, etc. It should be noted that, according to actual needs, the main battery pack 800a can also be removed from the frame 100a to power other tools. Additionally, the main battery pack 800a can have the same capacity and voltage as the spare battery pack 810a, or it can have a different capacity but the same voltage as the spare battery pack 810a, etc.

The specific location of the storage cavity 120a on the frame 100a is not limited. For example, it can be installed on the frame 100a directly behind the seat 500a, or on the frame 100a on both sides behind the seat 500a, etc. In this embodiment, the storage cavity 120a is provided on the frame 100a directly behind the seat 500a, which is conducive to the overall symmetrical design of the mower and facilitates the production and assembly of parts. The specific shape and area size of the storage cavity 120a are not limited, as long as it can accommodate at least the spare battery 810a required by the mower itself. The storage cavity 120a can accommodate one set of spare batteries 810a or multiple sets of spare batteries 810a, with the number placed selected according to the actual operational needs of the mower. In addition to placing the spare battery 810a, the storage cavity 120a can also store some operating tools, such as spare blades for the mower, maintenance tools, or personal protective equipment. The storage cavity 120a can be a separate box structure, fixed and installed on the frame 100 behind the seat 500 by means of bolt connections or welding connections; it can also be integrally formed with the shell on the frame 100 behind the seat 500. In this embodiment, the storage cavity 120a is integrally injection-molded with the shell on the frame 100 behind the seat 500. This configuration makes the structure more compact and gives the storage cavity 120a higher strength and rigidity, which is more conducive to protecting the spare battery 810a inside the storage cavity 120a.

An embodiment provides a lawn mower, wherein a storage cavity 131a is formed on the frame 111a behind the seat 511a. The spare battery 821a is placed in the storage cavity 131a. This arrangement has two advantages: firstly, since the storage cavity 131a is directly set behind the seat 511a, its position does not protrude from the vehicle body, thus maintaining the overall aesthetics of the lawn mower; secondly, compared to the periphery of the frame 111a, the position behind the seat 511a is less likely to be impacted when the lawn mower is hit or bumped, thereby reducing the probability of damage to the spare battery 821a in the storage cavity 131a and improving the safety of installing the spare battery 821a on the lawn mower.

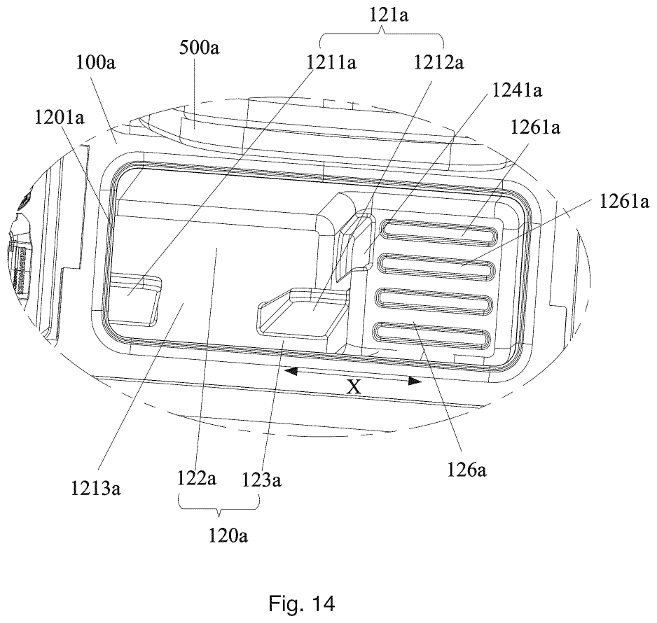

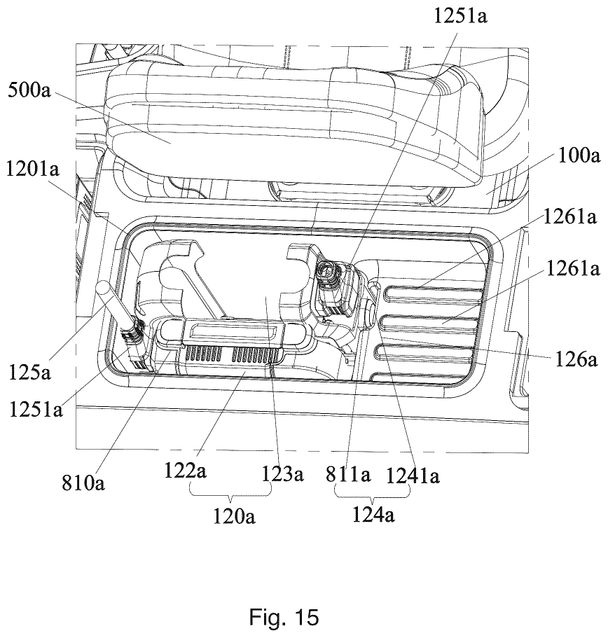

To better improve the space utilization of the storage cavity 131a, preferably, referring to FIG. 14 and FIG. 15, in one example of the lawn mower of an embodiment, a partition plate 132a is set inside the storage cavity 131a. The partition plate 132a divides the storage cavity 131a into a first compartment 133a and a second compartment 134a, with the spare battery 821a accommodated in the first compartment 133a. The partition plate 132a can be fixed in the storage cavity 131a by bolts, welding, or integral molding. In this embodiment, the side wall of the storage cavity 131a is made of plastic material, and the partition plate 132a is integrally injection-molded with the side wall of the storage cavity 131a. This setup facilitates the installation of the partition plate 132a in the storage cavity 131a, and the overall weight of the storage cavity 131a is relatively light, not significantly increasing the overall weight of the lawn mower. By setting up the partition plate 132a, when the spare battery 821a is placed in the first compartment 133a, other operating tools can be placed in the second compartment 134a without causing overlapping stacking with the spare battery 821a in the first compartment 133a, thus reducing potential damage to the spare battery 821a during the placement of operating tools. In another embodiment, operating tools can be placed in the first compartment 133a and the spare battery 821a in the second compartment 134a. In other embodiments, spare batteries 821a can be placed in both the first compartment 133a and the second compartment 134a. In this case, the partition plate 132a can reduce the probability of collision between the spare batteries 821a in the two compartments, preventing damage to the spare batteries 821a.

Please refer to FIG. 14. In an embodiment of the lawn mower, the partition 121a includes a first partition section 1211a and a second partition section 1212a. The installation positions of the first partition section 1211a and the second partition section 1212a in the accommodation cavity 120a are not limited, as long as they can separate the first chamber 122a and the second chamber 123a. In this embodiment, the first partition section 1211a and the second partition section 1212a are symmetrically arranged on the side walls at both ends of the accommodation cavity 120a in the length direction (as shown by the X-axis direction in FIG. 14), and the first partition section 1211a and the second partition section 1212a are spaced apart in the length direction of the accommodation cavity 120a, thereby forming a communication opening 1213a between the first partition section 1211a and the second partition section 1212a. The communication opening 1213a can connect the first chamber 122a and the second chamber 123a on both sides. With this arrangement, on one hand, the first partition section 1211a and the second partition section 1212a are respectively arranged on the side walls of the accommodation cavity 120a, which can serve as reinforcing ribs for the side walls, thus improving the supporting strength of the side walls of the accommodation cavity 120a, and better protecting the spare battery 810a inside the accommodation cavity 120a. On the other hand, the presence of the communication opening 1213a can reduce the wear on the surface of the partition 121a when placing or removing spare batteries 810a or operating tools in the first chamber 122a and the second chamber 123a, ensuring the supporting strength of the partition 121a, and also facilitating heat dissipation of the batteries.

It should be noted that in other embodiments, there may not be a communication opening 1213a between the first partition section 1211a and the second partition section 1212a.

To reduce the probability of movement of the spare battery 810a in the accommodating cavity 120a during the operation of the lawn mower, preferably, referring to FIG. 14 and FIG. 15, in an embodiment of the lawn mower, a positioning mechanism 124a is provided on the side wall of the first chamber 122a. The positioning mechanism 124a has multiple options, such as a card slot 1271a or a protrusion structure, or it can be any structure capable of achieving the positioning installation of the spare battery 810a in the accommodating cavity 120a, such as a locking screw tightening mechanism. In this embodiment, the positioning structure includes a positioning slot 1241a formed on the side wall of the first chamber 122a, and the positioning slot 1241a engages with a corresponding protrusion 811a on the outer contour of the spare battery 810a. The positioning slot 1241a can be formed at any position on the four side walls of the first chamber 122a, as long as it can engage with the corresponding protrusion 811a on the outer contour of the spare battery 810a. In this embodiment, the positioning slot 1241a is formed on one side wall along the length direction of the first chamber 122a and extends downward along the height direction of the accommodating cavity 120a. When the spare battery 810a is installed from top to bottom into the first chamber 122a, the corresponding protrusion 811a on the outer contour of the spare battery 810a slides into the positioning slot 1241a. This arrangement not only provides guidance during the installation process of the spare battery 810a, preventing the spare battery 810a from getting stuck during insertion and removal, but also serves as a positioning function after the spare battery 810a is placed, reducing the probability of displacement and impact damage of the spare battery 810a in the first chamber 122a.

It should be noted that in another embodiment, a positioning slot 1241a can also be formed on the side wall of the second chamber 123a to provide positioning for the spare battery 810a when placed in the second chamber 123a. In other embodiments, positioning slots 1241a can be formed on the side walls of both the first chamber 122a and the second chamber 123a, thus providing positioning for the spare batteries 810a placed in both the first chamber 122a and the second chamber 123a.

Referring to FIG. 15, in an embodiment of the lawn mower, the accommodating cavity 120a also includes a connecting wire 125a. One end of the connecting wire 125a is electrically connected to the control board, and the other end is provided with a plug 1251a for connecting to the backup battery 810a. The control board can be a vehicle control board or a separate control board for the main battery pack, etc. The connection method between the connecting wire 125a and the control board is not limited and can be directly soldered to the wiring terminals of the control board or connected to the wiring position of the control board through a plug-in connection, or any other method that can achieve electrical connection. The specific specifications and models of the plug 1251a at the end of the connecting wire 125a connected to the backup battery 810a are not limited, as long as it matches the socket hole on the backup battery 810a. Inserting the plug 1251a into the socket can achieve electrical connection between the backup battery 810a and the control board. In other embodiments, the connecting wire can also have one end with a plug 1251a for connecting to the backup battery 810a, and the other end connected to other electrical devices, such as the drive motor on the header assembly 300a or the drive motor on the walking mechanism 200a, or any other electrical equipment on the lawn mower. In this embodiment, by setting up the connecting wire 125a and plug 1251a in the accommodating cavity 120a, the circuit of the backup battery 810a can be connected or disconnected by simply plugging or unplugging the plug 1251a, which is simple and convenient to operate. Compared to setting up terminals in the accommodating cavity 120a to connect with corresponding terminals of the backup battery 810a, the connecting wire 125a has a longer service life and is more convenient for maintenance and replacement. Additionally, since there is no need to set up wiring terminals in the accommodating cavity 120a, when placing operating tools in the accommodating cavity 120a, there is no risk of damaging the wiring terminals, making it more convenient to store operating tools in the accommodating cavity 120a.

Referring to FIG. 14 and FIG. 15, in an embodiment of the lawn mower, the accommodating cavity 120a also includes a recessed portion 126a. The recessed portion 126a is located in an area outside the first chamber 122a and the second chamber 123a. The recessed portion 126a is recessed away from the opening direction of the accommodating cavity 120a to accommodate the wiring plug 1251a. The specific location and area of the recessed portion 126a within the accommodating cavity 120a are not limited, as long as it can meet the requirements for accommodating the wiring plug 1251a. The cross-sectional shape of the recessed portion 126a is not limited and can be circular, square, or rectangular. In this embodiment, the recessed portion 126a is located at one end of the accommodating cavity 120a in the length direction (as shown by the X-axis direction in FIG. 14) and is opposite to the first chamber 122a and the second chamber 123a. The cross-sectional shape of the recessed portion 126a is rectangular. The recessed portion 126a and the accommodating cavity 120a are integrally formed by injection molding. By providing the recessed portion 126a, when the wiring plug 1251a is not in use, it can be placed in the recessed portion 126a, preventing it from falling into the first chamber 122a or the second chamber 123a, thus reducing the probability of the wiring plug 1251a being damaged.

To facilitate the placement and removal of the connecting wire 125a in the accommodating cavity 120a, preferably, referring to FIG. 14, in an embodiment of the lawn mower, along the length direction of the accommodating cavity 120a (as shown by the X-axis direction in FIG. 14), the first chamber 122a and the second chamber 123a are arranged side by side on one side of the length direction of the accommodating cavity 126a. The recessed portion 126a is located on the other side of the length direction of the accommodating cavity, and along the length direction of the accommodating cavity 120a, the recessed portion 126a is connected to the first chamber 122a and the second chamber 123a. The connection can be through partial openings in the recessed portion 126a or through the entire side wall of the recessed portion 126a. In this embodiment, the recessed portion 126a forms a step structure with the first chamber 122a and the second chamber 123a, with the bottom wall of the recessed portion 126a higher than the bottom walls of the first chamber 122a and the second chamber 123a, thus achieving the connection between the recessed portion 126a and the first chamber 122a and the second chamber 123a. This arrangement, on one hand, reduces the storage length of the connecting wire 125a in the accommodating cavity 120a, thereby reducing the space occupied by the stored connecting wire 125a. On the other hand, because the bottom wall of the recessed portion 126a is closer to the opening of the accommodating cavity 120a, it is more convenient for operators to place and remove the connecting wire 125a, thus improving the connection efficiency between the spare battery 810a and the connecting wire 125a.

Refer to FIG. 14 and FIG. 15. In an embodiment of the lawn mower, the bottom wall of the recess 126a is provided with ribs 1261a. The specific distribution structure of the ribs 1261a is not limited and can be a dot-like protrusion distribution, a strip-like distribution, or any protruding structure. In this embodiment, the ribs 1261a are structured as multiple strip-like protrusions arranged in an array. By providing ribs 1261a on the bottom wall of the recess 126a, the strength of the bottom wall of the recess 126a can be improved, enhancing durability. Additionally, it can provide an anti-slip effect for the plug 1251a or other operating tools placed in the recess 126a, reducing the probability of items placed in the recess 126a falling into the first chamber 122a or the second chamber 123a.

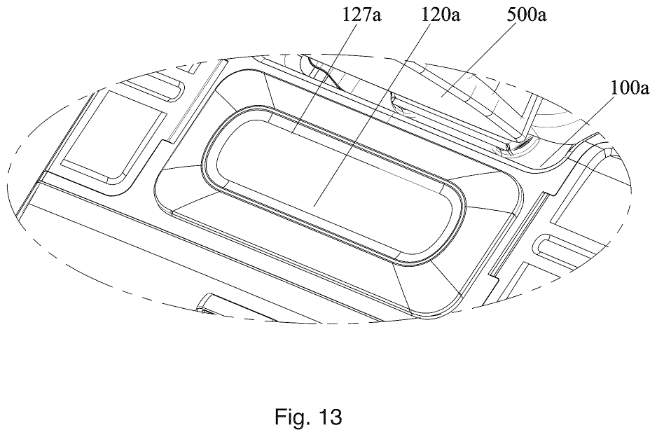

Refer to FIG. 12, FIG. 13, FIG. 14, and FIG. 16. In an embodiment of the lawn mower, a cover plate 127a is also provided on the frame 100a, covering the accommodating cavity 120a. The cover plate 127a can be hingedly connected to the side wall of the accommodating cavity 120a or can be a separate piece that snaps onto the opening of the accommodating cavity 120a, as long as it can cover the accommodating cavity 120a. In this embodiment, snap fasteners 1201a are provided around the opening of the accommodating cavity 120a, and corresponding slots 1271a are provided on the cover plate 127a. The slots 1271a engage with the snap fasteners 1201a. By providing the cover plate 127a, it can prevent items in the accommodating cavity 120a from escaping through the opening, reducing the risk of items falling out. It can also prevent external dust from entering the accommodating cavity 120a, which could lead to a risk of short circuit during the conduction process of the spare battery 810a.

An embodiment provides a gardening tool, which can be a ride-on sweeper, ride-on snow blower, or the lawn mower shown in FIG. 12. The gardening tool includes: a frame 100a, a walking mechanism 200a, and a working component. A seat 500a is installed on the frame 100a; the walking mechanism 200a is mounted on the frame 100a to drive the frame 100a to move. The walking mechanism 200a may include components such as a drive unit and a power supply unit. The power supply unit provides energy for the drive unit and can be a battery, diesel engine, gasoline engine, or hybrid engine. The drive unit provides power for the rotation of the walking wheels and can be an electric motor, an electric motor with a reducer, an electric motor with a gear and rack transmission mechanism, or an electric motor with a screw and nut transmission mechanism, or any transmission mechanism that meets the requirements. The walking mechanism 200a controls the frame 100a to perform corresponding walking actions. The working component is installed at the bottom of the frame 100a to perform corresponding gardening operations. A storage cavity 120a is formed on the frame 100a behind the seat 500a, and the storage cavity 120a accommodates at least a spare battery 810a. By forming the storage cavity 120a on the frame 100a behind the seat 500a and placing the spare battery 810a in the storage cavity 120a, this gardening tool does not compromise its overall aesthetics. Additionally, when the lawn mower is subjected to impacts or collisions, it is less likely to be hit, thereby reducing the probability of damage to the spare battery 810a in the storage cavity 120a and improving the safety of installing the spare battery 810a on the gardening tool.

An embodiment provides a lawn mower and gardening tool. By forming the storage cavity 120a on the frame 100a behind the seat 500a and placing the spare battery 810a in the storage cavity 120a, this lawn mower does not compromise its overall aesthetics since the storage cavity 120a does not protrude from the vehicle body. Moreover, when the lawn mower is subjected to impacts or collisions, it is less likely to be hit, reducing the probability of damage to the spare battery 810a in the storage cavity 120a and improving the safety of installing the spare battery 810a on the lawn mower. Therefore, this embodiment effectively overcomes some practical problems in the existing technology, making it highly valuable and meaningful for use.

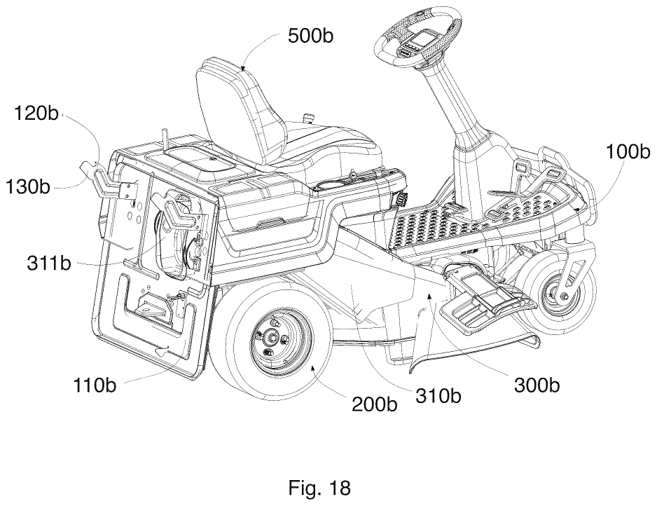

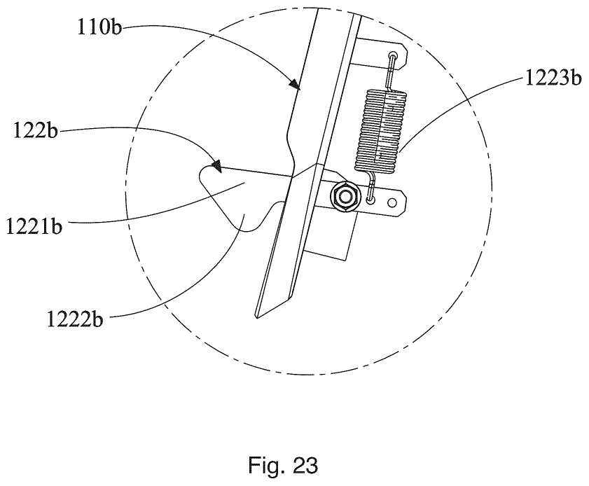

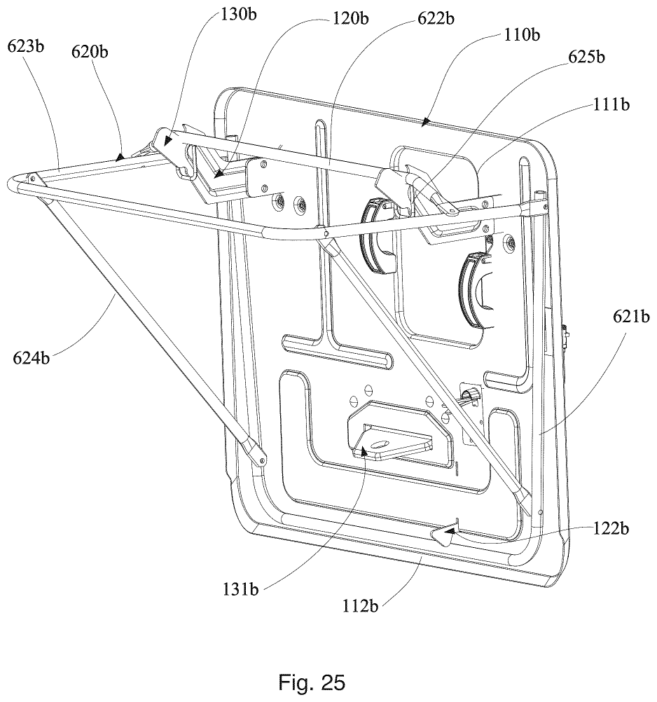

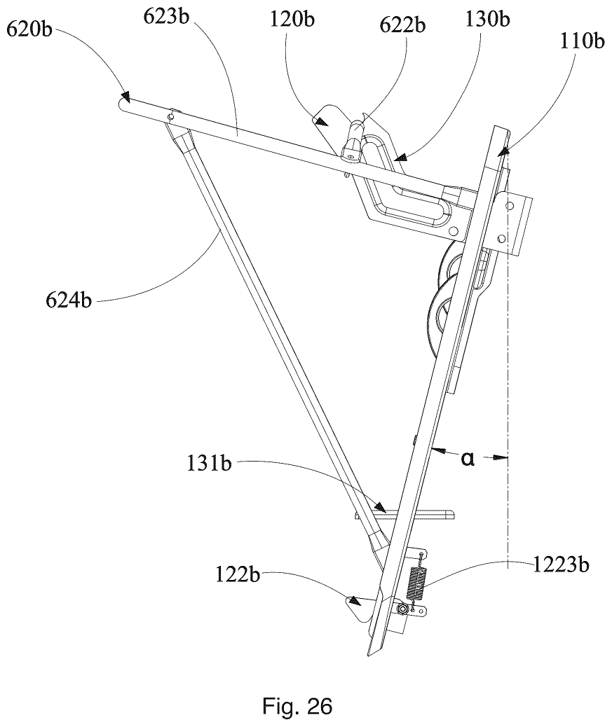

FIG. 18 to FIG. 28 show an embodiment of a lawn mower, including a mounting plate 110b, which is installed at the rear of the frame 100b and has a grass inlet 111b connected to the grass discharge port 311b. The mounting plate 110b is provided with a first connection part 120b for detachably connecting to a grass bag 600b and/or a second connection part 130b for detachably connecting to a cart 900b. This enables the lawn mower to install either a grass bag 600b or a cart 900b without increasing its volume and weight. The operator can install the cart 900b or grass bag 600b according to their needs, meeting various requirements for lawn mower operation.

FIG. 18 to FIG. 20 show that the lawn mower includes: a frame 100b, a walking mechanism 200b, a mowing deck assembly 300b, and a mounting plate 110b.

The structure of the frame 100b is not limited and can refer to existing lawn mower frame 100b structures. To improve the riding experience, a riding seat 500b can be installed on the frame 100b. In other embodiments, a riding seat 500b may not be installed, allowing for operation while standing.

The walking mechanism 200b is installed on the frame 100b to drive the frame 100b. The walking mechanism 200b may include driving parts, steering parts, power supply parts, etc. The power supply part provides energy to the driving part and can use a battery 800b or an engine, but is not limited to these. The driving part provides power for the rotation of the walking wheels and can use electric motor drive or electric motor with reducer drive, but is not limited to these. The walking mechanism 200b performs corresponding walking actions under the control of the operating assembly. There are various control methods for the operating assembly, including manual control, foot control, and integrated hand and foot control.

The mowing deck assembly 300b is installed on the bottom of the frame 100b, and corresponding mowing operations are performed through the mowing deck assembly 300b. The structure and specifications of the mowing deck assembly 300b can be of various types, with different working environments requiring different mowing deck assemblies 300b. Different specifications of mowing deck assemblies 300b, such as 48-inch, 52-inch, etc., require different assembly spaces. The bottom of the frame 100b can adjust the wheelbase of the lawn mower to obtain different bottom assembly spaces, meeting the adaptation needs of different mowing deck assemblies 300b. At the same time, in order to achieve the function of collecting cut grass into the grass collection bag 600b, the mowing deck assembly 300b also needs to be equipped with a grass conveying pipe 310b connected to the grass collection bag 600b, with the end of the grass conveying pipe 310b being the grass discharge outlet 311b.

Please refer to FIG. 18 and FIG. 21 to FIG. 22. An embodiment of the lawn mower includes a mounting plate 110b installed at the rear of the frame 100b, with a grass inlet 111b connected to the grass discharge outlet 311b. This setup achieves the grass collection function of the lawn mower. The connection method between the mounting plate 110b and the frame 100b can be welding or other fixed connections, or detachable screw connections. The installation angle of the mounting plate 110b and the frame 100b is not limited; the mounting plate 110b can be set horizontally, vertically, or at a certain angle to the vertical direction. The shape of the mounting plate 110b includes circular, rectangular, elliptical, or polygonal, but is not limited to these. When the grass collection bag 600b is installed on the mounting plate 110b, another function of the mounting plate 110b is to block the opening 611b of the grass collection bag 600b. Therefore, the area of the mounting plate 110b needs to cover the opening 611b of the grass collection bag 600b, ensuring that the cut grass can enter the grass collection bag 600b. Furthermore, considering that the operator drives in front of the grass collection bag 600b and cannot monitor whether the grass in the grass collection bag 600b is full, in an embodiment of this lawn mower, a grass-full switch is set on the mounting plate 110b. The grass-full switch is set near the position of the grass inlet 111b, which is the last position to be filled in the grass collection bag 600b. Therefore, setting the grass-full switch at this location can achieve the maximum capacity of the grass collection bag 600b. Specifically, when the grass collection bag 600b is full, it triggers the switch, sending a grass-full prompt.

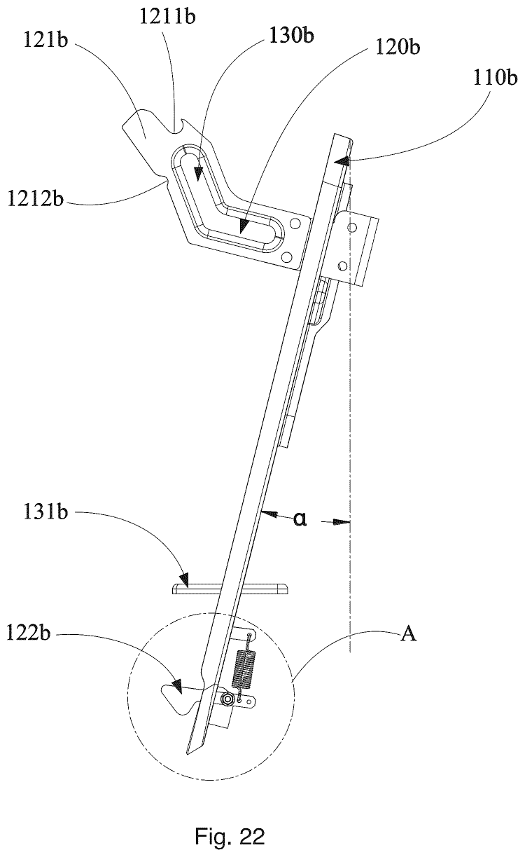

Please refer to FIG. 18 and FIG. 21 to FIG. 22, in an embodiment of the lawn mower, an inlet 111b is also formed on the mounting plate 110b, which is connected to the grass discharge port 311b. The shape and size of the inlet 111b are not limited; it can be circular or polygonal, as long as the cut grass can pass through the inlet 111b into the grass collection bag 600b. Preferably, in this embodiment, the mounting plate 110b has an approximately rectangular outline, and the surface of the mounting plate 110b is inclined downward away from the mowing deck assembly 300b, forming an angle α with the vertical direction, as shown in FIG. 22. The range of α is: 5°≤α≥45°. By adopting a certain angle, further, in an embodiment of the lawn mower, α=15°, both the grass collection bag 600b and the cart 900b will be in close contact with the mounting plate 110b under their own weight, which can also provide support for the grass collection bag 600b and the cart 900b. Furthermore, a protrusion 112b is provided on the mounting plate 110b, which corresponds to the opening 611b of the grass collection bag 600b. This protrusion 112b envelops the contact surface between the opening 611b of the grass collection bag 600b and the mounting plate 110b, which helps to improve the stability of the installation of the grass collection bag 600b on the mounting plate 110b. On the other hand, it can better prevent the grass in the grass collection bag 600b from spilling out when the lawn mower accelerates or encounters bumps.

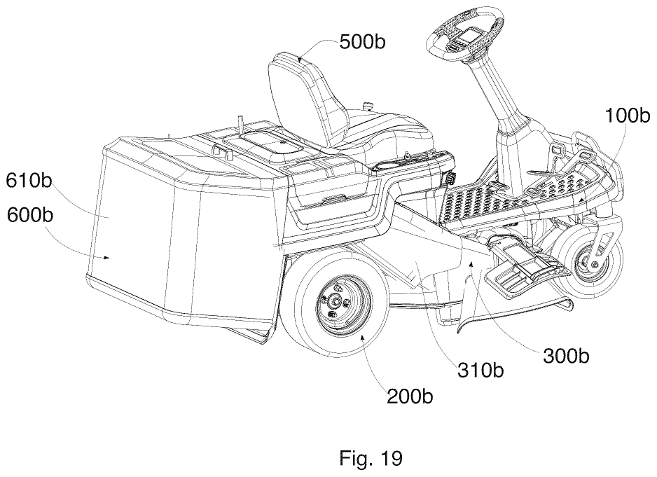

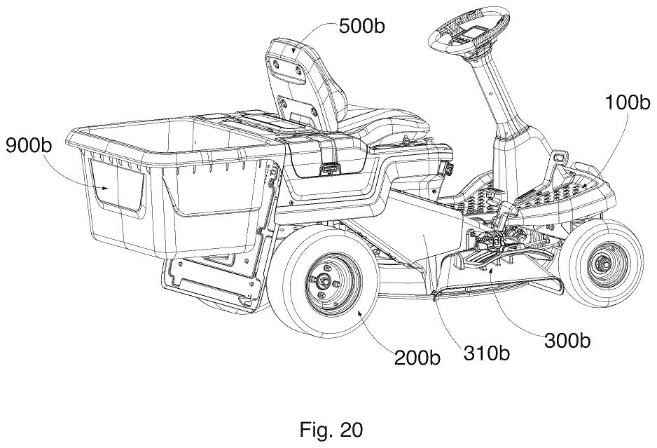

Please refer to FIG. 18 to FIG. 22, in an embodiment of the lawn mower, the mounting plate 110b is provided with a first connection part 120b for detachably connecting with the grass collection bag 600b and/or a second connection part 130b for detachably connecting with the cart 900b, achieving the effect of installing either the grass collection bag 600b or the cart 900b on the lawn mower. For example, please refer to FIG. 19, when it is necessary to clean up the cut grass, the grass collection bag 600b is installed on the first connection part 120b. For another example, please refer to FIG. 20, when storage and loading functions are needed, remove the grass collection bag 600b and install the cart 900b on the second connection part 130b. In this way, the lawn mower can install either the cart 900b or the grass collection bag 600b according to the requirements without increasing the volume and weight of the main body, to meet various needs of lawn mower operation. It should be noted that the connection methods between the first connection part 120b and the second connection part 130b with the mounting plate 110b can be fixed connections such as welding, or detachable connections such as screw connections.

An embodiment of the lawn mower includes the first connecting part 120b and the second connecting part 130b simultaneously set on the mounting plate 110b. Specifically, in one implementation, the first connecting part 120b and the second connecting part 130b have the same structure, capable of mounting both the grass collection bag 600b and the cart 900b. In another implementation, the first connecting part 120b and the second connecting part 130b are connected together, forming an integral structure that can mount both the grass collection bag 600b and the cart 900b.

In another embodiment of the lawn mower, when mounting the grass collection bag 600b, only the first connecting part 120b is set, and the second connecting part 130b is removed. When mounting the cart 900b, only the second connecting part 130b is set, while the first connecting part 120b is removed. Additionally, the mounting positions of the first connecting part 120b and the second connecting part 130b on the mounting plate 110b are not restricted, as long as they can secure the grass collection bag 600b or the cart 900b to the mounting plate 110b.

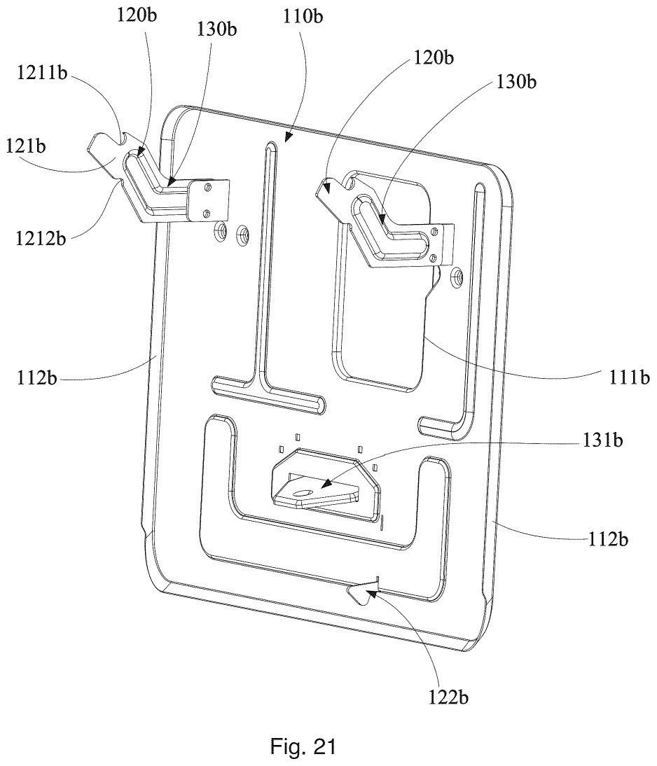

Referring to FIG. 21 to FIG. 22, in an embodiment of the lawn mower, the first connecting part 120b includes at least one fixing plate 121b. The fixing plate 121b is fixedly mounted on the side of the mounting plate 110b facing the grass collection bag 600b, used for mounting the grass collection bag 600b. To enhance the stability of the grass collection bag 600b mounted on the fixing plate 121b, this embodiment includes two fixing plates 121b, both located on the upper part of the mounting plate 110b, used to connect the upper side of the grass collection bag 600b. In another embodiment of the lawn mower, the second connecting part 130b also includes a fixing plate 121b, which is used for mounting the cart 900b.

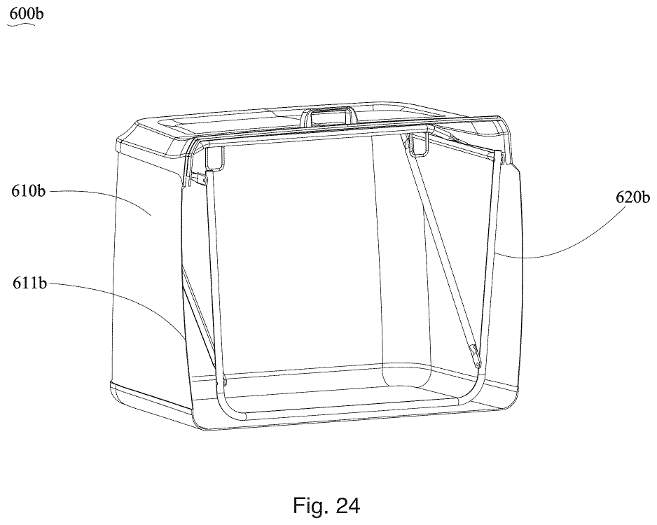

Please refer to FIG. 24, in an embodiment of the lawn mower, the grass collection bag 600b includes a bag body 610b and a support member 620b. The material of the bag body 610b includes, but is not limited to, plastic woven bags, composite woven bags, or cloth bags. The bag body 610b includes at least one opening 611b. For example, at least one opening 611b for grass entry can be provided on the bag body 610b. Furthermore, a grass discharge port that can be controlled to open and close can be provided at the bottom of the grass collection bag 600b to facilitate the discharge of grass from the grass collection bag 600b. In this embodiment, the bag body 610b is provided with only one opening 611b for grass entry. The support member 620b is supportively arranged inside the bag body 610b to support the bag body 610b and achieve a predetermined shape for the bag body 610b, such as a cuboid, cylinder, or prism.

Please refer to FIG. 18, FIG. 19, and FIG. 24 to FIG. 26. The support member 620b is detachably and rotatably connected to the fixing plate 121b. The rotatable connection methods include threaded connections, bearing connections, etc. This arrangement allows the upper side of the grass collection bag 600b to rotate around the fixing plate 121b. The mounting plate 110b is sealingly arranged on the opening 611b, and the opening 611b at least covers the grass inlet 111b. This arrangement allows the cut grass to enter the grass collection bag 600b through the inlet slot and be sealed by the mounting plate 110b. When the grass collection bag 600b is full of grass, the lower side of the opening 611b of the grass collection bag 600b can be lifted, causing the upper side of the grass collection bag 600b to rotate around the fixing plate 121b. This action separates the opening 611b of the grass collection bag 600b from the mounting plate 110b, opening the opening 611b and allowing the cut grass to be poured out for unified processing.

Refer to FIG. 18, FIG. 19, and FIG. 24 to FIG. 28. To better support the opening 611b of the grass collection bag 600b, in an embodiment of the lawn mower, the support structure 620b includes a first support frame 621b. The first support frame 621b is fixedly supported on the inside of the opening 611b and rests on the mounting plate 110b under gravity. The first support frame 621b is used to open and fix the opening 611b to facilitate grass entry. The shape of the first support frame 621b can be a circular frame, an elliptical frame, a square frame, or other polygonal frame. The first support frame 621b can be closed or open. In this embodiment, the first support frame 621b is an approximately U-shaped frame, with the upper end of the U-shaped frame open (the upper end here refers to the end of the grass collection bag 600b away from the ground when it is installed on the mounting plate 110b). The first support frame 621b includes a first rod 6211b at the lower end and a second rod 6212b and a third rod 6213b connecting the two ends of the first rod 6211b. A frame consisting of only three sides can support the opening 611b into a rectangular shape, saving costs.

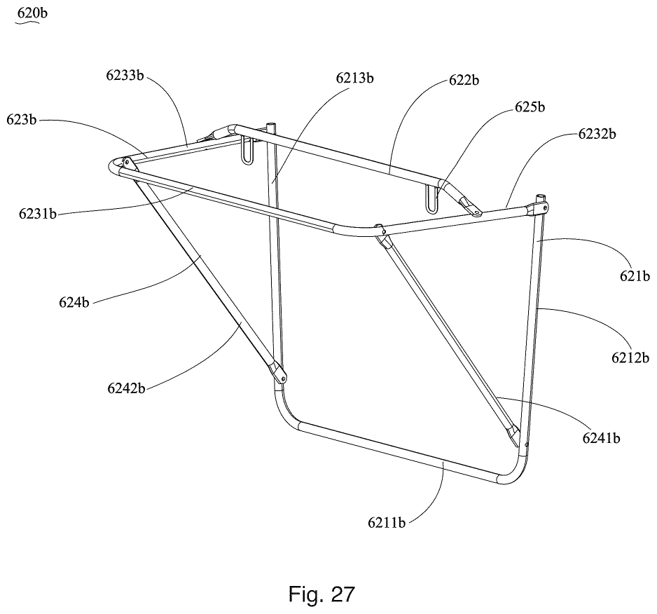

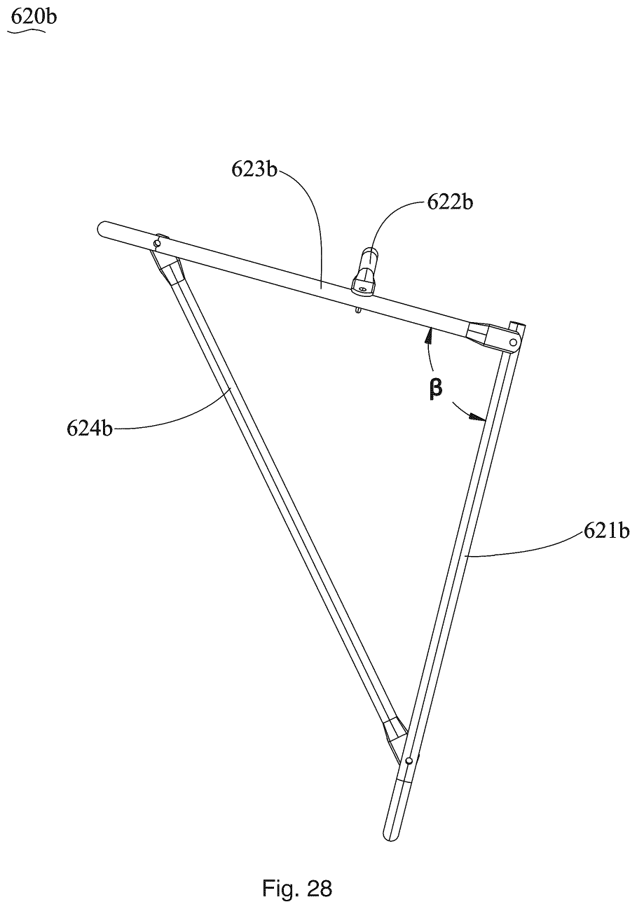

Refer to FIG. 18, FIG. 19, and FIG. 24 to FIG. 28. Considering that the grass clippings loaded into the grass collection bag 600b may stretch its bottom excessively, causing the grass collection bag 600b to sag and affect the lawn mower's operation, in an embodiment of the lawn mower, the support structure 620b also includes a second support frame 623b. The shape of the second support frame 623b is not limited and can be circular, elliptical, square, or other polygonal shapes. It can be closed or open. The second support frame 623b is fixedly connected to the first support frame 621b at an angle. The connection method between the second support frame 623b and the first support frame 621b is not limited and can be welded or other fixed connections, or detachable screw connections. The connection position is not limited. In this embodiment, the second support frame 623b is also an approximately U-shaped frame. The second support frame 623b includes a fifth rod 6232b and a sixth rod 6233b arranged opposite each other, and a fourth rod 6231b connecting the fifth rod 6232b and the sixth rod 6233b. The open end of the second support frame 623b is connected to the open end of the first support frame 621b. Specifically, refer to FIG. 27 to FIG. 28, the second rod 6212b is fixedly connected to the fifth rod 6232b, and the third rod 6213b is fixedly connected to the sixth rod 6233b. The rectangular surface formed by the second support frame 623b is set at an angle β to the rectangular surface formed by the first support frame 621b. Preferably, the range of β is: 75°≤β≤145°. Furthermore, in this embodiment, β=90°. The second support frame 623b set up in this way can provide more stable support for the grass collection bag 600b, making the grass collection bag 600b taut against the outer wall of the second support frame 623b when in use, preventing the grass clippings at the inner bottom from stretching the bottom of the grass collection bag 600b excessively and causing sagging that would affect the lawn mower's operation.

In another embodiment of the lawn mower, to improve the sagging condition of the grass collection bag 600b, the top and/or bottom of the grass collection bag 600b can also use rigid materials, such as plastic, to enhance the support of the grass collection bag 600b.

Referring to FIG. 27 to FIG. 28, considering the load-bearing strength issue between the first support frame 621b and the second support frame 623b, in an embodiment of the lawn mower, the supporting structure 620b also includes a third support frame 624b. The third support frame 624b connects the first support frame 621b and the second support frame 623b to enhance the load-bearing strength of the supporting structure 620b. The structure and shape of the third support frame 624b are not limited, as long as it can improve the deformation problem of the first support frame 621b and the second support frame 623b after bearing weight. In this embodiment, the third support frame 624b includes a seventh rod 6241b and an eighth rod 6242b. One end of the seventh rod 6241b is fixedly connected to the second rod 6212b, and the other end of the seventh rod 6241b is connected to the fifth rod 6232b. One end of the eighth rod 6242b is fixedly connected to the third rod 6213b, and the other end of the eighth rod 6242b is fixedly connected to the sixth rod 6233b. This arrangement can further improve the sagging problem of the grass collection bag 600b and is also beneficial for supporting the bag body 610b into an approximate cuboid shape.

Referring to FIG. 18, FIG. 19, and FIG. 24 to FIG. 28, in an embodiment of the lawn mower, considering better rotational connection between the supporting structure 620b and the fixing plate 121b, in this embodiment, a connecting member 622b is provided on the second support frame 623b. Specifically, the connecting member 622b is a long rod-shaped member, with one end fixedly connected to the fifth rod 6232b and the other end fixedly connected to the sixth rod 6233b. A first groove 1211b is provided on the fixing plate 121b, and the connecting member 622b is detachably and rotatably connected to the first groove 1211b. This arrangement allows the grass collection bag 600b to press against the mounting plate 110b by its own weight, making installation and removal more convenient. To improve the stability of the grass collection bag 600b on the mounting plate 110b, at least one limiting member 625b is provided on the connecting member 622b. A second groove 1212b is provided on the side of the fixing plate 121b away from the first groove 1211b. The second groove 1212b is detachably engaged with the limiting member 625b. The provision of this limiting member 625b restricts the swinging of the connecting member 622b on the fixing plate 121b and prevents the connecting member 622b from falling out of the first groove 1211b. In this embodiment, since there are two fixing plates 121b, two limiting members 625b corresponding to the two fixing plates 121b are provided on the connecting member 622b.

Please refer to FIG. 19 and FIG. 21 to FIG. 26. In an embodiment of the lawn mower, to further improve the stability of the grass collection bag 600b on the mounting plate 110b, the second connecting portion 130b includes a locking member 122b set on the mounting plate 110b. The locking member 122b is detachably engaged with the first support frame 621b. There are many ways for the locking member 122b to engage, such as mortise and tenon engagement, elastic engagement, screw engagement, or magnetic engagement. When the grass collection bag 600b is fixedly connected to the mounting plate 110b, the locking member 122b can play an auxiliary role in fixing the grass collection bag 600b. When the grass collection bag 600b is removed, it can be easily detached. The position of the locking member 122b is not limited and can be set at any position where the first support frame 621b can be engaged and fixed.

Please refer to FIG. 19 and FIG. 21 to FIG. 26. In an embodiment of the lawn mower, the locking member 122b adopts a spring engagement method. Specifically, the locking member 122b includes at least one locking plate 1221b. A positioning portion 1222b is provided near one end of the locking plate 1221b. The positioning portion 1222b protrudes from the locking plate 1221b and is used to limit the supporting member 620b of the grass collection bag 600b. It enables the supporting member 620b to smoothly enter the positioning portion 1222b and can lock the supporting member 620b. The other end of the locking plate 1221b passes through the mounting plate 110b and is pivotally connected to the side of the mounting plate 110b away from the grass collection bag 600b. The pivotal connection enables the locking plate 1221b to rotate around the pivot axis. The end of the locking plate 1221b away from the positioning portion 1222b is connected to an elastic member 1223b. The other end of the elastic member 1223b is fixedly connected to the mounting plate 110b. The elastic member 1223b includes but is not limited to springs or rubber bands. In this embodiment, the locking member 122b is provided with one locking plate 1221b. The locking plate 1221b is located at a position where it can engage with the first rod 6211b. This position can well fix the lower end of the grass collection bag 600b, which can improve the problem of the opening 611b of the grass collection bag 600b opening due to inertia or bumps, causing the cut grass to spill out of the grass collection bag 600b. The elastic member 1223b uses a spring. When the first rod 6211b enters the positioning portion 1222b, the locking plate 1221b stretches the spring. After the first rod 6211b enters, the spring returns to its original position, and the positioning portion 1222b locks the first rod 6211b.

Please refer to FIG. 20 to FIG. 22 and FIG. 25 to FIG. 26. Considering the stability of mounting the bucket 900b to the mounting plate 110b, in an embodiment of the lawn mower, a support plate 131b is provided on the side of the mounting plate 110b where the bucket 900b is mounted. The shape of the support plate 131b is not limited and can be rectangular, circular, or triangular, etc. In this embodiment, the support plate 131b is triangular and perpendicular to the mounting plate 110b. The support plate 131b is positioned below the mounting location of the bucket 900b, and when the bucket 900b is mounted on the mounting plate 110b, the triangular surface of the support plate 131b contacts the bottom surface of the bucket 900b, providing support for the bucket 900b. This weakens the force exerted by the bucket 900b on the fastening components, thereby extending the service life of the fastening components. Additionally, the support plate 131b is equipped with a through-hole for installing a tow rope, tow chain, or directly connecting with a tow hook to enable towing of other machinery or objects. In another embodiment of the lawn mower, the triangular surface of the support plate 131b does not contact the bottom surface of the bucket 900b, which can serve as a buffer if the bucket 900b falls and provide temporary support during the installation of the bucket 900b, allowing the operator to exert force or rest.

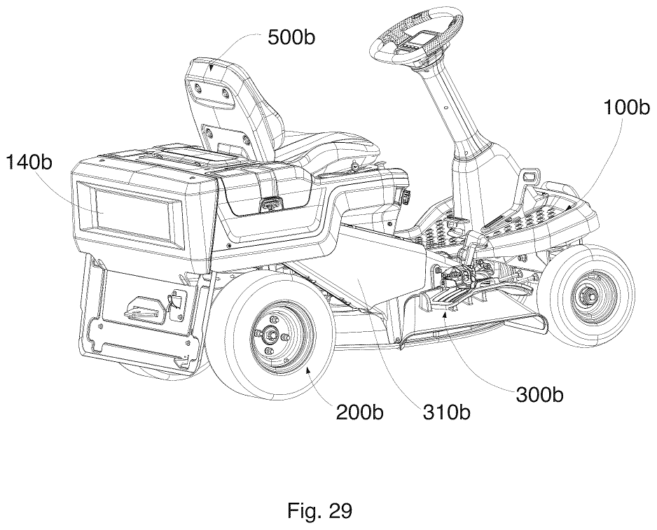

Please refer to FIG. 29. Considering that when neither the grass collection bag 600b nor the bucket 900b is installed on the lawn mower, the grass discharge port 311b and the grass inlet 111b are exposed, affecting aesthetics and posing potential safety hazards. In an embodiment of the lawn mower, it also includes a cover plate 140b that is detachably connected to the mounting plate 110b to cover the exposed grass inlet 111b when neither the grass collection bag 600b nor the bucket 900b is installed.

An embodiment of the lawn mower includes a mounting plate installed at the rear of the frame, with a grass inlet communicating with the grass discharge port. This configuration achieves the grass collection function of the lawn mower. The use of the mounting plate to install the grass collection bag provides large-area support for the bag, resulting in better fixation. Additionally, the mounting plate conveniently seals the opening of the grass collection bag. The mounting plate is equipped with a first connection part for detachably connecting with the bucket and/or a second connection part for detachably connecting with the grass collection bag. This allows the lawn mower to accommodate either a grass collection bag or a bucket. Consequently, the lawn mower can meet various operational needs by installing either a bucket or a grass collection bag as required, without increasing the volume or weight of the main body.

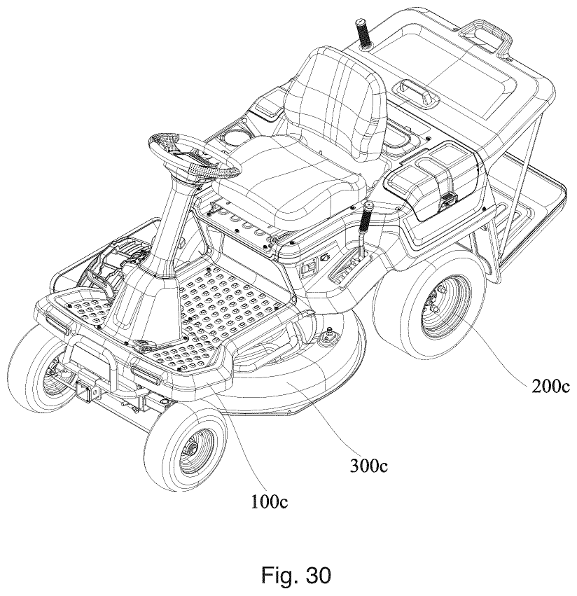

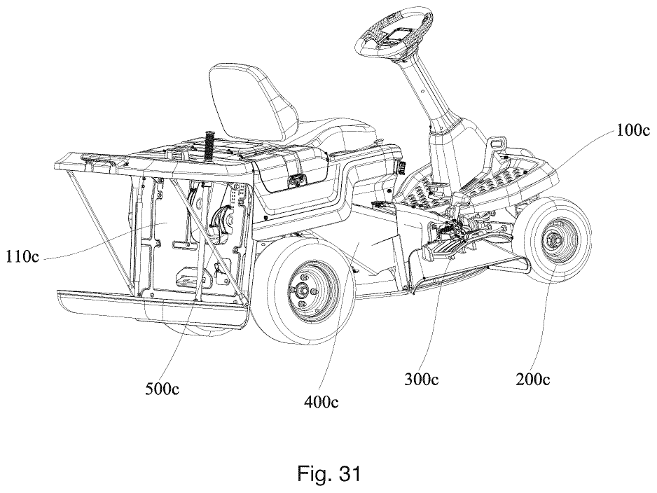

Please refer to FIG. 30 to FIG. 33. An embodiment provides a lawn mower 100c, which includes a frame 100c, a walking mechanism 200c, a cutting table 300c, a grass conveying pipe 400c, and a fixing device 500c. In an embodiment, the frame 100c is provided with a mounting plate 110c, which is arranged at the rear of the lawn mower 100c for mounting and fixing the grass conveying pipe 400c. In an embodiment, the mounting plate 110c can also be used to fix a grass collection device and the like. The walking mechanism 200c is arranged on the frame 100c for driving the lawn mower 100c to walk. In an embodiment, the walking mechanism 200c includes a drive motor, walking wheels, etc. The drive motor drives the walking wheels to rotate to drive the lawn mower 100c to walk. The cutting table 300c is arranged on the frame 100c. The cutting table 300c is provided with a cutter, a cutting motor, etc. The cutting motor drives the cutter to rotate to cut the lawn. As an example, the cutting table 300c can be adjusted up and down on the frame 100c to meet different cutting height requirements. At the same time, when the lawn mower 100c is transported or moved, the cutting table 300c can be raised to facilitate transportation or movement of the lawn mower 100c. The cutting table 300c is provided with a first grass discharge port to discharge the grass clippings cut by the cutter. One end of the grass conveying pipe 400c is connected to the first grass discharge port, and the other end is arranged on the mounting plate 110c. In an embodiment, the end arranged on the mounting plate 110c is connected to a grass collection device, thereby transferring the grass clippings cut by the lawn mower 100c into the grass collection device for collection. Of course, the grass collection device may not be provided, and the grass conveying pipe 400c directly discharges the grass clippings cut by the lawn mower 100c. The grass conveying pipe 400c is provided with a mounting part 410c. In an embodiment, the mounting part 410c is arranged on the left and right sides of the grass conveying pipe 400c. In another embodiment, the mounting part 410c is arranged on the upper and lower sides of the grass conveying pipe 400c. Preferably, the mounting part 410c is arranged on the left and right sides of the grass conveying pipe 400c to facilitate adaptive adjustment of the grass conveying pipe 400c when the cutting table 300c is adjusted up and down, and to better restrict the lateral movement of the grass conveying pipe 400c. The fixing device 500c is detachably fixed on the mounting plate 110c. The fixing device 500c and the mounting plate 110c form a mounting area 120c. The mounting part 410c is arranged in the mounting area 120c. The mounting area 120c accommodates the movement of the mounting part 410c within the mounting area 120c, facilitating the adaptive movement of the grass conveying pipe 400c after the cutting table 300c is adjusted up and down, so that the grass conveying pipe 400c can always transfer the grass clippings from the cutting table 300c to the grass collection device. The movement includes up and down movement and/or rotation. In an embodiment, the mounting area 120c accommodates the up and down movement of the mounting part 410c within the mounting area 120c. In another embodiment, the mounting area 120c accommodates the rotation of the mounting part 410c within the mounting area 120c. In other embodiments, the mounting area 120c accommodates both up and down movement and rotation of the mounting part 410c within the mounting area 120c. In an embodiment, in addition to accommodating the up and down movement and rotation of the mounting part 410c within the mounting area 120c, the mounting area 120c also accommodates the movement of the mounting part 410c in the direction towards or away from the mounting plate 110c within the mounting area 120c, which is more conducive to adjusting the position and angle of the grass conveying pipe 400c. In an embodiment, when the cutting table 300c is adjusted in height, the fixing device 500c can maintain its relative fixation with the mounting plate 110c, and the mounting part 410c of the grass conveying pipe 400c makes adaptive adjustments within the mounting area 120c following the cutting table 300c, so that when the cutting table 300c is adjusted in height, the grass conveying pipe 400c can follow the adjustment of the cutting table 300c without needing separate adjustment of the grass conveying pipe 400c, which is convenient to operate, simple, and saves adjustment time. In another embodiment, when the cutting table 300c is adjusted in height, the fixing device 500c is separated from the mounting plate 110c. After the height adjustment of the cutting table 300c is completed, the fixing device 500c is installed and fixed to the mounting plate 110c again, which can better ensure the accuracy of the position adjustment of the grass conveying pipe 400c.

In an embodiment of the lawn mower 100c of this application, the fixing device 500c is detachably connected to the mounting plate 110c on the frame 100c through at least one connecting unit, allowing the fixing device 500c to be detachably connected to the mounting plate 110c through the connecting unit, facilitating disassembly and other operations of the grass discharge tube 400c as needed.

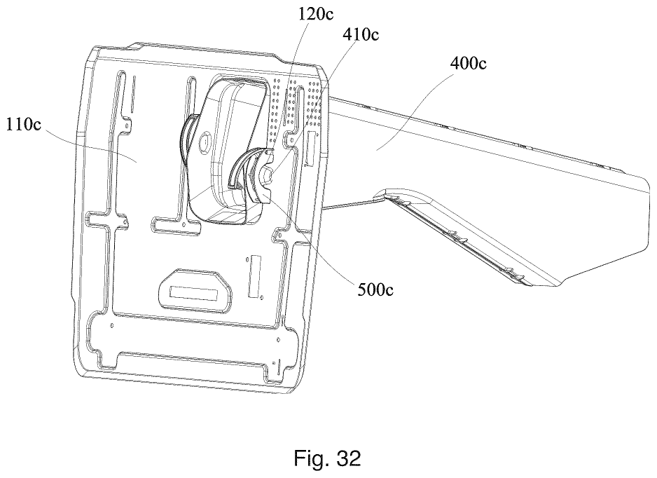

Referring to FIG. 32 to FIG. 35, exemplarily, the connecting unit includes a mounting hole 121c provided on the mounting plate 110c and a buckle 510c provided on the fixing device 500c. The buckle 510c is connected to the mounting hole 121c, achieving fixation of the fixing device 500c to the mounting plate 110c through the engagement of the buckle 510c with the mounting hole 121c, facilitating the fixation and detachment of the fixing device 500c to/from the mounting plate 110c.

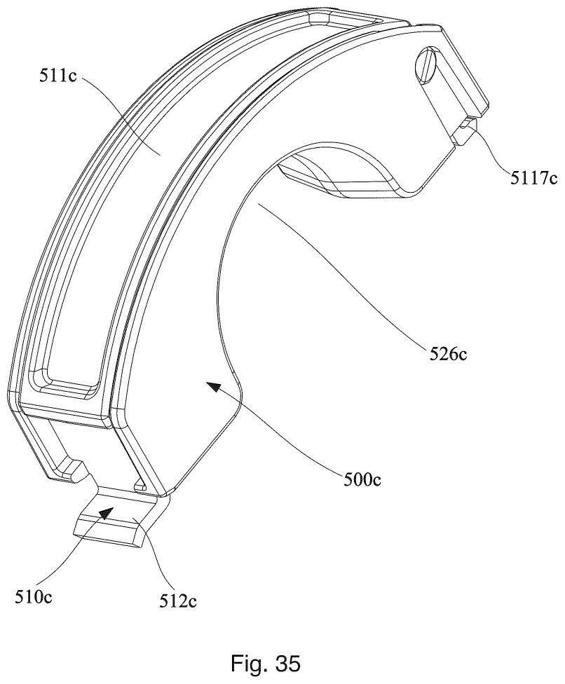

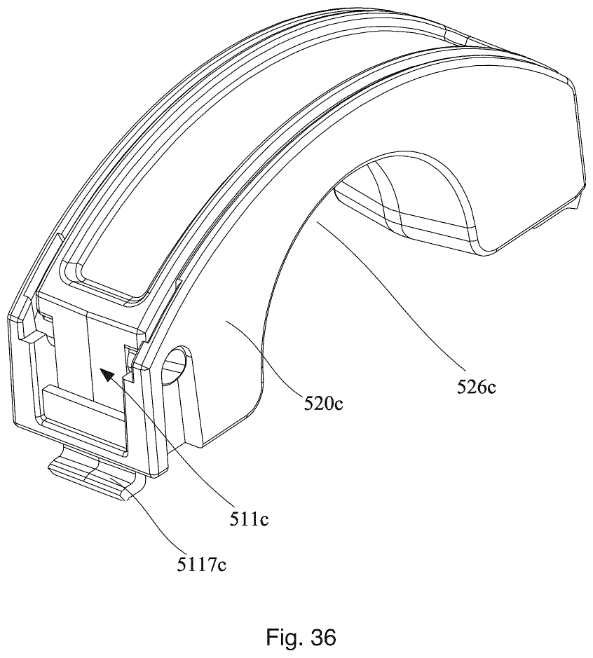

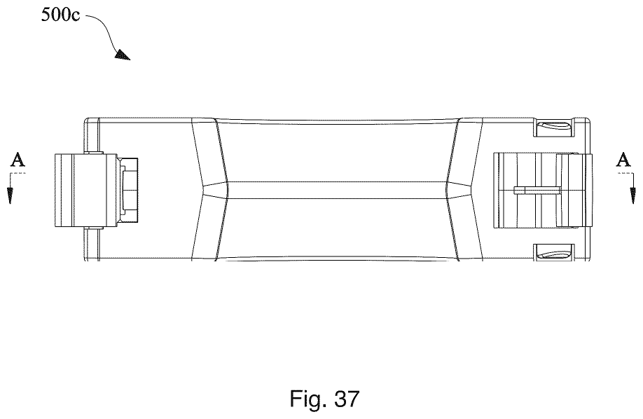

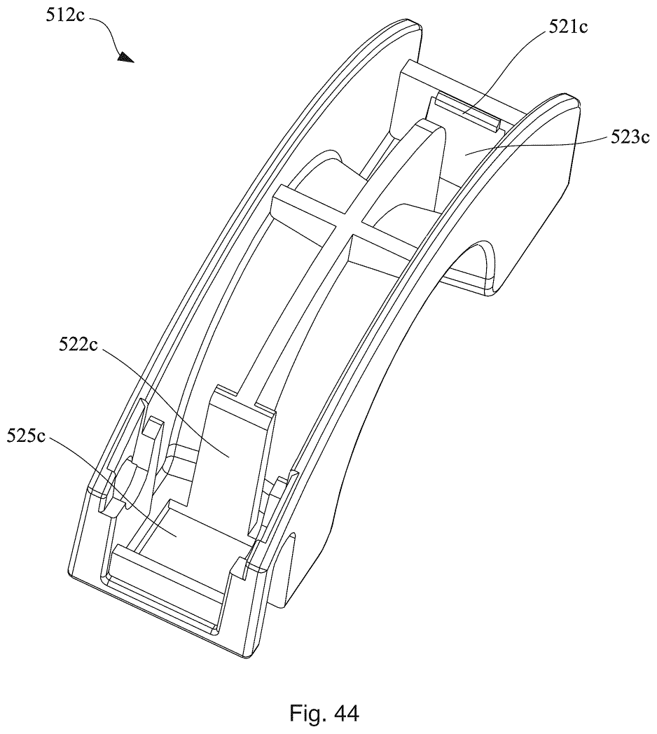

Referring to FIG. 35 to FIG. 38 and FIG. 44, in an embodiment of the lawn mower of this application, the fixing device 500c includes a main body 520c. During assembly, the main body 520c abuts against the mounting plate 110c. A recess 526c is provided on the side of the main body 520c facing the mounting plate 110c. The mounting plate 110c closes the opening of the recess 526c to form a mounting area 120c. Exemplarily, the inner wall of the recess 526c is arc-shaped or near arc-shaped, reducing wear between the mounting part 410c and the recess 526c when the mounting part 410c is installed in the mounting area 120c. Exemplarily, the cross-section of the mounting part 410c is elliptical or near-elliptical, facilitating the movement or rotation of the mounting part 410c when adjusting the grass discharge tube 400c, reducing wear between the mounting part 410c and the recess 526c.

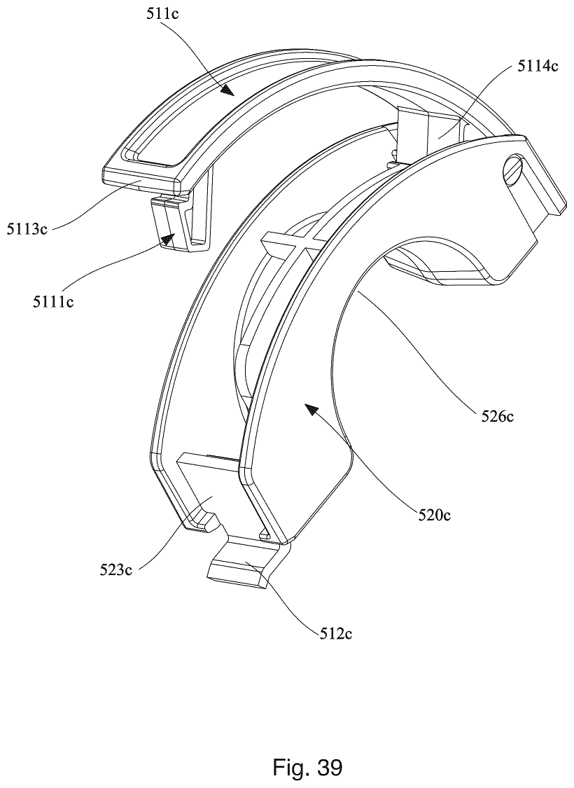

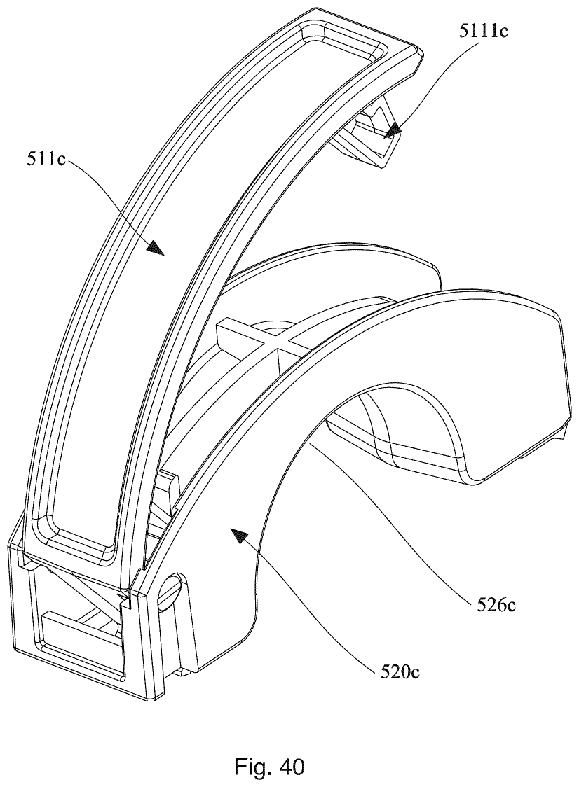

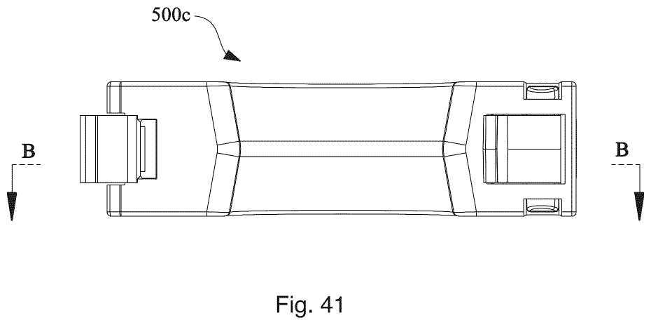

Refer to FIG. 35 to FIG. 38 and FIG. 43. As an example, the snap fastener 510c includes a first snap fastener 511c rotatably connected to the main body 520c. When the first snap fastener 511c rotates to a first position relative to the main body 520c, the first snap fastener 511c is locked to the main body 520c by the locking device 530c, thereby achieving engagement between the first snap fastener 511c and the mounting hole 121c. Refer to FIG. 39 to FIG. 43. When the first snap fastener 511c rotates to a second position relative to the main body 520c, the first snap fastener 511c separates from the corresponding mounting hole 121c, at which point the first snap fastener 511c can be removed from the mounting hole 121c. By providing the locking device 530c, the first snap fastener 511c can be relatively fixed to the main body 520c, thereby preventing the first snap fastener 511c from disengaging from the mounting hole 121c.

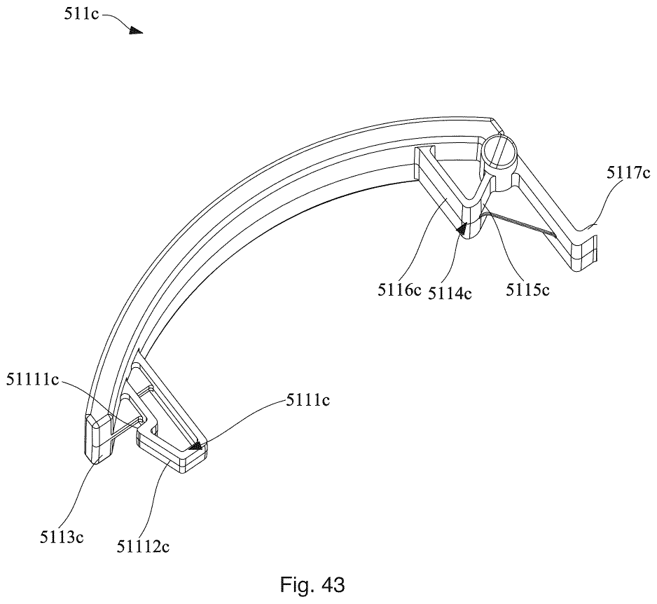

Refer to FIG. 32, FIG. 35 to FIG. 38, and FIG. 43. As an example, a hook 5117c is provided on the first snap fastener 511c. When the hook 5117c passes through the mounting hole 121c and abuts against the surface of the mounting plate 110c facing away from the mounting part 410c, the first snap fastener 511c engages with the mounting hole 121c. When the first snap fastener 511c rotates relative to the main body 520c, the hook 5117c rotates with the first snap fastener 511c, causing the hook 5117c to separate from the surface of the mounting plate 110c facing away from the mounting part 410c. This allows the hook 5117c to be removed through the mounting hole 121c, separating the first snap fastener 511c from the mounting hole 121c. The fixing device 500c and the mounting plate 110c move relative to each other, facilitating position adjustment of the grass discharge chute 400c.

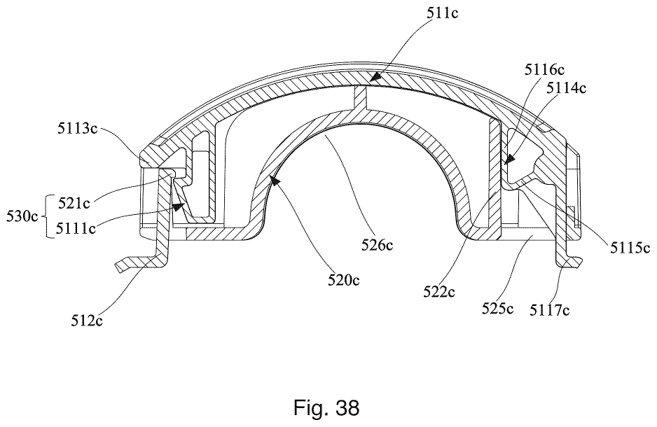

Referring to FIG. 38, in an embodiment of the lawn mower of this application, the locking device 530c includes a locking plate 521c set on the main body 520c and an elastic catch 5111c set on the first buckle 511c. The elastic catch 5111c can undergo elastic deformation, and the elastic catch 5111c cooperates with the locking plate 521c to achieve the locking function. Referring to FIG. 38 and FIG. 43, a step surface 51111c is set on the elastic catch 5111c. When the elastic catch 5111c is inserted into the main body 520c, the step surface 51111c abuts against the locking plate 521c, thereby limiting the separation of the elastic catch 5111c from the main body 520c, i.e., limiting the relative movement between the first buckle 511c and the main body 520c, preventing the first buckle 511c from rotating relative to the main body 520c and causing the first buckle 511c to detach from the mounting hole 121c. When the applied external force exceeds a preset threshold, the elastic catch 5111c undergoes elastic deformation, allowing the elastic catch 5111c to disengage from the locking plate 521c, enabling the first buckle 511c to rotate relative to the main body 520c until the first buckle 511c rotates to the second position relative to the main body 520c, at which point the first buckle 511c can detach from the mounting hole 121c.

Referring to FIG. 38 and FIG. 43, as an example, a guide surface 51112c is also set on the elastic catch 5111c. When the elastic catch 5111c is inserted into the main body 520c, the guide surface 51112c inclines from the bottom of the main body 520c towards the top of the main body 520c in the direction of the locking plate 521c, facilitating the insertion of the elastic catch 5111c into the main body 520c. When the elastic catch 5111c is inserted into the main body 520c, the guide surface 51112c abuts against the locking plate 521c. As the elastic catch 5111c is inserted deeper, the locking block causes the deformation of the elastic catch 5111c to increase until the guide surface 51112c disengages from the locking plate 521c, at which point the elastic catch 5111c recovers its shape, and the step surface 51111c abuts against the locking plate 521c.

Referring to FIG. 39 and FIG. 43, in an embodiment of the lawn mower of this application, a hand-grip portion 5113c is provided on the first buckle 511c. The hand-grip portion 5113c facilitates the operator's grip, making it easier to achieve locking and relative movement between the first buckle 511c and the main body portion 520c. For example, the hand-grip portion 5113c is set on the side of the first buckle 511c away from the rotation axis of the first buckle 511c, thus making it easier for the operator to exert force.

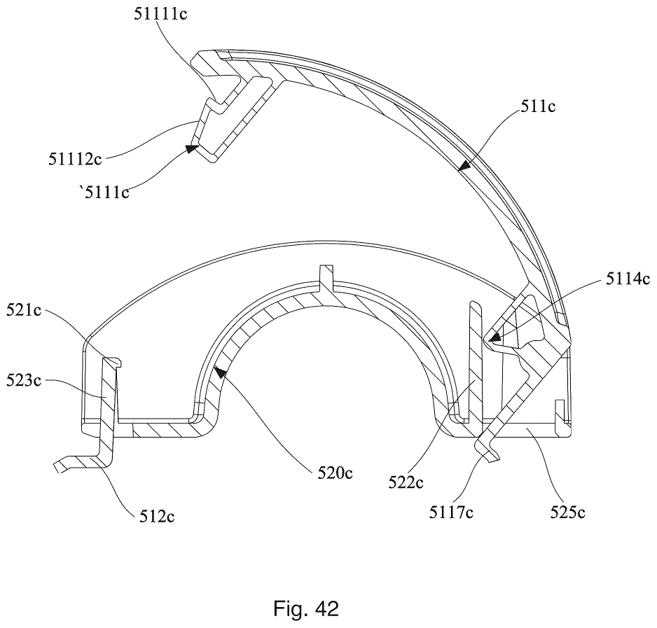

Referring to FIG. 43, in an embodiment, the first buckle 511c is generally L-shaped. The rotation axis of the first buckle 511c is set at the corner of the L-shape. The hand-grip portion 5113c is set on the longer edge of the L-shape, and the hook 5117c is set on the shorter edge of the L-shape. The locking device 530c is set on the longer edge of the L-shape, close to the hand-grip portion 5113c. Referring to FIG. 42, for example, a third support plate 523c is provided on the main body portion 520c. The locking plate 521c is set on the side wall of the third support plate 523c. The hand-grip portion 5113c is set on the top of the third support plate 523c and extends towards the side of the third support plate 523c away from the locking plate 521c, thus facilitating the operator's grip. Preferably, there is a space area between the third support plate 523c and the edge of the main body portion 520c to accommodate the operator's grip on the hand-grip portion 5113c, facilitating the operator's grip on the hand-grip portion 5113c for locking and moving the first buckle 511c and the main body portion 520c.

Refer to FIG. 38 and FIG. 42. In an embodiment of the lawn mower 120c of the present application, a limiting plate 522c is provided on the main body portion 520c. An elastic limiting portion 5114c is provided on the first snap-fit connector 511c. When the first snap-fit connector 511c is rotated to the first position, the limiting portion 5114c and the limiting plate 522c restrict the first snap-fit connector 511c from rotating in a direction away from the main body portion 520c. In an embodiment, when the first snap-fit connector 511c is rotated to the first position, the limiting portion 5114c moves while interferingly abutting against the limiting plate 522c. At this time, the limiting portion 5114c undergoes elastic deformation until the first snap-fit connector 511c is rotated to the first position, after which the elastic deformation of the limiting portion 5114c is fully or partially recovered. Similarly, when the first snap-fit connector 511c rotates from the first position to the second position, the limiting portion 5114c also moves while interferingly abutting against the limiting plate 522c, thereby requiring an external force exceeding a predetermined threshold to be applied to the first snap-fit connector 511c when rotating between the first position and the second position. By providing the limiting portion 5114c and the limiting plate 522c, on one hand, the stability of the connection between the first snap-fit connector 511c and the mounting hole 121c can be further ensured. On the other hand, when the first snap-fit connector 511c is disengaged from the mounting hole 121c, that is, when the first snap-fit connector 511c is rotated to the second position relative to the main body portion 520c, the limiting portion 5114c and the limiting plate 522c can restrict the first snap-fit connector 511c from rotating in the direction of engaging with the main body portion 520c. When engaging the first snap-fit connector 511c with the mounting hole 121c, it ensures that the first snap-fit connector 511c is in the second position, facilitating the engagement between the first snap-fit connector 511c and the mounting hole 121c.

Refer to FIG. 38 and FIG. 42. In an embodiment of the lawn mower 120c of the present application, a limiting hole 525c is provided on the main body portion 520c. The hook 5117c of the first snap-fit connector 511c passes through the limiting hole 525c, and the hook 5117c moves within the limiting hole 525c. By providing the limiting hole 525c, the position of the hook 5117c can be restricted, facilitating quick engagement between the first snap-fit connector 511c and the mounting hole 121c.

Refer to FIG. 38, FIG. 42, and FIG. 43. As an example, the limiting portion 5114c includes a first support plate 5115c and a second support plate 5116c. One end of the second support plate 5116c is connected to the first support plate 5115c, and the other end of the second support plate 5116c is connected to the first buckle 511c. Preferably, when the first buckle 511c is in the first position, the second support plate 5116c is parallel or substantially parallel to the limiting plate 522c. The second support plate 5116c, the first support plate 5115c, and the body of the first buckle 511c together form a cavity, facilitating the elastic deformation of the limiting portion 5114c.

In an embodiment of the lawn mower of this application, the limiting portion 5114c and the locking device 530c are arranged on the upper and lower sides of the mounting portion 410c in the assembled state, which can better achieve the locking and unlocking between the first buckle 511c and the main body portion 520c.

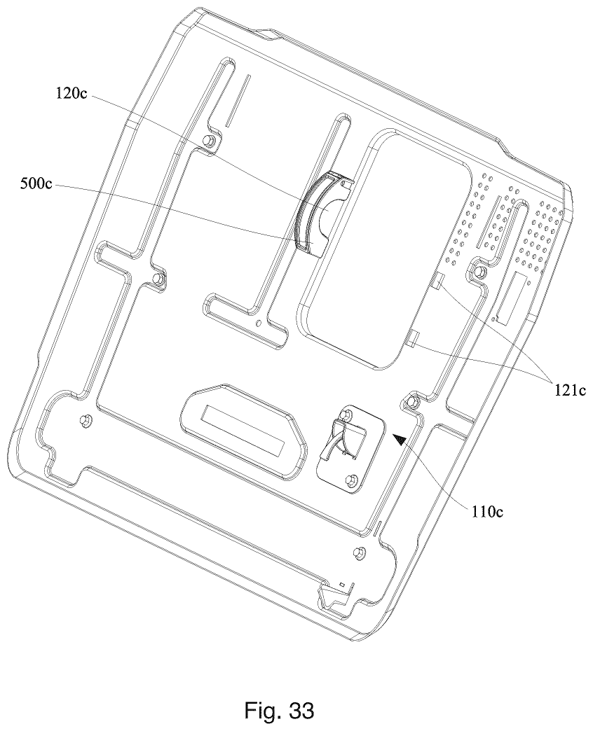

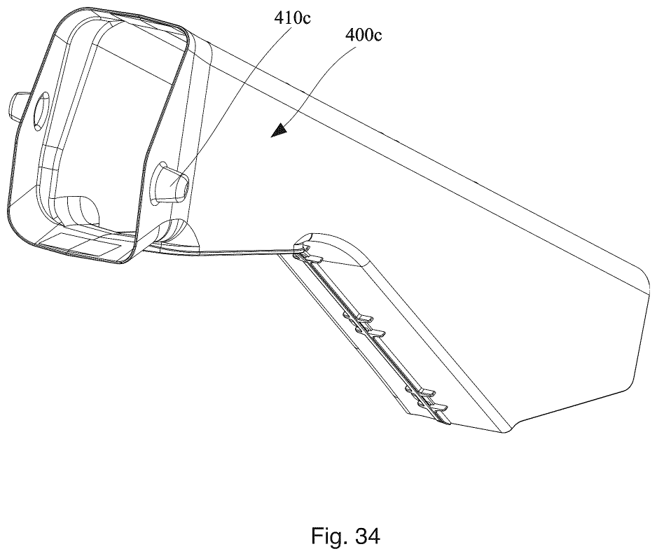

Refer to FIG. 33 and FIG. 34. In an embodiment of the lawn mower of this application, in the assembled state, two mounting holes 121c are provided on each of the left and right sides of the grass discharge chute 400c. The two mounting holes 121c on each side are arranged on the upper and lower sides of the mounting area 120c. A second buckle 512c is fixed on the main body portion 520c. The second buckle 512c and the first buckle 511c are respectively engaged with the two mounting holes 121c. The second buckle 512c is relatively fixed to the main body portion 520c. When fixing the fixing device 500c to the frame 100c, first engage the second buckle 512c into one mounting hole 121c, then abut the main body portion 520c against the mounting plate 110c, and rotate the first buckle 511c to the first position to achieve engagement between the first buckle 511c and the other mounting hole 121c. At this time, the locking device 530c, the limiting portion 5114c, and the limiting plate 522c can jointly restrict the relative rotation between the first buckle 511c and the main body portion 520c, ensuring stable connection between the fixing device 500c and the mounting plate 110c of the frame 100c.

An embodiment of a lawn mower has the beneficial effect of facilitating the adjustment of the grass discharge chute height, effectively ensuring that the grass discharge chute can make adaptive adjustments synchronously when the cutter deck is at height, meeting different usage requirements. Therefore, an embodiment effectively overcomes some practical problems in the existing technology and thus has high utilization value and practical significance.

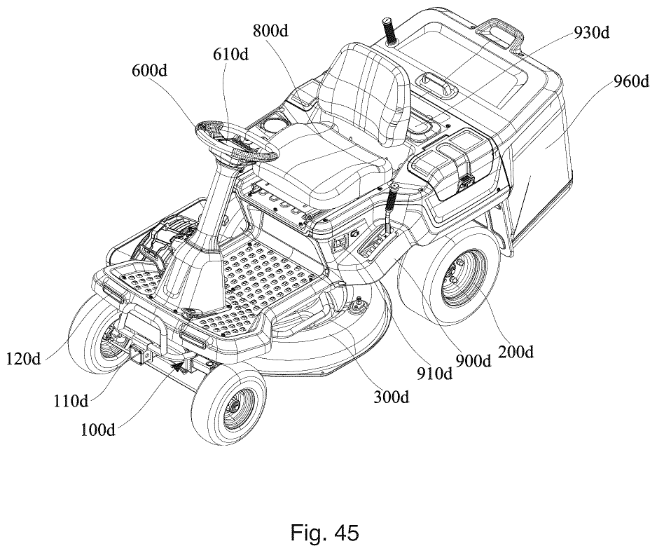

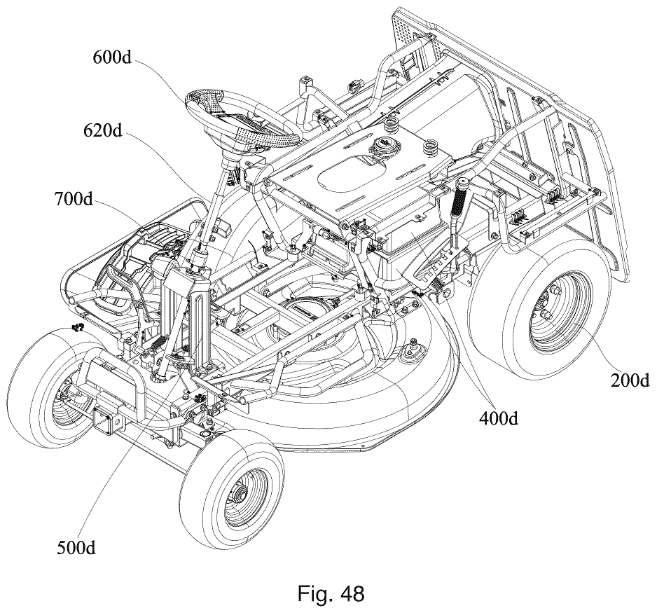

Referring to FIG. 45 to FIG. 49, an embodiment provides a lawn mower 100d, which includes a frame 100d, a walking mechanism 200d, a mowing deck assembly 300d, a control component 400d, a steering wheel bracket 500d, a steering wheel 600d, and a conductive slip ring 700d. The frame 100d provides mounting space for some components of the lawn mower 100d. The walking mechanism 200d is mounted on the frame 100d and includes a drive motor, walking wheels, etc. The walking mechanism 200d is used to drive the lawn mower 100d to move. The mowing deck assembly 300d is mounted on the frame 100d for mowing operations and includes components such as a mowing deck, cutting motor, and blades. The cutting motor drives the blades to trim the lawn. In one embodiment, the height of the mowing deck assembly 300d can be adjusted on the frame 100d to meet different usage requirements, such as trimming lawns of different heights or retracting the mowing deck assembly 300d for easy transport. The control component 400d is mounted on the frame 100d and controls the lawn mower 100d according to the operator's instructions or preset commands, including but not limited to controlling the walking mechanism 200d to drive the lawn mower 100d and controlling the operation of the mowing deck assembly 300d. The steering wheel bracket 500d is fixed to the frame 100d and provides support for the steering wheel 600d, improving the convenience for the operator to operate the steering wheel 600d. The steering wheel 600d is rotatably connected to the steering wheel bracket 500d. The support of the steering wheel bracket 500d for the steering wheel 600d reduces or eliminates wobbling when the steering wheel 600d rotates, improving the stability of the operator's operation. A display component 610d is installed on the steering wheel 600d, which can display the real-time status of the lawn mower 100d and other information. Additionally, the operator can input commands through the display component 610d to adjust the display content or issue operating instructions to the lawn mower 100d. The conductive slip ring 700d includes a first part 710d and a second part 720d that rotate relative to each other. The first part 710d is electrically connected to the second part 720d. The first part 710d is fixedly connected to the steering wheel 600d and electrically connected to the display component 610d. When the steering wheel 600d rotates, the wires between the first part 710d and the display component 610d rotate synchronously with the steering wheel 600d. The second part 720d is fixedly connected to the steering wheel bracket 500d and electrically connected to the control component 400d. In the original design, the display component 610d was directly connected to the control component 400d by wires. When the steering wheel 600d rotated, one end of the wires would rotate while the other end remained fixed, causing the wires to twist and tangle, which could lead to wire breakage and loose connections over long-term use. This application solves the problem of wire breakage and damage by using the conductive slip ring 700d to segment the original wires. The part of the conductive slip ring 700d connected to the display component 610d rotates synchronously with the steering wheel 600d without twisting or tangling, while the wires between the conductive slip ring 700d and the control component 400d remain fixed, also preventing twisting and tangling.

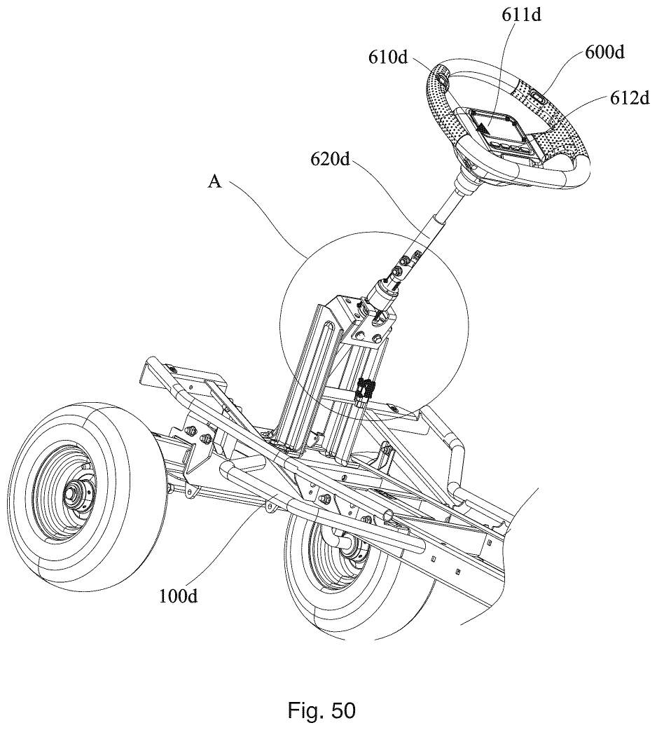

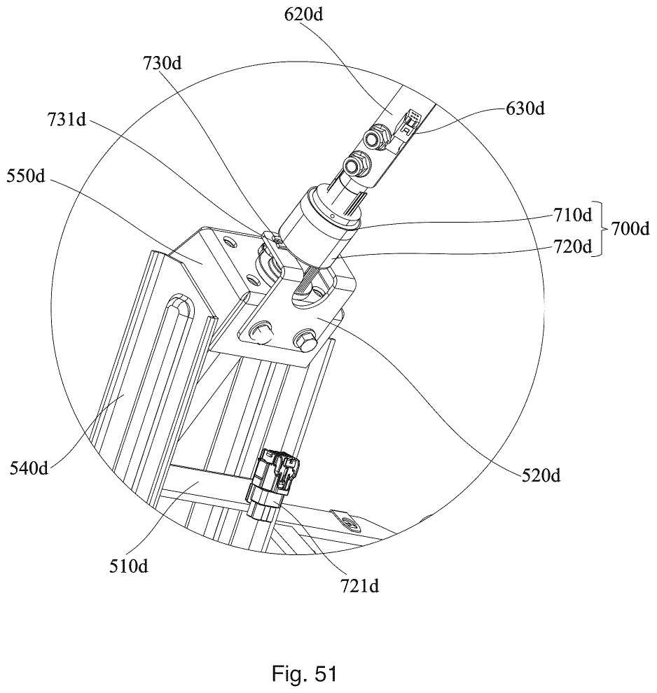

Please refer to FIG. 50 to FIG. 51. In an embodiment of the lawn mower of this application, the second component 720d is electrically connected to a plug-in terminal 721d. The plug-in terminal 721d is detachably connected to plug-in terminals 721d of other wires, facilitating wiring operations of the second component 720d and enabling convenient troubleshooting, replacement, and maintenance.

Please refer to FIG. 50 to FIG. 51. In an embodiment of the lawn mower of this application, the steering wheel frame 500d includes two second support plates 540d and a connecting plate 550d. The second support plates 540d are fixed on the frame 100d, and the connecting plate 550d is fixed between the tops of the two second support plates 540d, forming a gate-shaped structure. The connecting plate 550d is provided with a through-hole, through which the steering wheel shaft 620d passes and is rotatably connected. In one embodiment, a bearing is set inside the through-hole, and the steering wheel shaft 620d is rotatably connected to the connecting plate 550d through the bearing to ensure smooth rotation of the steering wheel 600d.

Please refer to FIG. 50 to FIG. 51. In one embodiment, the steering wheel frame 500d also includes a first support plate 510d. The two ends of the first support plate 510d are fixed to the two second support plates 540d respectively. The first support plate 510d can be set in the middle of the two second support plates 540d or on their side walls. Preferably, the first support plate 510d is set on the side walls of the second support plates 540d, enhancing the stability of the steering wheel frame 500d. The plug-in terminal 721d is detachably fixed on the first support plate 510d, allowing for the organization of wires and avoiding a chaotic arrangement that would make inspection difficult. The first support plate 510d is set on the side wall of the second support plate 540d near the control component 400d, facilitating the operator's disassembly and assembly operations on the plug-in terminal 721d on the first support plate 510d.

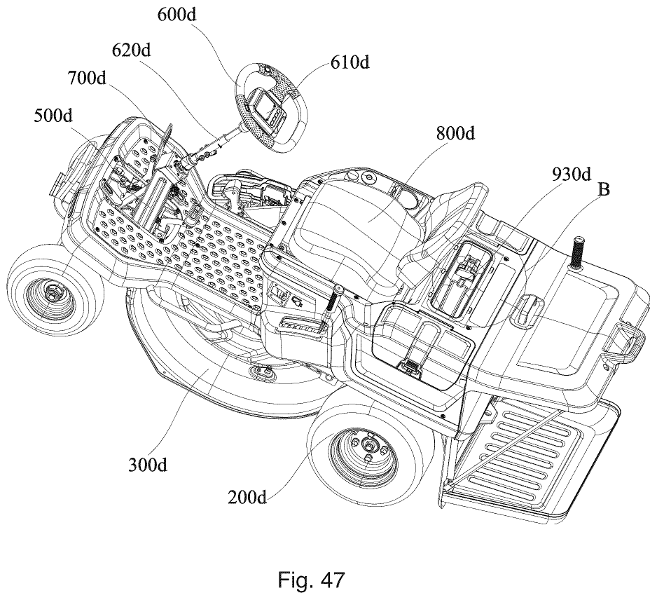

Please refer to FIG. 47 to FIG. 49. In an embodiment of the lawn mower of this application, the steering wheel 600d is connected to the steering wheel frame 500d through the steering wheel shaft 620d. The steering wheel shaft 620d is fixedly connected to the steering wheel 600d. A wire harness fixing frame 630d is set on the steering wheel shaft 620d, facilitating the organization of wires between the first component 710d and the display component 610d. This arrangement makes all wires clearly visible, avoiding a chaotic wire setup, facilitating inspection and maintenance, and improving neatness and aesthetics.

In an embodiment of the lawn mower in this application, the conductive slip ring 700d is fitted over the steering wheel shaft 620d, with the first part fixed to the steering wheel shaft 620d. The fixing method between the first part and the steering wheel shaft 620d can be varied. For example, threaded holes can be set on the first part, and screws can be screwed into the threaded holes to press against the steering wheel shaft 620d, achieving the fixation of the first part to the steering wheel shaft 620d. Alternatively, threaded holes can be set on the steering wheel shaft 620d, through-holes can be set on the side wall of the first part, and bolts can pass through the through-holes and connect with the threaded holes on the steering wheel shaft 620d, achieving the fixation of the first part to the steering wheel shaft 620d. Preferably, threaded holes are set on the side wall of the first part, and bolts are threaded into these holes to press against the steering wheel shaft 620d, achieving the relative fixation of the first part to the steering wheel shaft 620d.

Please refer to FIG. 50 and FIG. 51. In an embodiment of the lawn mower in this application, a support frame 520d is fixed on the steering wheel frame 500d. The second component 720d is set above the support frame 520d and abuts against the top wall of the support frame 520d. The support frame 520d supports the second component 720d from below, enhancing the firmness of the conductive slip ring 700d fixation and its own stability. This prevents issues such as the second component 720d separating from the first component 710d due to long-term use, bumps, and the gravity of the second part itself, thereby increasing the service life of the conductive slip ring 700d and reducing the maintenance of the lawn mower.

In an embodiment, a groove is set on the top of the support frame 520d. The groove penetrates the end wall of the support frame 520d, and its width is greater than the diameter of the steering wheel shaft 620d. During assembly, at least part of the steering wheel shaft 620d is located within the groove, increasing the contact area between the support frame 520d and the second component 720d, improving the supporting effect of the support frame 520d, and enhancing the stability of the second component 720d.

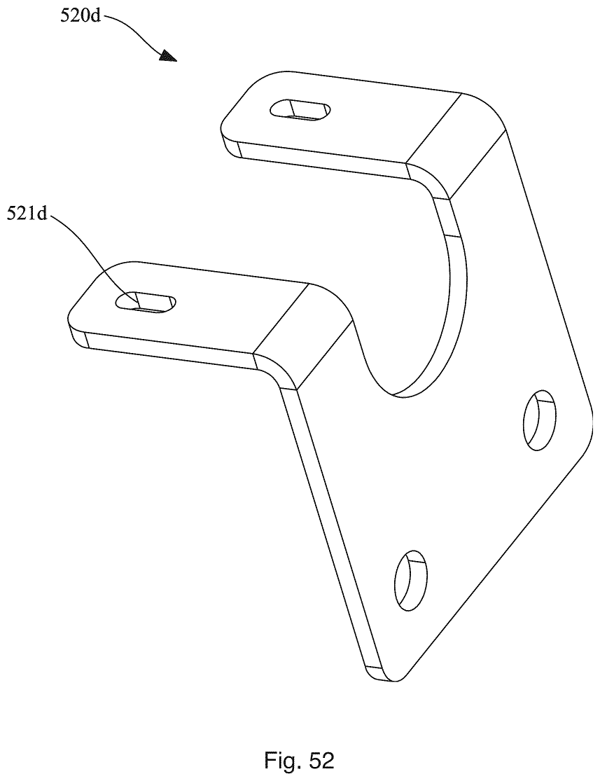

Refer to FIG. 50 to FIG. 52. In an embodiment of the lawn mower of this application, an oval hole 521d is set on the top of the support frame 520d. The second component 720d has a mounting portion 730d with a mounting hole 731d. The mounting hole 731d and the oval hole 521d are connected by a connecting member, which can be a bolt or other connecting component. The oval hole 521d can increase the fitting tolerance with the mounting hole 731d, ensuring that the second component 720d and the support frame 520d can still be stably connected within a larger tolerance range.

In an embodiment of the lawn mower of this application, the side of the mounting hole 731d penetrates the side wall of the mounting portion 730d to accommodate the adjustment of the connecting member's position within the mounting hole 731d, facilitating the connection between the second component 720d and the support frame 520d. Preferably, the direction in which the mounting hole 731d penetrates the side wall of the mounting portion 730d is perpendicular to the length direction of the oval hole 521d. In other words, the connecting member can adjust its position in a first direction within the oval hole 521d, and in a second direction within the mounting hole 731d. The first direction is perpendicular to the second direction, allowing the connecting member to be adjusted in both directions, making it more convenient to assemble the second component 720d with the support frame 520d.

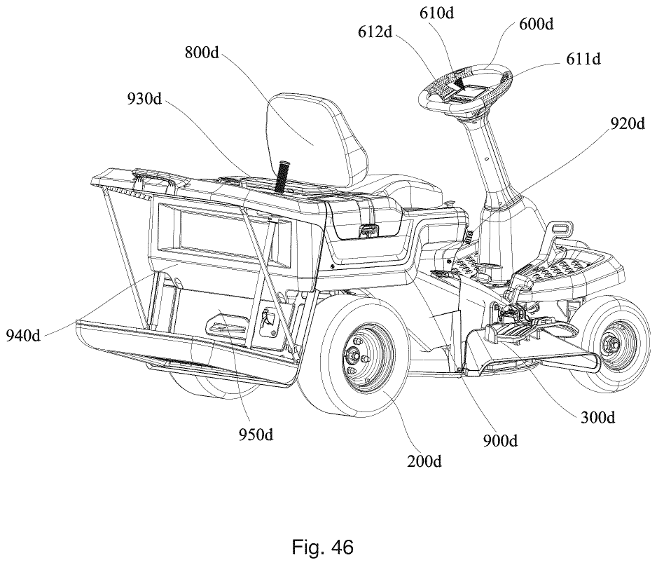

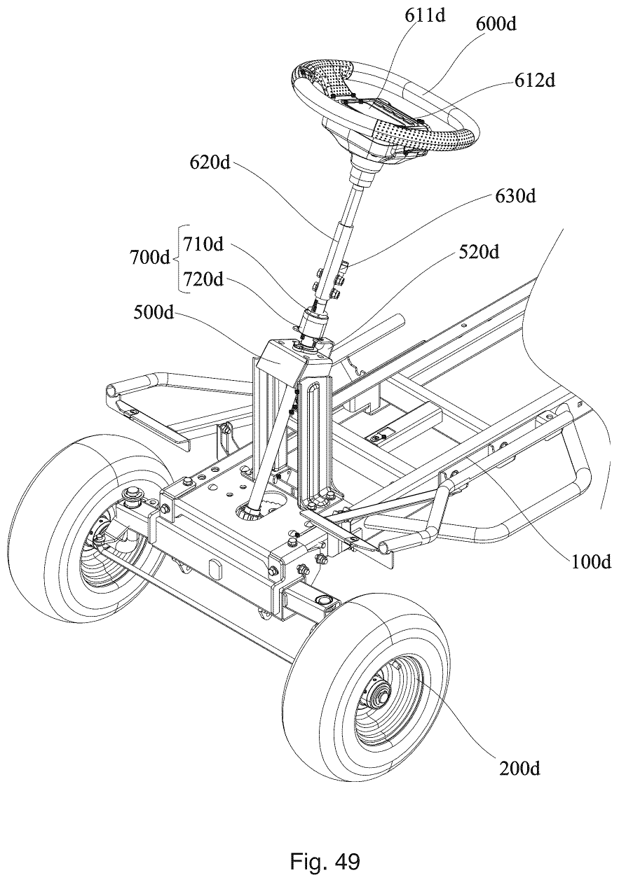

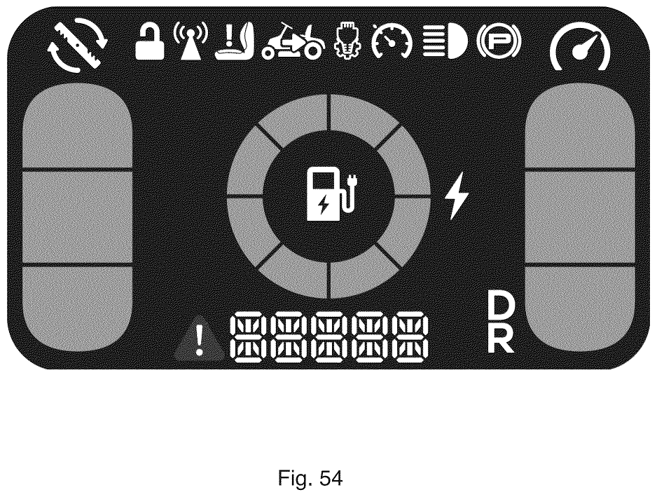

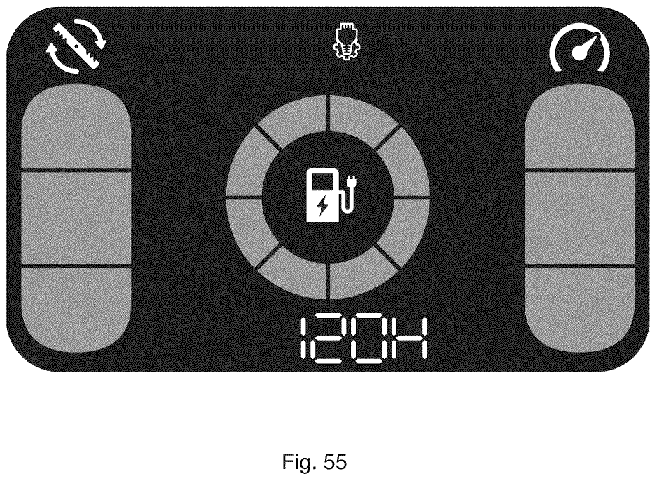

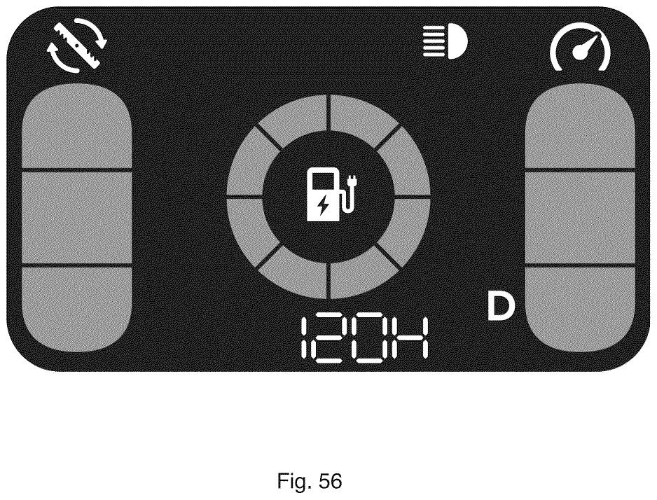

Please refer to FIG. 46, FIG. 49, and FIG. 54. In an embodiment of the lawn mower of this application, the display component 610d includes a display screen 611d. Display icons for showing the lawn mower status are set on the display screen 611d to display various states of the lawn mower. The content that can be displayed on the display screen 611d includes cutting blade gear indication, grass collection device in-place switch, GPS online status, seat switch (whether the operator is in place), reverse mowing function, power interface icon, constant speed cruise status, light status, parking status, walking gear, etc. The display screen 611d also shows battery level symbol, real-time speed, motor speed, etc., to facilitate the operator's real-time understanding of the lawn mower's status. The display icons light up according to the actual situation. As shown in FIG. 55, when an accessory is connected to the power interface and confirmed by the operator, the power interface icon lights up. As shown in FIG. 56, when the lights are turned on, the light status icon lights up. When the grass collection device 960d is installed in place, the grass collection device in-place switch icon lights up, etc.

Please refer to FIG. 46 and FIG. 49. In an embodiment of the lawn mower of this application, the display component 610d includes control buttons 612d set around the periphery of the display screen 611d. The control buttons 612d can adjust the lawn mower's walking gear, cutting blade gear, turn on/off lights, and control the on/off of the power interface 920d, etc. In an embodiment, the control buttons 612d can also adjust the display content of the display screen 611d to meet the operator's diverse needs for lawn mower information.

In an embodiment of the lawn mower of this application, a housing 900d is set on the lawn mower. The rear frame 100d of the lawn mower is connected as a whole, and the housing 900d is positionally connected to the integrated frame 100d and partially or fully covers the frame 100d, increasing the aesthetic appeal of the lawn mower. In an embodiment, the housing 900d covers the steering wheel shaft 620d and the steering wheel frame 500d. The wires are set inside the housing 900d to avoid wire exposure. A conductive slip ring 700d is set to make the wires easier to organize and prevent them from tangling inside the housing 900d.

Please refer to FIG. 45 to FIG. 48. In an embodiment of the lawn mower of this application, a riding seat 800d is set on the lawn mower. The riding seat 800d facilitates the operator to sit and control the lawn mower. The riding seat 800d is fixed on the frame 100d, and the control component 400d is installed on the frame 100d under the riding seat 800d. The installation space enclosed by the riding seat 800d and the frame 100d facilitates the assembly of the control component 400d.

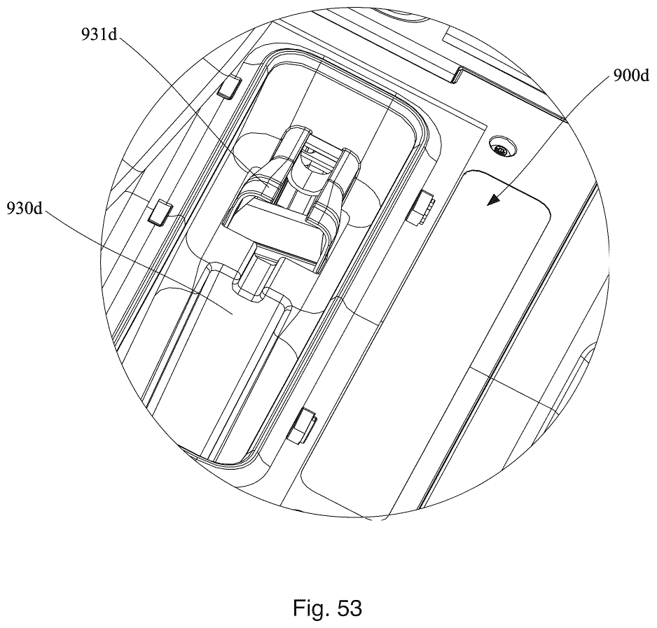

Referring to FIG. 45 to FIG. 47 and FIG. 53, in an embodiment of the lawn mower of this application, a battery compartment is set on the housing 900d at the rear and/or side of the riding seat 800d. The battery compartment is used to install the battery pack, which powers various components of the lawn mower, such as powering the drive motor to drive the lawn mower's movement, and powering the cutting motor to drive the cutting blade for mowing. The control component 400d is set below the riding seat 800d, that is, between the battery compartment and the steering wheel 600d. The wiring between the control component 400d and the battery compartment, as well as between the control component 400d and the steering wheel 600d, is convenient, with shorter wiring distances, facilitating organization and reducing wire failures.

Referring to FIG. 45 to FIG. 47, in an embodiment of the lawn mower of this application, a spare battery compartment 930d is set on the housing 900d at the rear of the riding seat 800d. The spare battery compartment 930d is equipped with a connector and a connector fixing part 931d. The connector fixing part 931d is used to place the connector for easy organization, and can also prevent the connector from colliding with the battery pack during lawn mower bumps, avoiding damage to the battery pack. The connector facilitates connection to the battery pack in the spare battery compartment 930d when needed.

As an example, the control component 400d includes a controller. In an embodiment, the controller for the traveling mechanism 200d and the controller for the mowing deck component 300d are independent. That is, the controller for the traveling mechanism 200d only controls the traveling mechanism 200d, and the controller for the mowing deck component 300d only controls the mowing deck component 300d. When there are multiple cutting blades, they can be controlled by multiple controllers separately, or one controller can control multiple cutting blades. In another embodiment, the controller is a master controller, which can control both the movement of the traveling mechanism 200d and the cutting of the mowing deck component 300d.

Referring to FIGS. 45-47, in an embodiment of the lawn mower of the present application, the housing 900d under the riding seat 800d covers the control assembly 400d. The housing 900d is provided with a charging interface 910d, a power interface 920d, and so on. The charging interface 910d is used for charging the battery pack inside the lawn mower, while the power interface 920d is used for discharging to external accessories. In an embodiment, the power interface 920d can be used both for charging the battery pack inside the lawn mower and for discharging to external accessories. The charging interface 910d and power interface 920d are located near the control assembly 400d, facilitating wire arrangement and insulation setup.

In an embodiment of the lawn mower of the present application, the front side of the housing 900d under the riding seat 800d slopes downward from top to bottom towards the rear of the lawn mower, thus forming a larger clearance space in front of and below the riding seat 800d, accommodating different driving posture habits of various operators.

Referring to FIG. 45, in an embodiment of the lawn mower of the present application, a headlight 120d is installed at the front end of the lawn mower frame 100d to meet lighting needs. An accessory connection part 110d is also provided at the front end of the frame 100d for installing accessories such as snow sweeping structures, blowers, etc.

Referring to FIG. 46, in an embodiment of the lawn mower of this application, a mounting plate 950d is provided at the rear of the lawn mower 120d. The mounting plate 950d is used to mount a grass collection device 960d to meet grass collection needs. When the grass collection device 960d is not installed, the mounting plate 950d is exposed outside the lawn mower 120d, especially components such as the grass discharge chute are exposed, affecting aesthetics. A rear shield 940d is provided at the rear of the lawn mower 120d. When the grass collection device 960d is not installed, the rear shield 940d covers at least part of the mounting plate 950d, such as the installation area of the grass discharge chute, to improve the overall neatness of the lawn mower's 120d exterior and enhance aesthetics.

This application also provides a gardening tool, including a frame, a walking mechanism, a working part, a control component, a steering wheel bracket, a steering wheel, and a conductive slip ring. The walking mechanism is mounted on the frame to drive the gardening tool to move; the working part is mounted on the frame for the gardening tool to work, such as mowing or snow sweeping; the control component is mounted on the frame to control the gardening tool; the steering wheel bracket is mounted on the frame to support the steering wheel; the steering wheel is rotatably connected to the steering wheel bracket, and a display component is mounted on the steering wheel; the conductive slip ring includes a first part and a second part that rotate relative to each other, the first part is electrically connected to the second part, the first part is fixedly connected to the steering wheel and electrically connected to the display component; the second part is fixedly connected to the steering wheel bracket and electrically connected to the control component. By using the conductive slip ring to segment the original wires, the part connected to the display component rotates synchronously with the steering wheel without twisting or entanglement, while the wires between the conductive slip ring and the control component remain fixed, also preventing twisting or entanglement, thus solving the problem of easy breakage and damage of the original wires.

An embodiment, a lawn mower, has the beneficial effect of avoiding relative movement between wires and the steering wheel, preventing problems such as wire twisting and entanglement, reducing issues like wire breakage and loose connections, and decreasing the failure rate of the lawn mower 120d.

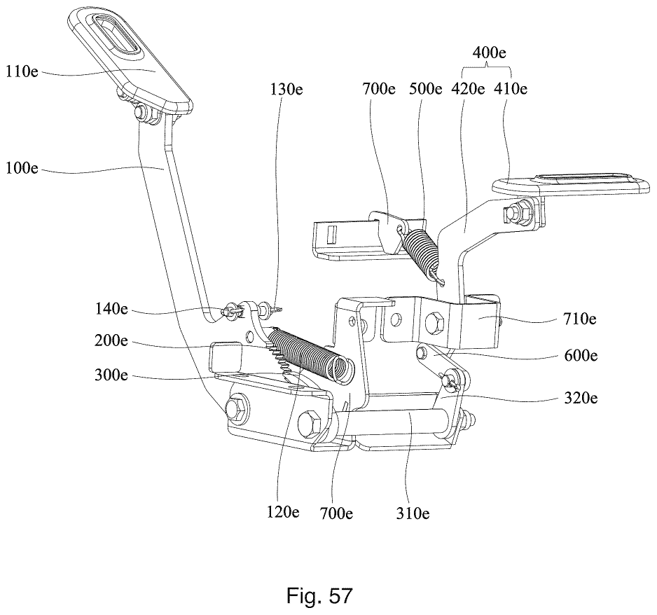

Please refer to FIG. 57 to FIG. 62. An embodiment provides a parking device and a lawn mower 800e. The parking device establishes a connection with the brake member through a first locking member 200e, enabling the parking device and the brake member to share a set of braking components. The braking system is locked through the cooperation of the first locking member 200e and the second locking member 300e, achieving a parking effect. Additionally, a parking component 400e is set up, using a foot brake method to achieve the parking braking process. The parking brake is released through an elastic reset member 500e, making the operation simple and convenient. This saves the cost of an additional braking system and does not occupy extra control space, making it suitable for lawn mowers 800e with small vehicle bodies and control spaces.

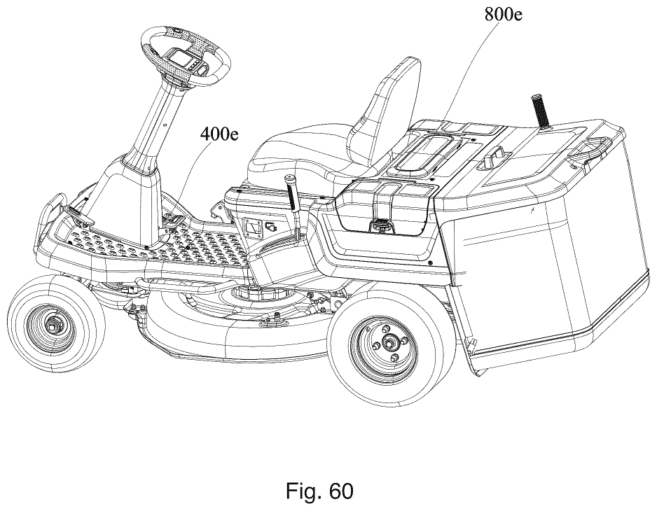

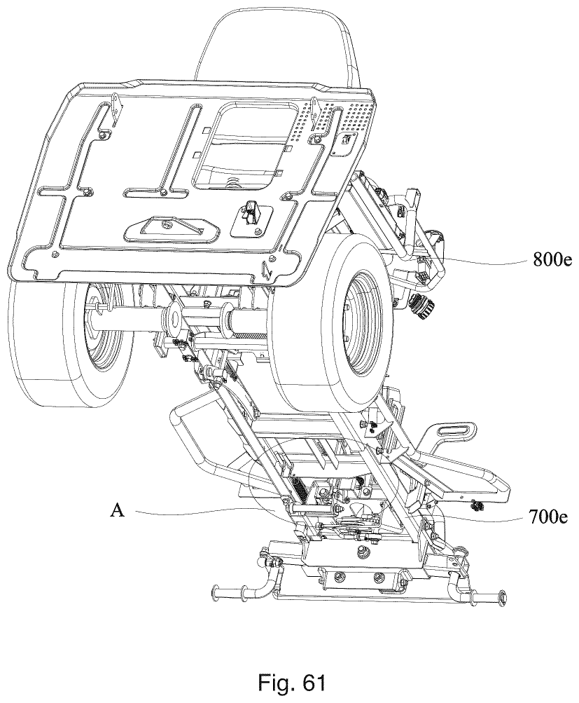

Please refer to FIG. 57, FIG. 60, and FIG. 61. FIG. 57 is a structural diagram of an embodiment of the parking device. FIG. 60 is an overall structural diagram of an embodiment of the lawn mower. FIG. 61 is a diagram showing the installation position of the parking device after removing some structures from an embodiment of the lawn mower. An embodiment provides a lawn mower 800e, which includes a vehicle frame 700e and a parking device. The parking device is installed on the vehicle frame 700e. The vehicle frame 700e is also used for integrated installation of the lawn mower's 800e mowing device, brake member, and drive system, as well as other components of the lawn mower 800e, which will not be elaborated here. The drive system is used to drive the lawn mower 800e to move. The mowing device moves along with the lawn mower 800e on the vehicle frame 700e to perform mowing operations, reducing the labor intensity of mowing. The parking device can effectively ensure the stability of the lawn mower 800e in a stopped state, preventing rolling and avoiding equipment damage or collision accidents. The structure and installation relationships of the vehicle frame 700e, mowing device, brake member, and drive system in this application can refer to existing technologies and will not be elaborated here.

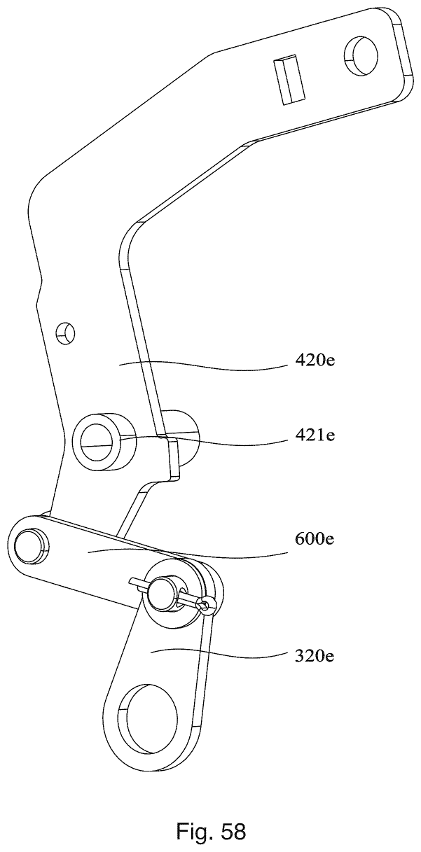

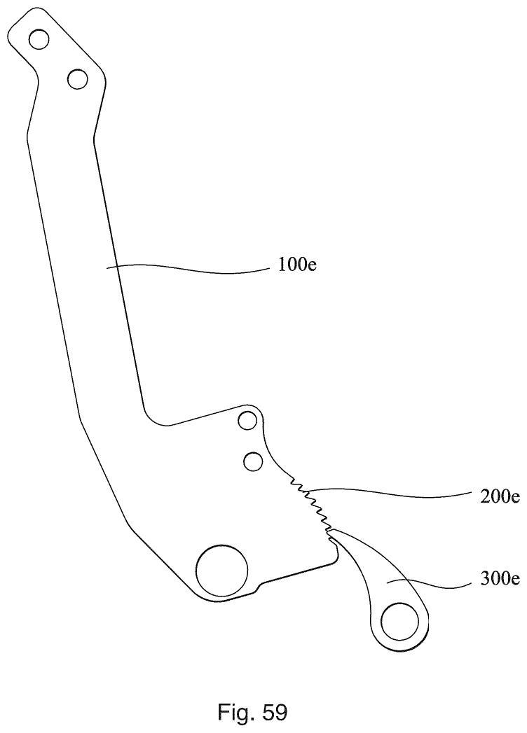

Refer to FIG. 57 to FIG. 59. FIG. 58 is a schematic diagram showing the connection of the connecting arm, connecting rod, and cantilever in an embodiment of the parking device. FIG. 59 is a schematic diagram showing the cooperation between the first locking member and the second locking member in an embodiment of the parking device. An embodiment provides a parking device, including: a brake arm 100e, a first locking member 200e, a second locking member 300e, a parking assembly 400e, and an elastic reset member 500e. The brake arm 100e is rotatably installed on the vehicle frame 700e and connected to the brake pulling end 130e of the brake member to perform braking operations. In an embodiment, the brake member includes a drum brake or disc brake driven by a brake lever or brake cable to brake the drive system. The brake pulling end 130e of the brake lever or brake cable is installed on the brake arm 100e and controlled by the brake arm 100e. Depending on actual needs, the brake member can also be other existing structures, which will not be described further here. The brake pulling end 130e is preferably rotatably installed on the brake arm. In this embodiment, the brake pulling end 130e is rotatably installed on the brake arm 100e through a rotating shaft 140e. A brake pedal 110e is provided on the brake arm 100e for braking by stepping. The first locking member 200e is set on the brake arm 100e. The first locking member 200e can be integrally set with the brake arm 100e or separately set and fixedly connected to the brake arm 100e. The second locking member 300e is rotatably installed on the vehicle frame 700e and cooperates with the first locking member 200e during rotation to achieve unlocking and locking of the brake arm 100e. When the brake arm 100e is braking, it tends to reset under the action of the brake reset member 120e, causing the first locking member 200e and the second locking member 300e to interlock, thereby locking the brake arm 100e to achieve parking effect. After releasing the locking between the first locking member 200e and the second locking member 300e, the locking of the brake arm 100e can be released, and the parking state is consequently released. This allows one set of brake members to serve both braking and parking functions, eliminating the need for additional parking brake structures for the drive device, effectively saving costs and space for the lawn mower 800e. The brake reset member 120e includes, but is not limited to, springs.

Refer to FIG. 57 to FIG. 59, the parking assembly 400e is rotatably mounted on the frame 700e to drive the second locking member 300e to rotate. When parking, the parking pedal 400e is stepped on, and the elastic reset member 500e is pulled, thereby storing elastic potential energy and having a tendency to recover deformation. One end of the elastic reset member 500e is fixedly installed on the frame 700e, and the other end is connected to the parking assembly 400e to pull the parking assembly 400e to reset after the first locking member 200e and the second locking member 300e are unlocked.

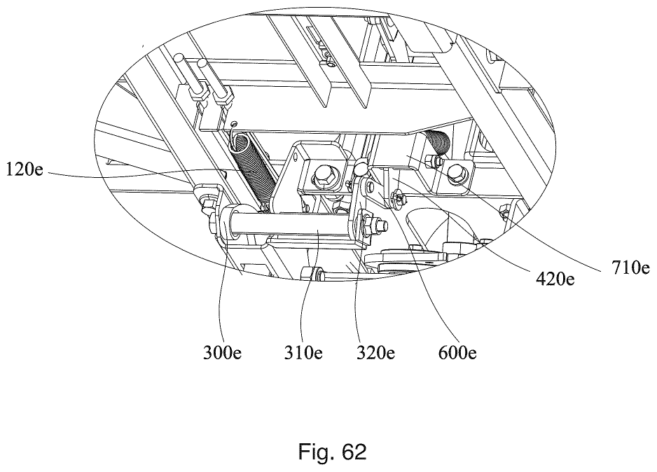

Refer to FIG. 57 to FIG. 62, FIG. 62 is an enlarged view of area A in FIG. 61. In an embodiment of the parking device, the parking assembly 400e includes a pedal 410e and a connecting arm 420e. The shape of the pedal 410e is not limited and is used to provide sufficient force-bearing surface for convenient stepping to perform parking braking. A connecting arm bracket 710e is provided on the frame 700e, and the middle part of the connecting arm 420e is rotatably installed on the connecting arm bracket 710e of the frame 700e. The connecting arm bracket 710e is “ [symbol] ” shaped (as shown in FIG. 57), which can limit the rotation amplitude of the connecting arm 420e to prevent interference between the parking device and other structures of the lawn mower 800e. The pedal 410e is installed at one end of the connecting arm 420e, and the connecting arm 420e drives the second locking member 300e to rotate. The method by which the connecting arm 420e drives the second locking member 300e to rotate is not limited, for example, gear meshing, connecting rod 600e, etc. In this embodiment, the connecting arm 420e drives the second locking member 300e to rotate through the connecting rod 600e, which can connect the connecting arm 420e and the second locking member 300e at a certain distance and occupies little space.

Please refer to FIG. 57 to FIG. 59. In an embodiment of the parking device, a middle part of the connecting arm 420e is provided with a first rotating shaft 421e. The connecting arm 420e is rotatably mounted on the frame 700e through the first rotating shaft 421e. When the pedal 410e is stepped on, the connecting arm 420e rotates around the first rotating shaft 421e, and the end of the connecting arm 420e away from the pedal 410e moves simultaneously. At this time, the second locking member 300e to be rotated is the load at the end of the connecting arm 420e away from the pedal 410e. Therefore, installing the parking assembly 400e on the end of the connecting arm 420e farther from the first rotating shaft 421e increases the force arm when stepping on the pedal 410e, making the parking step more effortless.

Please refer to FIG. 57 to FIG. 59. In an embodiment of the parking device, one of the first locking member 200e and the second locking member 300e is a lock head, and the other is a tooth meshing with the lock head. The lock head and the tooth cooperate with each other, located on one side of each other's reset direction and engaged in contact, forming a locked state. To release the lock, simply step on the brake pedal 110e again, rotate the brake arm 100e to move the tooth away from the lock head. The lock head then resets under the action of the elastic reset member 500e. After releasing the brake pedal 110e, the brake arm 100e can also reset to its initial state, at which point the brake state is released, and the parking state is also released.

Please refer to FIG. 57 to FIG. 59. In an embodiment of the parking device, the first locking member 200e is a tooth, and the second locking member 300e is a lock head, with one end of the lock head meshing with the tooth. In another embodiment, the first locking member 200e can also be a lock head, and the second locking member 300e can be a tooth. Those skilled in the art can also set up other first locking members 200e and second locking members 300e with locking functions as needed. One end of the lock head meshes with the tooth, and the other end is rotatably mounted on the frame 700e through a second rotating shaft 310e. The end of the second rotating shaft 310e away from the lock head is provided with a cantilever 320e, and the cantilever 320e is connected to the connecting arm 420e through a connecting rod 600e.

Please refer to FIG. 57 to FIG. 59. The two ends of the connecting rod 600e are rotatably connected to the end of the cantilever 320e away from the second rotating shaft 310e and the end of the connecting arm 420e away from the pedal 410e, respectively. Since the end of the connecting arm 420e moves in an arc during rotation, rotatably connecting the connecting rod 600e with the connecting arm 420e and the cantilever 320e allows the length direction of the connecting rod 600e to change constantly, thus pulling the cantilever 320e and causing the rotation of the second rotating shaft 310e.

Please refer to FIG. 57 to FIG. 59. In an embodiment of the parking device, the end of the elastic reset member 500e away from the frame 700e is rotatably installed on the connecting arm 420e. Since one end of the elastic reset member 500e is fixed, when the connecting arm 420e rotates, the connection point between the elastic reset member 500e and the connecting arm 420e moves in an arc. Rotatably installing the end of the elastic reset member 500e away from the frame 700e on the connecting arm 420e can maximize the elastic utilization of the elastic reset member 500e.

Please refer to FIG. 57 to FIG. 59. In an embodiment of the parking device, the type of elastic reset member 500e is not limited and includes but is not limited to springs. In this embodiment, the elastic reset member 500e is a spring, which has a low cost and can meet the force requirements for resetting as the reset load of the parking component 400e is relatively small.

Please refer to FIG. 57 to FIG. 59. In an embodiment of the parking device, there are multiple teeth, and these multiple teeth are evenly spaced along the edge of the brake arm 100e. When the lock head engages with different teeth, the locking effect on the brake member varies, resulting in different parking effects. Depending on the different parking positions of the lawn mower 800e, such as the horizontal angle of the parking surface, the lock head can engage with different teeth to maintain different braking forces of the brake member, thereby extending the service life of the brake member.

An embodiment of the parking device and lawn mower establishes a connection between the parking device and the brake member through the first locking member, allowing the parking device and brake member to share a single braking assembly. The parking system is locked by the cooperation of the first locking member and the second locking member, achieving the parking effect. Meanwhile, the parking component is set up to implement the parking braking process using a foot brake method, and the parking brake is released through the elastic reset member. This operation is simple and convenient, saves the cost of an additional braking system, and does not occupy extra control space, making it suitable for lawn mowers with small vehicle bodies and control spaces.

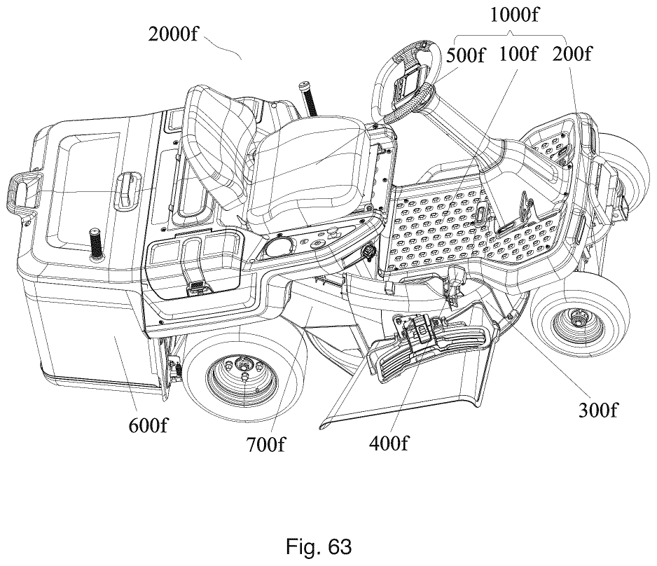

Please refer to FIG. 63 to FIG. 80. An embodiment provides a lawn mower 1000f and a lawn mowing system 2000f. The lawn mower 1000f includes a switching mechanism 400f on the cutting deck 300f, which can achieve switching between open and closed states of the first grass discharge opening 3111f, thereby enabling switching between different working modes of the lawn mower 1000f. Additionally, by setting up a locking component 430f, the stability of the baffle 410f in different positions is increased, which can reduce the probability of the baffle 410f becoming displaced when the lawn mower 1000f experiences bumps or vibrations during operation. This further improves the stability of the open or closed state of the first grass discharge opening 3111f, ensuring the operational efficiency stability of the lawn mower 1000f in different working modes.

Please refer to FIG. 63. An embodiment provides a lawn mowing system 2000f, which includes a lawn mower 1000f and a grass collection bag 600f. The grass collection bag 600f is installed on the lawn mower 1000f and connected to it. The connection method can be through an interface provided by the grass collection bag 600f itself connecting to the lawn mower 1000f, or the lawn mower 1000f may have an extended interface connecting to the grass collection bag 600f, or an additional grass discharge chute 700f can be set up. In this embodiment, the lawn mowing system 2000f includes a grass discharge chute 700f. One end of the grass discharge chute 700f is connected to the grass collection bag 600f, while the other end is connected to the lawn mower 1000f, thereby transferring the grass clippings cut by the lawn mower 1000f through the grass discharge chute 700f into the grass collection bag 600f for centralized processing. This lawn mowing system 2000f integrates the lawn mower 1000f, grass collection bag 600f, and grass discharge chute 700f into a single installation, resulting in a compact structure that can automatically process grass clippings produced during mowing in a timely manner, reducing the workload of on-site workers. It should be noted that the specific installation structures of the grass collection bag 600f and grass discharge chute 700f on the frame 100f in this application can refer to existing structures and will not be elaborated further here.

FIG. 63, further describing the lawn mower 1000f in the above embodiment, the lawn mower 1000f includes: a frame 100f, a mowing deck 300f, and a switching mechanism 400f. The frame 100f is equipped with a walking mechanism 200f, and a seat 500f may or may not be installed on the frame 100f; in this embodiment, to improve the driver's comfort, a seat 500f is installed on the frame 100f; the specific structure of the frame 100f is not limited. The walking mechanism 200f is installed on the frame 100f to drive the frame 100f to move, the walking mechanism 200f may include components such as a drive unit, a power supply unit, etc. The power supply unit provides energy for the drive unit, which can be a battery, a diesel engine, a gasoline engine, or a hybrid engine; the drive unit provides power for the rotation of the walking wheels, which can be an electric motor, an electric motor+reducer, an electric motor+gear rack transmission mechanism, or an electric motor+screw nut transmission mechanism, or any transmission mechanism that meets the requirements; the walking mechanism 200f controls the corresponding walking action of the frame 100f. The mowing deck 300f is installed on the frame 100f, and the installation position of the mowing deck 300f on the frame 100f is not limited, for example, it can be installed at the front end of the frame 100f, in the middle of the frame 100f, or at the rear end of the frame 100f, as long as it meets the installation requirements for mowing operations.

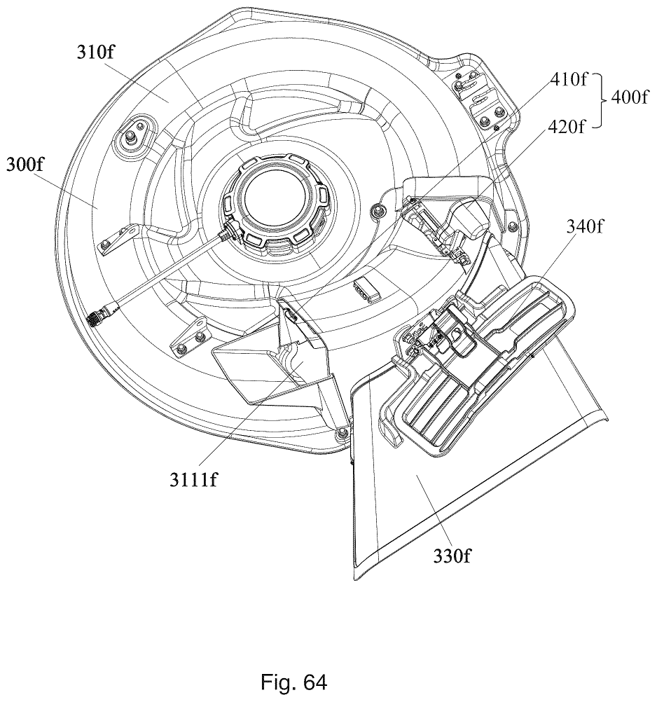

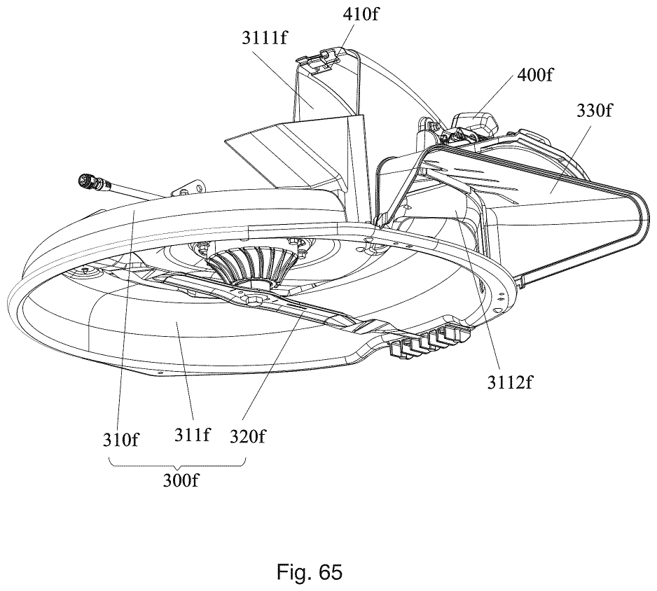

FIG. 64 and FIG. 65, further describing the mowing deck 300f, which includes a housing 310f and a cutter 320f. The housing 310f is fixedly connected to the bottom of the frame 100f by, but not limited to, bolts. A mowing chamber 311f is formed inside the housing 310f, and a first grass discharge port 3111f is opened on the mowing chamber 311f. The first grass discharge port 3111f can be set on the side wall of the mowing chamber 311f or on the top wall of the mowing chamber 311f, which is not restricted; in this embodiment, the first grass discharge port 3111f is opened on the top wall of the mowing chamber 311f, the specific cross-sectional shape and area of the first grass discharge port 3111f are not limited, as long as it allows the discharge of cut grass clippings. The cutter 320f is rotatably installed on the housing 310f and located inside the mowing chamber 311f. The rotatable installation method is not limited and can be through motor rotation installation, motor+reducer rotation installation, or motor+gear transmission rotation method. When the cutter 320f rotates, it cuts the grass inside the mowing chamber 311f to achieve mowing operation.

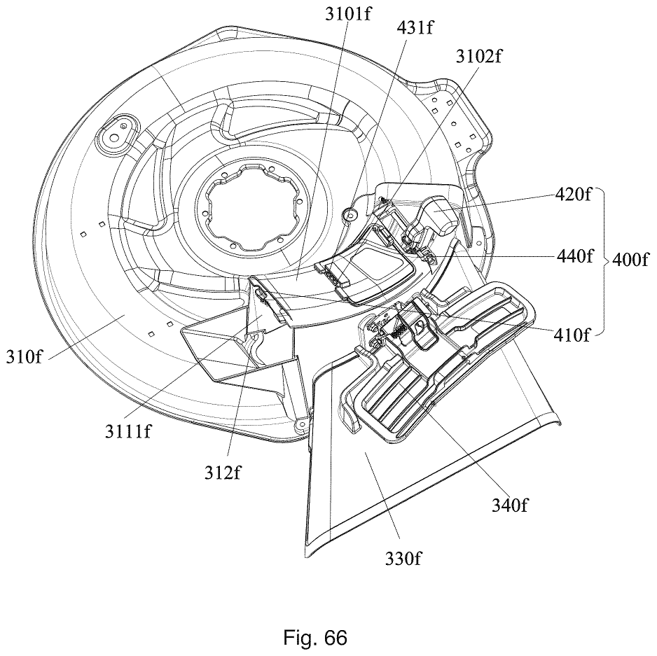

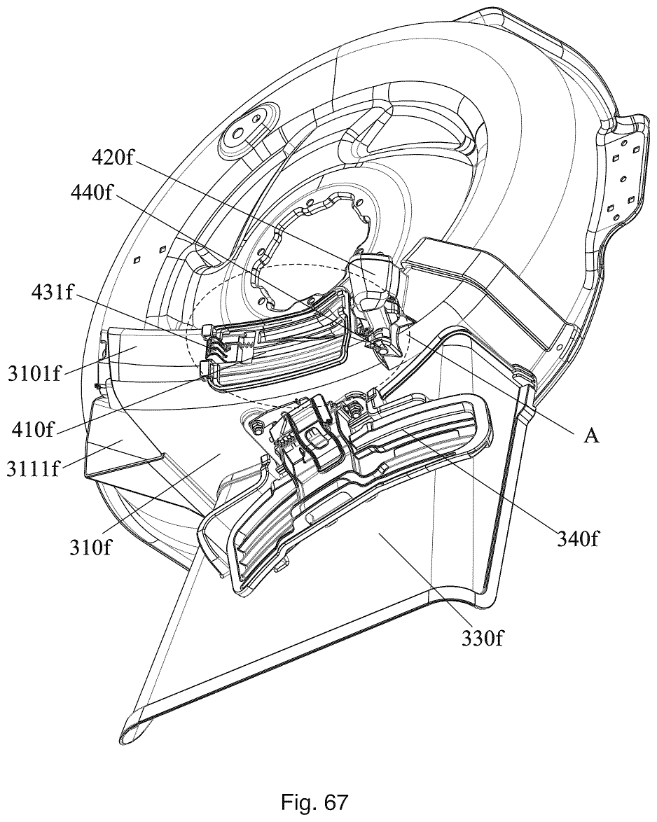

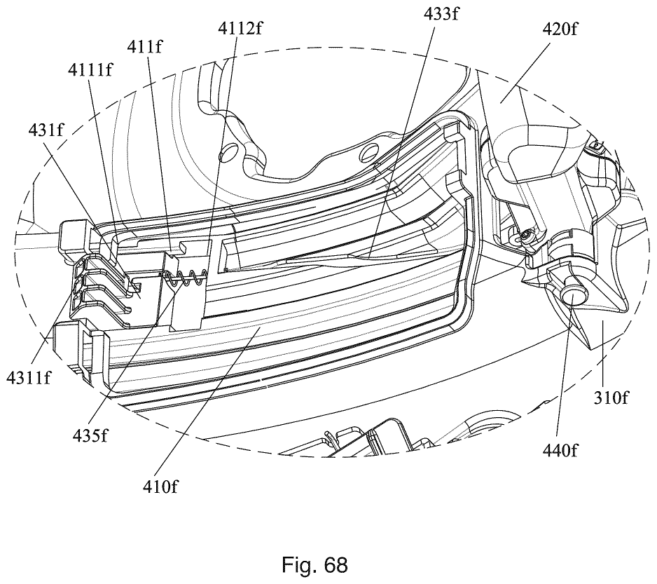

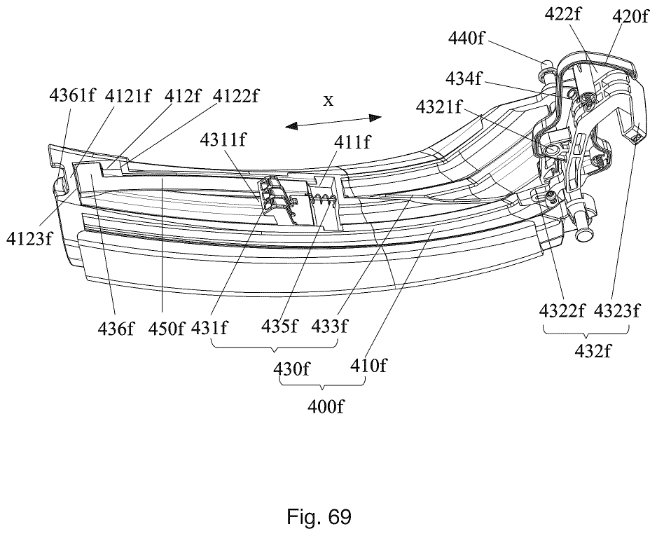

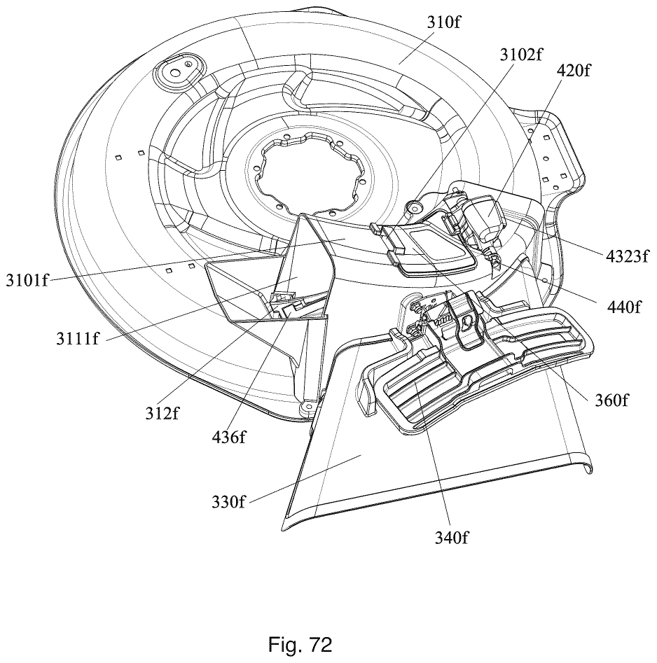

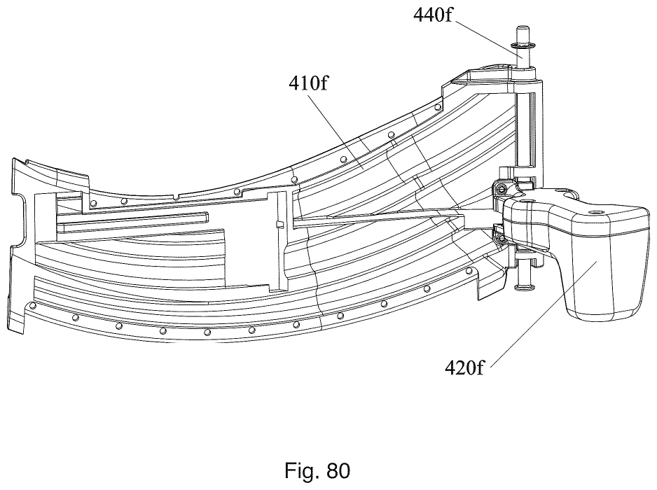

Please refer to FIG. 63, FIG. 66, FIG. 67, FIG. 68, FIG. 69, FIG. 72 and FIG. 80 for further description of the switching mechanism 400f. The switching mechanism 400f includes a baffle plate 410f, a handle 420f, and a locking assembly 430f. The handle 420f is rotatably connected to the outer wall of the housing 310f. One end of the handle 420f is fixedly connected to the baffle plate 410f. The fixed connection method can be an integrally formed connection or a bolt-fixed connection, etc. The other end of the handle 420f extends towards the outside of the housing 310f. The end of the baffle plate 410f away from the handle 420f extends into the interior of the housing 310f, and the baffle plate 410f rotates inside the housing 310f. The rotatable connection of the handle 420f on the outer wall of the housing 310f can be through a bearing rotation connection or an axle-hole clearance fit rotation connection, etc. By setting up the handle 420f, the operator only needs to rotate the handle 420f on the outside of the housing 310f to achieve the rotation of the baffle plate 410f inside the housing 310f. This method is convenient to operate and has a simple structure. It should be noted that in other embodiments, the baffle plate 410f can also be rotatably connected to the outer wall of the housing 310f, which can also achieve the rotation of the baffle plate 410f when rotating the handle 420f. Specifically, the baffle plate 410f is rotatably installed near the position of the first grass discharge port 3111f, which facilitates the action of the baffle plate 410f relative to the first grass discharge port 3111f. The baffle plate 410f has at least a first position and a second position on the housing 310f. When the baffle plate 410f is in the second position, it completely closes the first grass discharge port 3111f to prevent grass clippings from being discharged from the position of the first grass discharge port 3111f, stopping the grass collection operation. When the baffle plate 410f rotates away from the second position, it opens the first grass discharge port 3111f, and when the baffle plate 410f is in the first position, it fully opens the first grass discharge port 3111f, i.e., the first grass discharge port 3111f is in its maximum open state. At this time, grass clippings can be discharged from the first grass discharge port 3111f into the grass collection bag 600f, putting the lawn mower 1000f into grass collection work mode. The structure of the locking assembly 430f can have multiple options, such as a clamping block structure, a protrusion and slot structure, or a top rod pressure block structure, etc., as long as it can achieve locking of the baffle plate 410f in the first position and the second position. The locking assembly 430f can be set on the outer wall of the housing 310f, on the baffle plate 410f, or partly on the housing 310f and partly on the baffle plate 410f, as long as it meets the locking requirements of the baffle plate 410f.

By placing a baffle plate 410f and a handle 420f at the position of the first grass discharge port 3111f on the shell 310f, rotating the handle 420f on the outside of the shell 310f can achieve the transformation of the baffle plate 410f inside the shell 310f between the first position and the second position, thereby switching the baffle plate 410f between opening and closing the first grass discharge port 3111f, thus enabling the lawn mower 1000f to switch between different working modes. For example, when the first grass discharge port 3111f is in an open state, it can be connected to the grass collection bag 600f, allowing the lawn mower 1000f to operate in grass collection mode; when the first grass discharge port 3111f is in a closed state, it is disconnected from the grass collection bag 600f, enabling the lawn mower 1000f to operate in mulching mode or grass discharge mode. At the same time, by setting up a locking assembly 430f, the locking assembly 430f can lock the baffle plate 410f in the first position and the second position respectively. In this way, during the operation of the lawn mower 1000f, when bumps or vibrations occur, the baffle plate 410f is less likely to be displaced due to the external force of the locking assembly 430f, thereby improving the stability of the open or closed state of the first grass discharge port 3111f and ensuring the stability of the lawn mower 1000f's operating efficiency in different working modes.

Referring to FIG. 67 to FIG. 69, in an embodiment of the lawn mower 1000f, the switching mechanism 400f further includes a rotating shaft 440f. Both ends of the rotating shaft 440f pass through and are fixedly connected to the side walls of the housing 310f. The fixed connection can be achieved by locking the ends of the rotating shaft 440f with lock nuts, or by integrally forming the ends of the rotating shaft 440f with the side walls of the housing 310f. In this embodiment, one end of the rotating shaft 440f is provided with a stop portion, and the other end is installed with a lock nut. By tightening the lock nut, the stop portion of the rotating shaft 440f presses against the housing 310f, achieving a fixed connection between the rotating shaft 440f and the housing 310f. In this embodiment, the handle 420f is fixedly connected to the baffle plate 410f by bolts. Both the baffle plate 410f and the handle 420f have mounting holes with diameters larger than that of the rotating shaft 440f. The rotating shaft 440f passes through these mounting holes, thereby achieving a rotatable connection between the rotating shaft 440f and the baffle plate 410f, as well as between the rotating shaft 440f and the handle 420f. The rotating shaft 440f facilitates the rotatable connection of the baffle plate 410f and the handle 420f to the side walls of the housing 310f. If a malfunction occurs during the rotation of the baffle plate 410f and the handle 420f, only the lock nut at one end of the rotating shaft 440f needs to be loosened to replace the rotating shaft 440f, without removing the baffle plate 410f and the handle 420f from the housing 310f, making the operation simpler and more convenient.

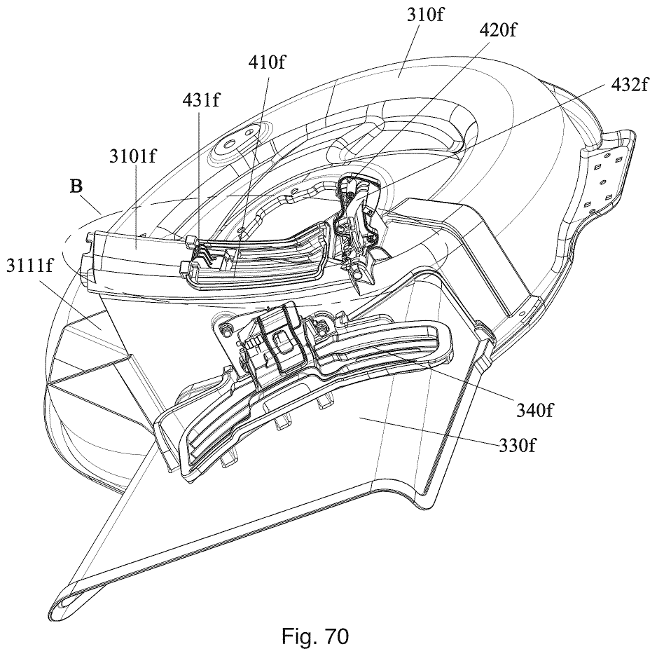

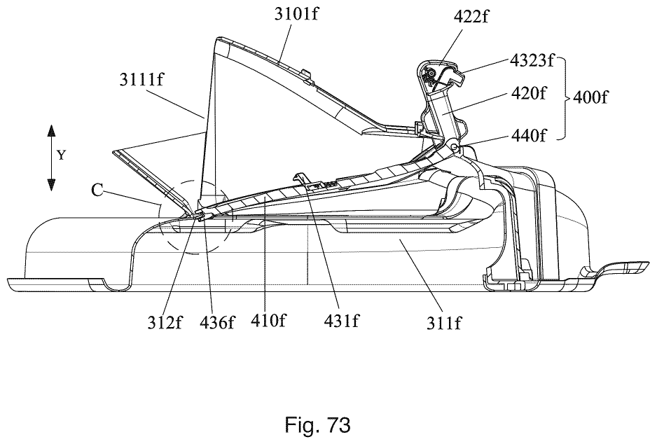

The rotation direction of the baffle plate 410f inside the housing 310f is not limited, as long as it can achieve the closing and opening of the first grass discharge port 3111f by the baffle plate 410f. However, preferably, referring to FIG. 70, FIG. 72, and FIG. 73, in an embodiment of the lawn mower 1000f, the baffle plate 410f rotates vertically up and down relative to the housing 310f, that is, the axis of the rotating shaft 440f is perpendicular to the vertical plane. The first position is when the end of the baffle plate 410f away from the rotating shaft 440f rotates to its limit away from the ground, and the second position is when it rotates to its limit towards the ground. With this setup, as the baffle plate 410f rotates from the first position to the second position, the torque produced by the gravity of the baffle plate 410f is in the same direction as the torque required for rotation. This makes the operation of the handle 420f less effortful. Additionally, when the baffle plate 410f is in the second position, the pressure generated by gravity consistently acts on the baffle plate 410f, thereby reducing the probability of the baffle plate 410f moving upward from the second position.

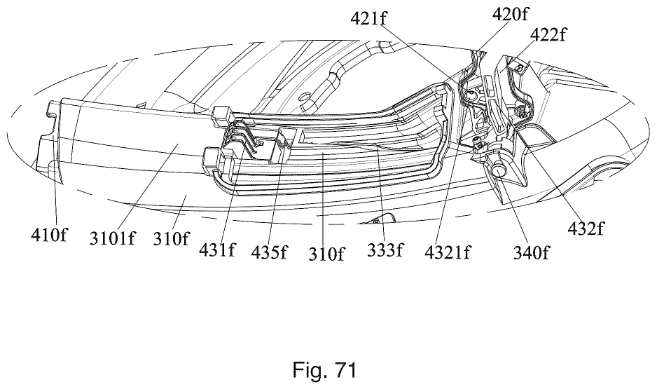

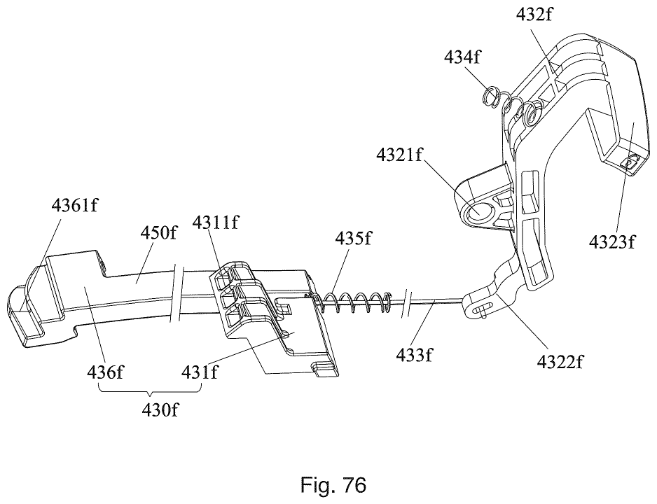

Please refer to FIG. 67, FIG. 68, FIG. 69, FIG. 71, FIG. 65 and FIG. 76. In an embodiment of the lawn mower 1000f, the locking assembly 430f includes a first locking member 431f. The first locking member 431f is set on the baffle plate 410f and can lock the baffle plate 410f in the first position on the outer wall of the housing 310f. The first locking member 431f can be installed at any position such as the front end or rear end of the baffle plate 410f, as long as it can lock the baffle plate 410f on the outer wall of the housing 310f when the baffle plate 410f is in the first position. Preferably, in this embodiment, the area of the housing 310f connected to the first grass discharge port 3111f includes a first side wall 3101f. When the baffle plate 410f is in the first position, the baffle plate 410f is located below the first side wall 3101f and abuts against the inner surface of the first side wall 3101f. The first locking member 431f can lock the baffle plate 410f on the first side wall 3101f. The locking method can be a groove-and-tenon structure, a pressure block pressing structure, or a pin locking structure, etc. Preferably, the first locking member 431f is set at approximately the middle position along the length direction of the baffle plate 410f (as shown by the X-axis in FIG. 69). This arrangement can improve the force condition at the locking position of the first locking member 431f, which is conducive to enhancing the locking effect of the first locking member 431f on the baffle plate 410f. It should be noted that in other embodiments, the first locking member 431f can also be set on the side wall of the housing 310f. Additionally, the first locking member 431f can be located inside or outside the housing 310f. However, preferably, in this embodiment, a first through hole 3102f is formed on the first side wall 3101f, and the first locking member 431f is installed at the first through hole 3102f. This allows for timely detection if the first locking member 431f malfunctions, reducing the impact on the lawn mower 1000f's operation. In other embodiments, the first locking member 431f can also be set on the side wall of the housing 310f, or partly set on the baffle plate 410f and partly on the side wall of the housing 310f, etc.

Please refer to FIG. 66, in an embodiment of the lawn mower 1000f, a support portion 312f is provided on the wall of the housing 310f opposite to the first side wall 3101f. The support portion 312f can be integrally formed with the housing 310f or fixed to the side wall of the housing 310f by bolts. In this implementation, the support portion 312f extends from the wall of the housing 310f towards the interior of the housing 310f, which can save the installation process of the support portion 312f on the housing 310f. Along the height direction of the cutting deck 300f (as shown by the Y-axis in FIG. 73), the first grass discharge port 3111f is located between the first side wall 3101f and the support portion 312f, and the baffle 410f is located between the first side wall 3101f and the support portion 312f. When the baffle 410f is in the second position (as shown in FIG. 73), the side of the baffle 410f facing the ground abuts against the support portion 312f. It should be noted that the supporting position of the support portion 312f relative to the baffle 410f is not limited, but preferably, referring to FIG. 73, in this embodiment, the support portion 312f supports the end of the baffle 410f in the length direction, and is located at the end away from the rotating shaft 440f. By setting the support portion 312f, on one hand, it can limit the rotation of the baffle 410f in the housing 310f, ensuring the accuracy of repeated positioning of the baffle 410f at the second position; on the other hand, it can also provide good support for the end of the baffle 410f, reducing the downward deformation in the length direction of the baffle 410f, thereby improving the rotation accuracy of the baffle 410f.

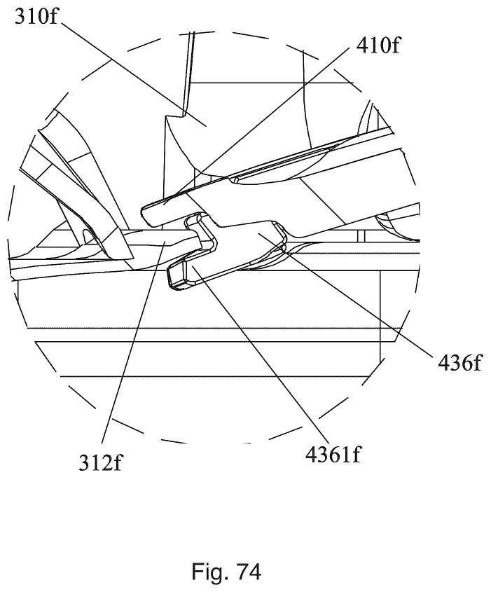

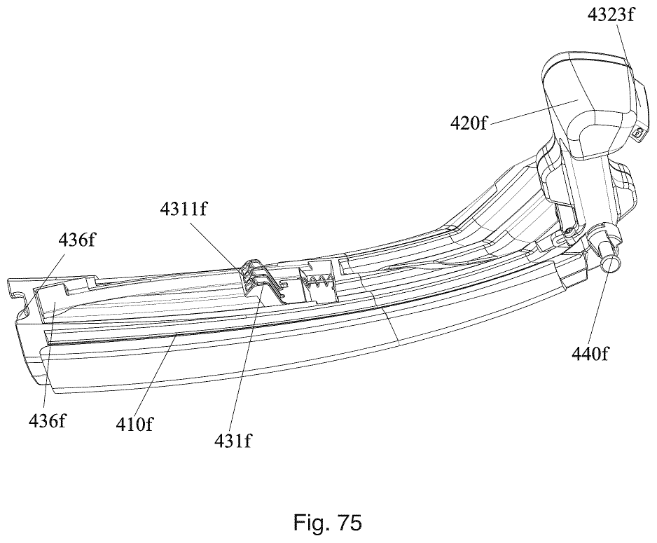

Please refer to FIG. 69, FIG. 72, FIG. 73, FIG. 74, FIG. 75, and FIG. 76. In an embodiment of the lawn mower 1000f, the locking assembly 430f also includes a second locking member 436f. The second locking member 436f is set on the baffle 410f. When the baffle 410f is in the second position (as shown in FIG. 73), the second locking member 436f can lock the baffle 410f in the second position to the housing 310f. The second locking member 436f can be installed at any position such as the front end or rear end of the baffle 410f, as long as it can lock the baffle 410f to the outer wall of the housing 310f when the baffle 410f is in the second position. The locking method can be a groove and protrusion structure, a pressure block pressing structure, a pin locking structure, etc. In other embodiments, the second locking member 436f can also be set on the side wall of the housing 310f, or part of the second locking member 436f can be set on the baffle 410f and part on the side wall of the housing 310f.

The second locking member 436f can be fixedly connected to the first locking member 431f, or they can be two independent parts, as long as the first locking member 431f can lock the baffle 410f in the first position, and the second locking member 436f can lock the baffle 410f in the second position. However, preferably, referring to FIG. 69 and FIG. 76, in an embodiment of the lawn mower 1000f, the first locking member 431f is fixedly connected to the second locking member 436f. The fixed connection can be an integrally formed connection or a bolt-fixed connection, etc. In this embodiment, the locking assembly 430f includes a connecting arm 450f, with one end of the connecting arm 450f connected to the first locking member 431f and the other end connected to the second locking member 436f. The connecting arm 450f, the first locking member 431f, and the second locking member 436f are integrally formed. The first locking member 431f is slidably connected to the baffle 410f along the length direction of the baffle 410f. When the first locking member 431f slides on the baffle 410f, it drives the connecting arm 450f to move, which in turn drives the second locking member 436f to slide along the baffle 410f in the same direction. The first locking member 431f has a first limit position and a second limit position relative to the baffle 410f. The first locking member 431f has a first engaging part 4311f, and the second locking member 436f has a second engaging part 4361f. When the first locking member 431f is at the first limit position, the first engaging part 4311f is in an extended state and engages with the first side wall 3101f, thereby preventing the baffle 410f from rotating downward and achieving the locking of the baffle 410f in the first position. When the baffle 410f needs to be moved from the first position to the second position, the first locking member 431f is first moved from the first limit position to the second limit position, causing the first engaging part 4311f to retract and disengage from the first side wall 3101f, releasing the lock between the baffle 410f and the first side wall 3101f. Then, the handle 420f is rotated to drive the baffle 410f to rotate within the housing 310f. When the baffle 410f reaches the second position, the first locking member 431f is moved from the second limit position back to the first limit position. At this time, the baffle 410f engages with the support part 312f, the second engaging part 4361f extends and abuts against the lower part of the support part 312f, thereby fixing the baffle 410f on the support part 312f and achieving the locking of the baffle 410f in the second position.

Refer to FIG. 68 and FIG. 69. In an embodiment of the lawn mower 1000f, the baffle 410f is also provided with a first guide groove 411f and a second guide groove 412f. The first locking member 431f is slidably arranged in the first guide groove 411f, and the second locking member 436f is slidably arranged in the second guide groove 412f. The two ends of the first guide groove 411f are provided with a first stop portion 4111f and a second stop portion 4112f, corresponding to the first limit position and the second limit position respectively. By providing the first guide groove 411f and the second guide groove 412f, the sliding precision of the first locking member 431f and the second locking member 436f on the baffle 410f can be improved, thereby enhancing the locking precision of the baffle 410f in the first position and the second position.

Furthermore, refer to FIG. 69. The two ends of the second guide groove 412f are provided with a third stop portion 4121f and a fourth stop portion 4122f. A first slot opening 4123f is formed between the third stop portion 4121f and the second guide groove 412f. The second locking member 436f is inserted through the first slot opening 4123f, enabling the second locking member 436f to be engaged with the baffle 410f. When the first locking member 431f is at the first limit position, one end of the second locking member 436f abuts against the third stop portion 4121f. When the first locking member 431f is at the second limit position, the other end of the second locking member 436f abuts against the fourth stop portion 4122f. By providing the third stop portion 4121f and the fourth stop portion 4122f, the positioning precision of the second locking member 436f at the first limit position and the second limit position can be achieved, thereby further improving the locking precision of the baffle 410f in the first position and the second position.

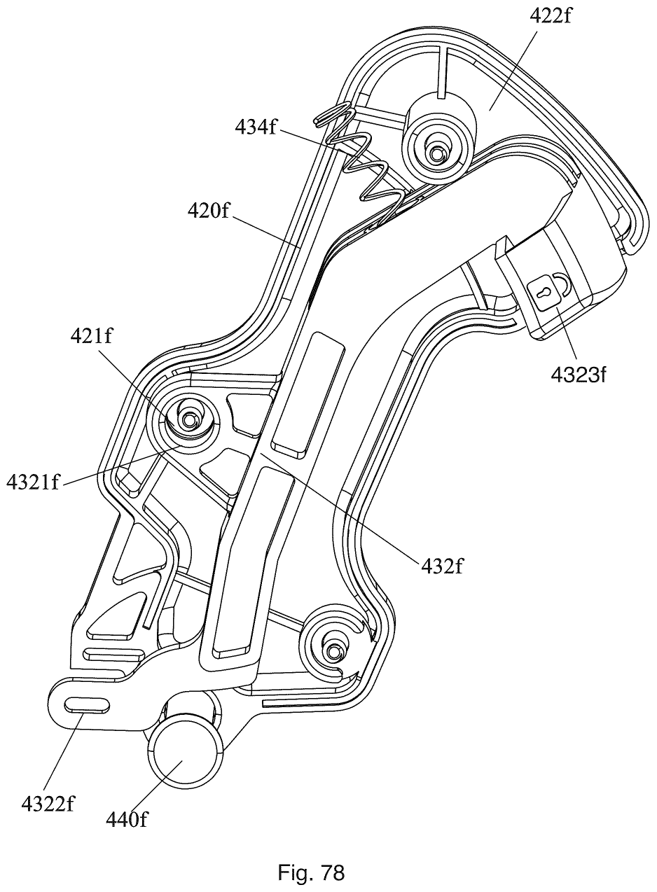

Refer to FIG. 69, FIG. 76, and FIG. 78. In an embodiment of the lawn mower 1000f, the locking component 430f further includes a rotary arm 432f and a first connecting member 433f, with the rotary arm 432f rotatably connected to the handle 420f. Specifically, the handle 420f has a protruding pin 421f on the side facing the rotary arm 432f, and the rotary arm 432f has a circular hole 4321f with a diameter larger than the outer diameter of the protruding pin 421f. The protruding pin 421f is inserted into the circular hole 4321f. By rotating the rotary arm 432f, the circular hole 4321f rotates relative to the protruding pin 421f, thereby achieving a rotatable connection between the rotary arm 432f and the handle 420f. The rotary arm 432f includes a connecting portion 4322f and a pressing portion 4323f, with the circular hole 4321f located between the connecting portion 4322f and the pressing portion 4323f. One end of the first connecting member 433f is connected to the connecting portion 4322f, while the other end is connected to the first locking member 431f. The connection method is not limited and can be a snap-fit connection, a bolt-fixed connection, or other methods. Preferably, in this embodiment, one end of the first connecting member 433f is rotatably connected to the connecting portion 4322f, while the other end is fixedly connected to the first locking member 431f, thus improving the force distribution on the first connecting member 433f. Since the rotary arm 432f is installed on the handle 420f, the operator can achieve rotation of the rotary arm 432f in both directions by toggling the pressing portion 4323f, thereby moving the first locking member 431f and the second locking member 436f between the first limit position and the second limit position. This structure is simple and easy to operate.

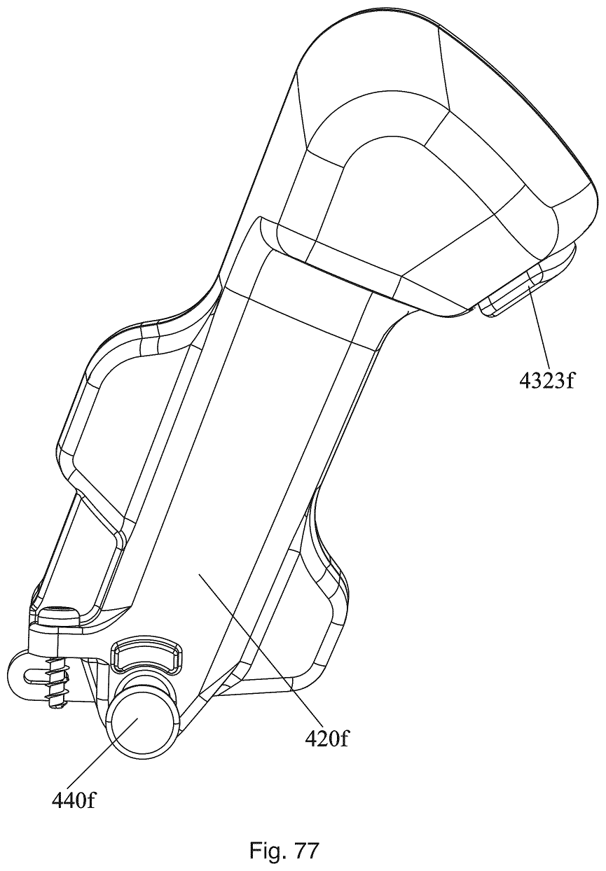

Please refer to FIG. 69, FIG. 70, FIG. 71, FIG. 76, FIG. 77 and FIG. 78. In an embodiment of the lawn mower 1000f, the locking component 430f further includes a first elastic reset member 434f. The first elastic reset member 434f is set between the handle 420f and the rotating arm 432f to produce an elastic force that resets the rotating arm 432f. The first elastic reset member 434f can be an elastic member such as a tension spring, compression spring, or torsion spring. In this embodiment, the first elastic reset member 434f is a compression spring. The two ends of the first elastic reset member 434f are connected to the handle 420f and the end of the rotating arm 432f near the pressing part 4323f, respectively. A receiving cavity 422f is provided on the handle 420f. The rotating arm 432f is set in the receiving cavity 422f, and the pressing part 4323f can extend out of or retract into the receiving cavity 422f. When the operator grips the handle 420f, they can simultaneously press the pressing part 4323f, causing the pressing part 4323f to retract into the receiving cavity 422f. At this time, the rotating arm 432f drives the first locking member 431f and the second locking member 436f to move from the first limit position to the second limit position through the first connecting member 433f. The first elastic reset member 434f is compressed, storing elastic potential energy. When the operator releases the pressing part 4323f, the pressing part 4323f rotates the rotating arm 432f in the opposite direction under the elastic potential energy of the first elastic reset member 434f, causing the pressing part 4323f to return to the extended state. Meanwhile, the rotating arm 432f drives the first locking member 431f and the second locking member 436f to return from the second limit position to the first limit position. By setting the first elastic reset member 434f, automatic reset of the rotating arm 432f can be achieved, facilitating operation.

Please refer to FIG. 68, FIG. 69, FIG. 71, FIG. 75 and FIG. 76. In an embodiment of the lawn mower 1000f, the first connecting member 433f has a metal wire structure. A second elastic reset member 435f is set between the first locking member 431f and the baffle plate 410f. When the first connecting member 433f is in a tightened state, the second elastic reset member 435f stores elastic potential energy. The second elastic reset member 435f can be a compression spring, tension spring, or torsion spring. In this embodiment, the second elastic reset member 435f is a compression spring. The second elastic reset member 435f is fitted over the outside of the metal wire, with one end of the second elastic reset member 435f abutting against the second stop part 4112f, and the other end abutting against the first locking member 431f. When the operator grips the handle 420f, they can simultaneously press the pressing part 4323f, causing the pressing part 4323f to retract into the receiving cavity 422f. At this time, the rotating arm 432f drives the first locking member 431f and the second locking member 436f to move from the first limit position to the second limit position through the first connecting member 433f. The first connecting member 433f is tightened, and the second elastic reset member 435f is compressed, storing elastic potential energy. When the operator releases the pressing part 4323f, the first locking member 431f returns to the first limit position under the action of the second elastic reset member 435f. The first locking member 431f simultaneously drives the first connecting member 433f to move in the opposite direction, which in turn causes the rotating arm 432f to rotate in the opposite direction, returning the pressing part 4323f to the extended state. The first connecting member 433f returns to a relaxed state. By setting the second elastic reset member 435f, better reset of the first locking member 431f and the second locking member 436f can be achieved. At the same time, setting the first connecting member 433f as a metal wire structure can save installation space for the first connecting member 433f on the baffle plate 410f and facilitate connection.

It should be noted that to better achieve automatic reset of the first locking member 431f and the second locking member 436f, in an embodiment, both the first elastic reset member 434f and the second elastic reset member 435f can be set simultaneously. In other embodiments, only one of the first elastic reset member 434f and the second elastic reset member 435f can be set, which can also achieve automatic reset of the first locking member 431f and the second locking member 436f. In this embodiment, referring to FIG. 69, FIG. 75, FIG. 76, FIG. 77 and FIG. 78, both the first elastic reset member 434f and the second elastic reset member 435f are set on the baffle 410f. When pressing the pressing part 4323f on the rotating arm 432f, the pressing part 4323f retracts into the receiving cavity 422f, at this time the first elastic reset member 434f is compressed, and simultaneously the rotating arm 432f rotates, driving the first connecting member 433f to move, the second elastic reset member 435f located between the first connecting member 433f and the first locking member 431f is compressed, storing elastic potential energy, the first connecting member 433f is tightened, driving the first locking member 431f and the second locking member 436f to move from the first limit position to the second limit position. When releasing the pressing part 4323f, at this time the first elastic reset member 434f releases elastic potential energy, driving the rotating arm 432f to rotate in the opposite direction, the pressing part 4323f extends out of the receiving cavity 422f, and simultaneously the rotating arm 432f drives the first connecting member 433f to move in the opposite direction, the second elastic reset member 435f releases elastic potential energy, pushing the first locking member 431f and the second locking member 436f to return from the second limit position to the first limit position, and the first connecting member 433f returns to a relaxed state.

Typically, the bottom of the grass cutting chamber 311f is an open structure, and during the grass cutting operation of the lawn mower 1000f, the grass clippings after cutting can be directly discharged to the working surface through the opening at the bottom of the grass cutting chamber 311f. However, preferably, referring to FIG. 64 and FIG. 65, in an example of the lawn mower 1000f of an embodiment, a second grass discharge port 3112f is also formed on the side wall of the housing 310f, and the second grass discharge port 3112f is connected to the grass cutting chamber 311f. The size and specific shape of the second grass discharge port 3112f are determined by the specific grass discharge requirements of the lawn mower 1000f, and are not specifically limited here; in this embodiment, the position where the second grass discharge port 3112f is formed on the housing 310f is close to the position of the first grass discharge port 3111f, and in other embodiments, it can also be formed in other positions. Preferably, referring to FIG. 63 to FIG. 66, in this embodiment, a cover 330f and a side baffle 340f are also provided at the position of the second grass discharge port 3112f. The cover 330f is fixedly connected to the housing 310f above the second grass discharge port 3112f by, but not limited to, bolts, and the cover 330f extends in a direction away from the outer side wall of the housing 310f, so as to form a certain degree of shielding above the second grass discharge port 3112f, thereby reducing the probability of grass clippings and dust flying during the process of grass clippings being discharged from the second grass discharge port 3112f, thus reducing the phenomenon of dust raising during the grass discharge process. The side baffle 340f is rotatably connected to the housing 310f above the second grass discharge port 3112f, and the side baffle 340f can open or close the second grass discharge port 3112f.

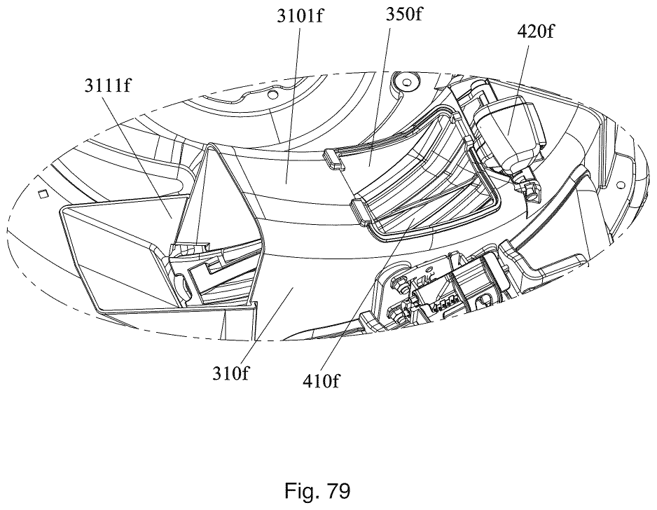

During the rotation process of the baffle 410f inside the housing 310f, grass clippings can easily remain in the gap between the baffle 410f and the first side wall 3101f, which may affect the rotation and positioning accuracy of the baffle 410f. For this reason, refer to FIG. 72 and FIG. 79, in an embodiment of the lawn mower 1000f, a first opening 350f is provided on the first side wall 3101f, and a portion of the surface of the first baffle 410f facing the first side wall 3101f is exposed at the first opening 350f. By providing the first opening 350f, it is convenient to clean the residual grass clippings between the baffle 410f and the first side wall 3101f at the first opening 350f, ensuring the rotation accuracy of the baffle 410f. Furthermore, a cover plate 360f is provided on the first side wall 3101f to cover the first opening 350f. The cover plate 360f has two states: closed and open. When cleaning grass clippings, the cover plate 360f needs to be opened, and after cleaning, the cover plate 360f needs to be closed. In an embodiment, when the lawn mower 1000f needs to perform grass collection operation, assuming the initial position of the baffle 410f is the second position. At this time, press the pressing part 4323f on the rotating arm 432f to make the pressing part 4323f retract into the receiving cavity 422f. The rotating arm 432f rotates, driving the first connecting member 433f to move. The first connecting member 433f drives the first locking member 431f and the second locking member 436f to move from the first limit position to the second limit position. Meanwhile, the second engagement part 4361f retracts and disengages from under the support part 312f, releasing the lock between the baffle 410f and the support part 312f. At this time, keep pressing the pressing part 4323f, then rotate the handle 420f. The handle 420f rotates, driving the baffle 410f to rotate towards the first side wall 3101f until the baffle 410f abuts against the inner surface of the first side wall 3101f. Then release the pressing part 4323f, and the pressing part 4323f returns to the state of protruding from the receiving cavity 422f under the action of the first elastic reset member 434f. At the same time, the rotating arm 432f rotates in the opposite direction, driving the first connecting member 433f to move in the opposite direction. Under the action of the second elastic reset member 435f, the first locking member 431f and the second locking member 436f return to the first limit position. At this time, the first engagement part 4311f extends out and engages with the first side wall 3101f, achieving the locking of the baffle 410f in the first position. Meanwhile, the first grass discharge port 3111f opens, and grass clippings are discharged from the first grass discharge port 3111f into the grass collection bag 600f, achieving grass collection operation. When the lawn mower 1000f does not need to perform grass collection operation, press the pressing part 4323f again to make the first engagement part 4311f retract and disengage from the first side wall 3101f. Rotate the handle 420f in the opposite direction to move the baffle 410f towards the support part 312f. When the baffle 410f abuts against the support part 312f, release the pressing part 4323f, and the second engagement part 4361f extends out again to abut against the support part 312f, achieving the locking of the baffle 410f in the second position. By repeating this operation, the movement and locking of the baffle 410f between the first position and the second position can be achieved, thus meeting the requirements for switching between different working modes of the lawn mower 1000f.

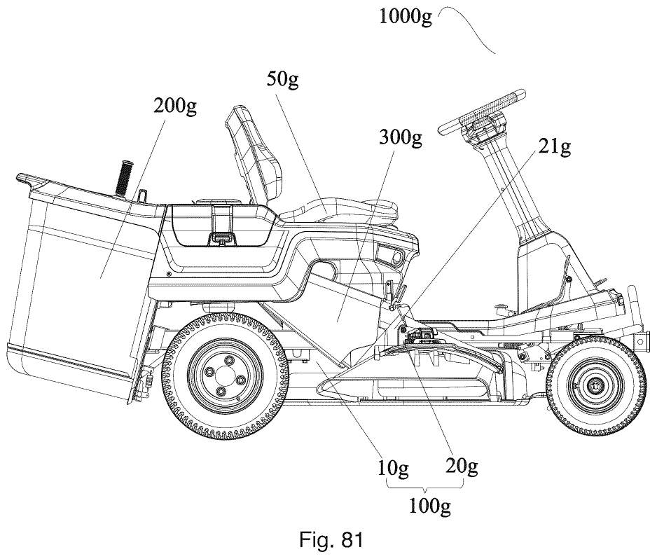

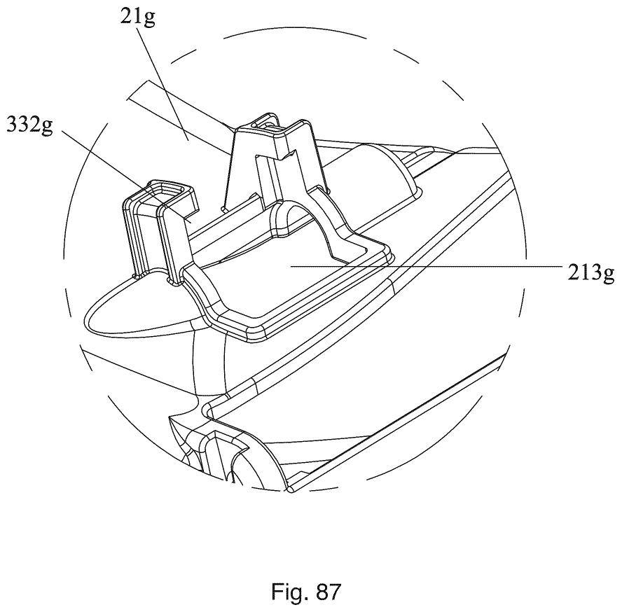

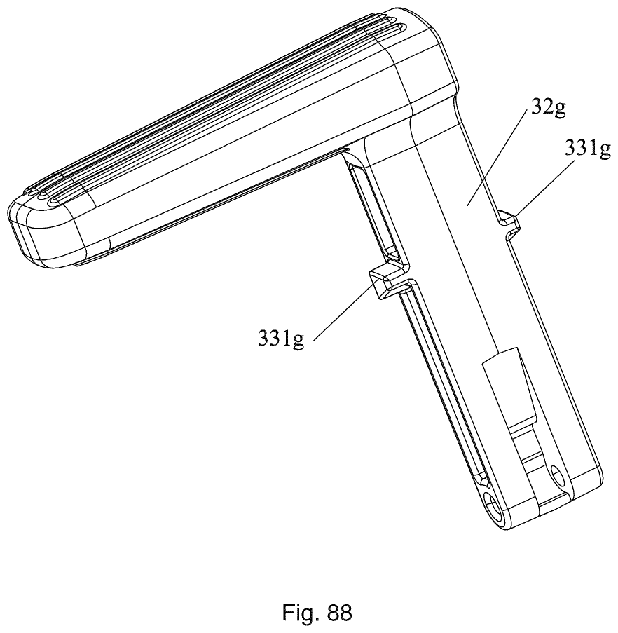

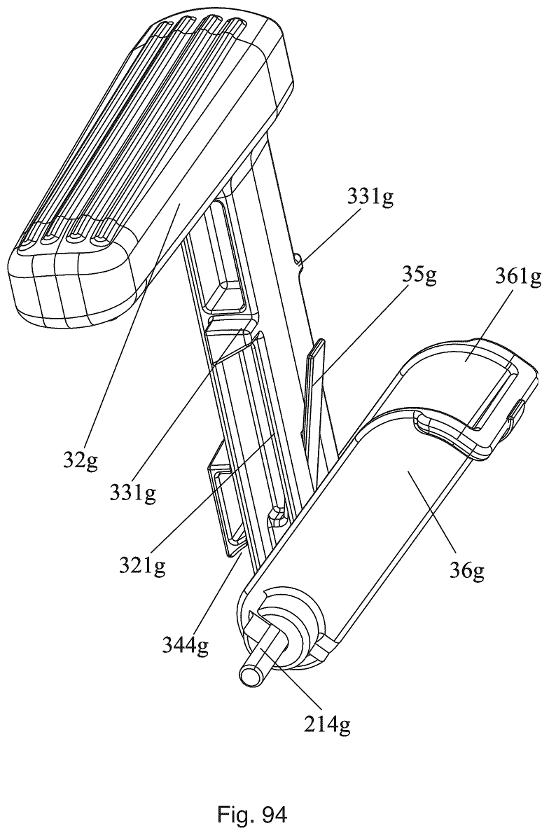

Please refer to FIG. 81 to FIG. 95. An embodiment provides a lawn mower 100g and a lawn mowing system 1000g. The lawn mower 100g has a baffle 31g and a handle 32g set at the grass collection opening 241g position. By operating the handle 32g, the baffle 31g can be opened or closed relative to the grass collection opening 241g, thereby achieving conversion between different working modes of the lawn mower 100g. This saves time occupied during switching between grass collection and non-grass collection modes, improving the operating efficiency of the lawn mower 100g. At the same time, due to the presence of a first engagement structure 33g and a second engagement structure 34g, the stability of the baffle 31g in closed and open states can be ensured.

Please refer to FIG. 81. An embodiment provides a lawn mowing system 1000g, which includes a lawn mower 100g and a grass collection bag 200g. The grass collection bag 200g is installed on the lawn mower 100g and connected to the lawn mower 100g. The connection method can be that the grass collection bag 200g itself has an interface connected to the lawn mower 100g, or the lawn mower 100g extends an interface connected to the grass collection bag 200g, or an additional grass transfer pipe 300g is set up, with one end of the grass transfer pipe 300g connected to the grass collection bag 200g and the other end connected to the lawn mower 100g, thereby transferring grass clippings cut by the lawn mower 100g through the grass transfer pipe 300g to the grass collection bag 200g for centralized processing. In this embodiment, the grass transfer pipe 300g is set between the grass collection bag 200g and the grass discharge duct 21g, with both ends of the grass transfer pipe 300g connected to the grass collection bag 200g and the grass discharge duct 21g respectively. This lawn mowing system 1000g integrates the lawn mower 100g and grass collection bag 200g in one installation, with a compact structure, and can promptly and automatically process grass clippings generated during mowing, reducing the workload of on-site workers. It should be noted that the specific installation structure of the grass collection bag 200g and grass transfer pipe 300g on the frame 10g in this application can refer to existing structures, which will not be elaborated here.

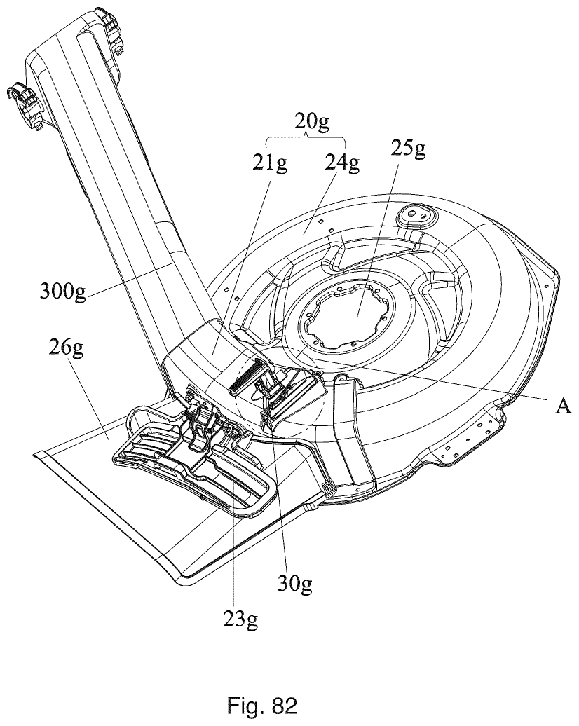

FIG. 81 to FIG. 82 further describe the lawn mower 100g of the above embodiment, which includes: a frame 10g, a cutting deck 20g, and a switching mechanism 30g. The frame 10g is equipped with a walking mechanism, and a seat 50g may or may not be installed on the frame 10g; in this embodiment, to improve the driving comfort of the operator, a seat 50g is installed on the frame 10g; the specific structure of the frame 10g is not limited. The walking mechanism is installed on the frame 10g to drive the frame 10g to move, and may include components such as a drive unit and a power supply unit. The power supply unit provides energy to the drive unit, which can be a battery, a diesel engine, a gasoline engine, or a hybrid engine. The drive unit provides power for the rotation of the walking wheels, which can be an electric motor, an electric motor+reducer, an electric motor+gear and rack transmission mechanism, or an electric motor+screw and nut transmission mechanism, or any transmission mechanism that can meet the requirements. The walking mechanism controls the corresponding walking actions of the frame 10g. The cutting deck 20g is installed on the frame 10g, and its installation position on the frame 10g is not limited. For example, it can be installed at the front, middle, or rear of the frame 10g, as long as it meets the installation requirements for grass cutting operations.

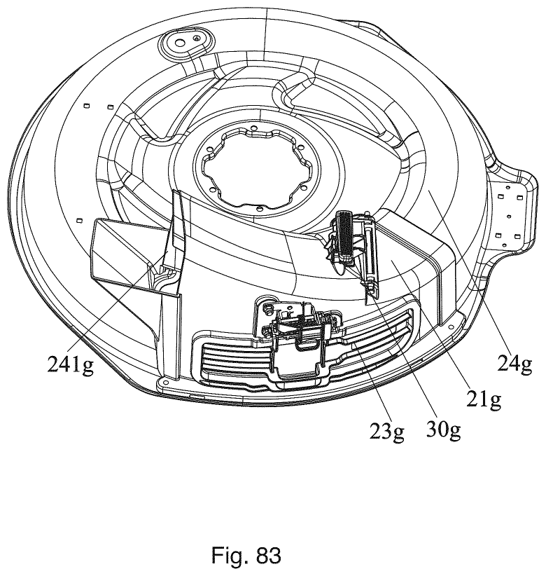

Referring to FIG. 82 and FIG. 83, the cutting deck 20g is further described. It includes a housing 24g and cutting blades, with a grass cutting chamber 25g formed inside the housing 24g. The housing 24g is connected to the bottom of the frame 10g and can be either fixedly or movably connected to the frame 10g in the height direction, depending on the operating conditions of the lawn mower 100g. A grass collection opening 241g is provided on the side wall of the housing 24g, connecting the inside and outside of the grass cutting chamber 25g. The grass collection opening 241g can be an integral opening structure on the side wall of the housing 24g or an additional connecting pipe set on the side wall of the housing 24g, with the grass collection opening 241g on the connecting pipe. Preferably, in this embodiment, a discharge chute 21g is connected to the outer wall of the housing 24g, connecting to the grass cutting chamber 25g, with the grass collection opening 241g set on the discharge chute 21g. The discharge chute 21g can be set on the side wall or top wall of the grass cutting chamber 25g; in this embodiment, the discharge chute 21g is installed on the top wall of the grass cutting chamber 25g. The specific cross-sectional shape and area of the discharge chute 21g are not limited, as long as it allows the discharge of cut grass clippings. The cutting blades are rotatably installed in the housing 24g and located within the grass cutting chamber 25g. The rotatable installation method is not limited and can be through electric motor rotation, electric motor+reducer rotation, or electric motor+gear transmission rotation. The cutting blades rotate to cut the grass in the grass cutting chamber 25g, achieving the grass cutting operation.

Referring to FIG. 82 to FIG. 86, the switching mechanism 30g includes a baffle plate 31g and a handle 32g. An upper wall of the grass discharge duct 21g is provided with a first mounting opening 211g, and a first rotating shaft 212g is fixedly connected at the first mounting opening 211g. One end of the baffle plate 31g in the length direction is rotatably connected to the first rotating shaft 212g, and the other end of the baffle plate 31g in the length direction extends into the grass discharge duct 21g. The baffle plate 31g rotates within the grass discharge duct 21g with the first rotating shaft 212g as the axis of rotation, opening or closing the grass discharge duct 21g. The handle 32g is rotatably mounted on the baffle plate 31g and is located on the side of the baffle plate 31g near the first rotating shaft 212g. In other embodiments, the first rotating shaft 212g can be rotatably connected at the first mounting opening 211g, with the baffle plate 31g fixedly connected to the first rotating shaft 212g. When the baffle plate 31g rotates relative to the grass discharge duct 21g, the first rotating shaft 212g rotates relative to the first mounting opening 211g.

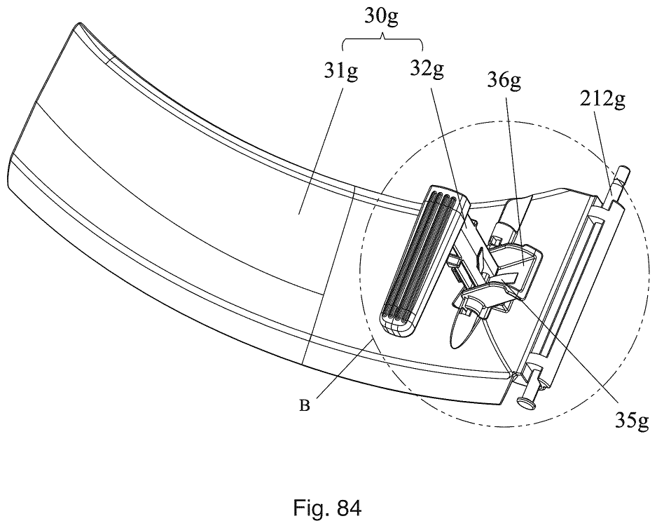

Specifically, referring to FIG. 84 to FIG. 90, a second mounting opening 213g is provided on the upper wall of the grass discharge duct 21g near the first mounting opening 211g. One end of the handle 32g in the length direction is rotatably connected to a second rotating shaft 214g, and the other end of the handle 32g in the length direction passes through the second mounting opening 213g and extends to the outside of the grass discharge duct 21g. The handle 32g rotates relative to the baffle plate 31g with the second rotating shaft 214g as the axis of rotation, while the handle 32g also moves up and down relative to the second mounting opening 213g, thereby driving the baffle plate 31g to rotate up and down within the grass discharge duct 21g with the first rotating shaft 212g as the axis of rotation. The handle 32g has at least a first position and a second position relative to the grass discharge duct 21g. When the handle 32g is in the first position, the baffle plate 31g closes the grass discharge duct 21g to the maximum extent, blocking the communication between the grass discharge outlet 241g and the outside of the grass cutting chamber 25g. Meanwhile, the handle 32g cooperates with the first engaging structure 33g to keep the baffle plate 31g in the closed position, achieving the locking of the baffle plate 31g relative to the grass discharge duct 21g in the closed position. When the handle 32g is in the second position, the baffle plate 31g opens the grass discharge duct 21g to the maximum extent, restoring the communication between the grass discharge outlet 241g and the grass cutting chamber 25g. Meanwhile, the handle 32g cooperates with the second engaging structure 34g to keep the baffle plate 31g in the open position, achieving the locking of the baffle plate 31g relative to the grass discharge duct 21g in the open position.

In an embodiment, the lawn mower 100g only requires operation of the handle 32g to drive the baffle 31g to move within the grass discharge duct 21g, thereby achieving connection or closure between the grass collection opening 241g and the exterior of the mowing chamber 25g, thus enabling switching between grass collection and non-grass collection working modes of the lawn mower 100g. This structure is easy to operate and simple in design. Since it doesn't require repeated assembly and disassembly of components like the baffle 31g during mode switching, it can save time when changing between grass collection and non-grass collection modes, further improving the work efficiency of the lawn mower 100g. Additionally, when the handle 32g reaches the first position, it engages with the first locking structure 33g to keep the baffle 31g in the closed position. When the handle 32g reaches the second position, it engages with the second locking structure 34g to keep the baffle 31g in the open position. This arrangement enables locking of the baffle 31g relative to the grass discharge duct 21g in both closed and open positions, ensuring stability of the baffle 31g closing or opening the grass discharge duct 21g during lawn mower 100g operation, thereby enhancing the stability of the lawn mower 100g's working efficiency in different modes.

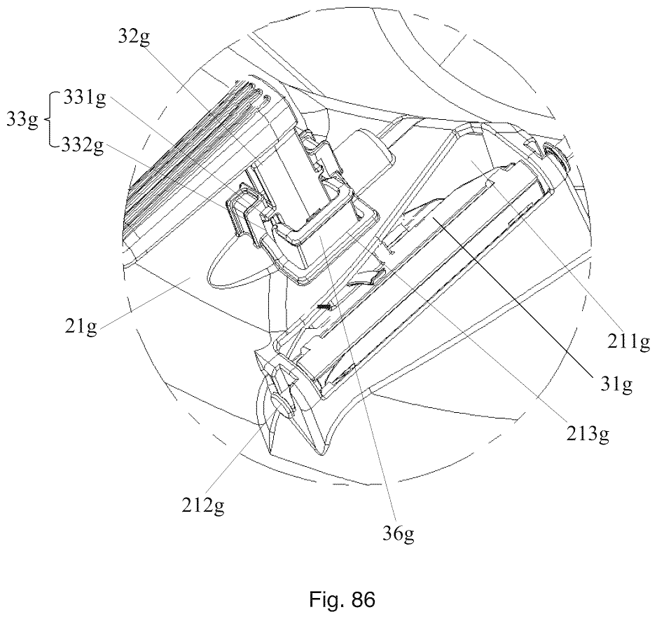

In an embodiment of the lawn mower 100g, the first locking structure 33g and/or the second locking structure 34g include a protrusion and a slot. The protrusion is set on either the handle 32g or the grass discharge duct 21g, while the slot is set on the other one, with the protrusion fitting into the slot. Specifically, in an embodiment, referring to FIG. 84 to FIG. 88, the first locking structure 33g comprises a first protrusion 331g and a first slot 332g. The first protrusion 331g is set on the handle 32g, and the first slot 332g is set on the upper wall of the grass discharge duct 21g. When the handle 32g is in the first position, the first protrusion 331g engages with the first slot 332g. The shapes of the first protrusion 331g and first slot 332g are not limited; for example, they can be rectangular protrusion and slot structures, or semi-circular protrusion and slot structures, etc. The specific number of first protrusions 331g and first slots 332g is also not limited. In this embodiment, referring to FIG. 86 to FIG. 88, there are two first protrusions 331g symmetrically set on both sides of the handle 32g's width, and correspondingly, there are two first slots 332g that engage with the two first protrusions 331g respectively. In other embodiments, the first protrusion 331g could be set on the grass discharge duct 21g, with the first slot 332g set on the handle 32g. The second locking structure 34g includes a second protrusion 341g and a second slot 342g. The second protrusion 341g is set on the upper wall of the grass discharge duct 21g, and the second slot 342g is set on the handle 32g. When the handle 32g is in the second position, the second protrusion 341g engages with the second slot 342g. Similarly, there are no specific restrictions on the shape and number of second protrusions 341g and second slots 342g. In this embodiment, there is one each of the second protrusion 341g and second slot 342g. In other embodiments, the second protrusion 341g could be set on the handle 32g, with the second slot 342g set on the grass discharge duct 21g.

It should be noted that in other embodiments, one of the first locking structure 33g and second locking structure 34g could be a protrusion and slot locking structure, while the other could be a locating pin and hole insertion structure, or other existing locking structures. As long as they meet the requirement of locking the handle 32g relative to the grass discharge duct 21g in the first and second positions, they are acceptable.

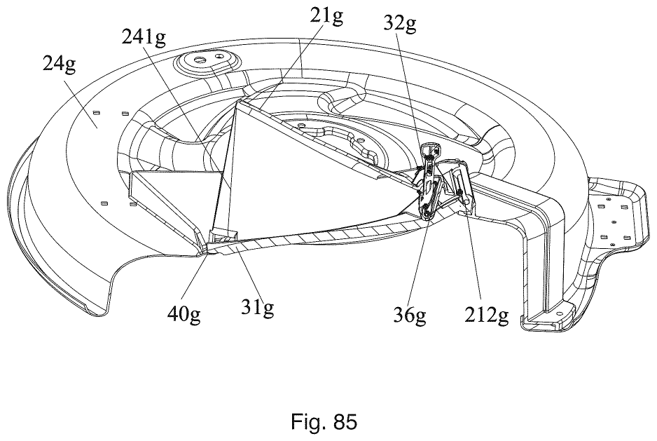

Please refer to FIG. 85 and FIG. 86. In an embodiment of the lawn mower 100g, a support portion 40g is provided at the connection position between the grass discharge duct 21g and the housing 24g. The support portion 40g extends towards the interior of the grass discharge duct 21g and is located at the end of the baffle plate 31g away from the first rotation axis 212g. When the baffle plate 31g is in the closed position, along the length direction of the baffle plate 31g, the end of the baffle plate 31g away from the first rotation axis 212g at least partially overlaps with the support portion 40g. The support portion 40g can be integrally formed with the housing 24g, or integrally formed with the wall of the grass discharge duct 21g, or be a separate part fixed to the housing 24g or the grass discharge duct 21g by fasteners such as bolts. In this embodiment, the support portion 40g is integrally formed with the housing 24g. By providing the support portion 40g, when the baffle plate 31g is in the closed position, it can provide stable support for the end of the baffle plate 31g, which can both improve the force condition of the first engagement structure 33g and enhance the stability of the baffle plate 31g in the closed position.

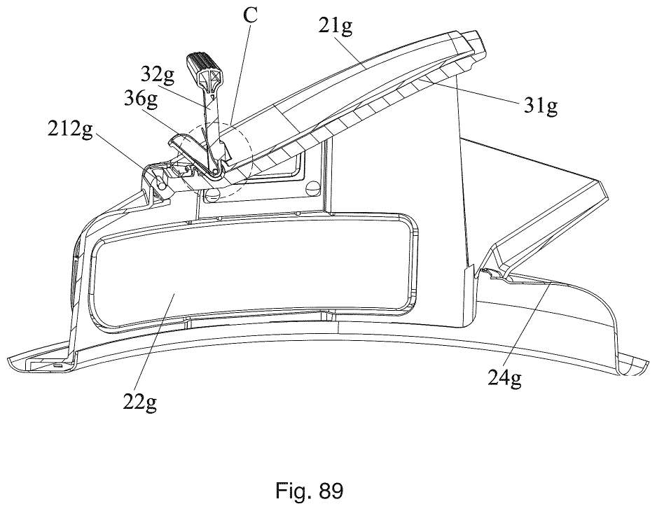

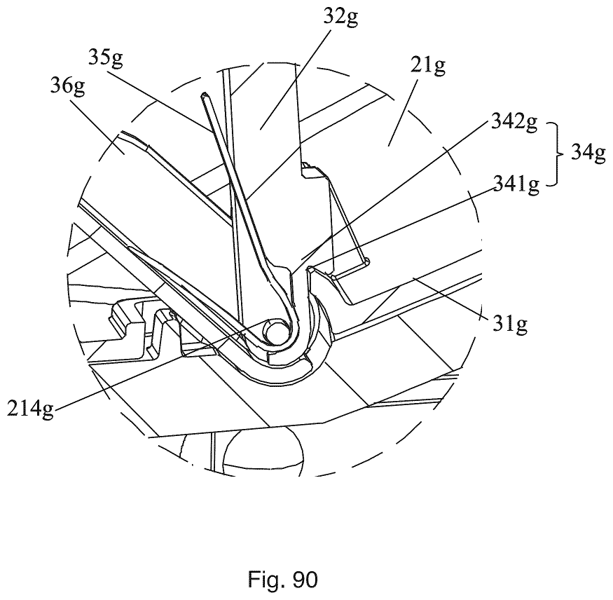

Please refer to FIG. 89 and FIG. 90. In an embodiment of the lawn mower 100g, the second engagement structure 34g includes a second slot 342g provided on the handle 32g and a second protrusion 341g provided on the grass discharge duct 21g. The second slot 342g is a wedge-shaped slot, and the second protrusion 341g is a wedge-shaped block. When the handle 32g is in the first position, the wedge-shaped slot engages with the matching wedge-shaped block. The wedge-shaped slot is located on the side of the handle 32g away from the first rotation axis 212g, with its opening facing the side of the handle 32g close to the second rotation axis 214g. The wedge-shaped block is located on the upper wall of the grass discharge duct 21g, with its top end extending towards the outside of the grass discharge duct 21g. The wedge angle of the wedge-shaped block matches the wedge angle of the wedge-shaped slot.

When the grass discharge pipe 21g needs to be connected to the grass cutting chamber 25g, first rotate the handle 32g, causing the first protrusion 331g on the handle 32g to disengage from the first slot 332g. Then pull the handle 32g upward, which drives the baffle 31g to rotate towards the upper wall of the grass discharge pipe 21g until the baffle 31g is close to its limit position relative to the upper wall of the grass discharge pipe 21g. At this point, as the handle 32g is pulled upward, the wedge-shaped slot located on the handle 32g moves from inside the grass discharge pipe 21g to its outside, positioning above and to the side of the wedge-shaped block. Subsequently, rotate the handle 32g towards the wedge-shaped block, aligning the wedge-shaped slot on the handle 32g directly above the wedge-shaped block. Finally, release the handle 32g. Under the gravity of the baffle 31g, the handle 32g moves downward, causing the wedge-shaped slot to engage with the wedge-shaped block, thus achieving a locked connection between the handle 32g and the grass discharge pipe 21g, securing the baffle 31g in the open position. By using the engagement structure of the wedge-shaped slot and wedge-shaped block, during the locking process, due to the gravity of the baffle 31g, the wedge-shaped slot consistently exerts a downward pressing force on the wedge-shaped block. This enhances the stability of the engagement between the handle 32g and the grass discharge pipe 21g, thereby improving the stability of the baffle 31g in the open position.

Of course, in other embodiments, the wedge-shaped block could be set on the handle 32g, and the wedge-shaped slot on the grass discharge pipe 21g. The matching engagement of the wedge-shaped block and wedge-shaped slot would achieve the same beneficial effects as the aforementioned embodiment.

Please refer to FIG. 89 to FIG. 92. In an embodiment of the lawn mower 100g, an elastic member 35g is set on the baffle 31g to prevent the rotation of the handle 32g at the first position or the second position. The elastic member 35g can be a tension spring, compression spring, leaf spring, or any other component that can prevent the handle 32g from rotating relative to the baffle 31g at the first or second position. In this embodiment, the elastic member 35g is a spring sheet structure. The elastic member 35g bends around the second rotation axis 214g, forming two bent edges. These two bent edges abut against the side of the baffle 31g near the first rotation axis 212g and the side of the handle 32g facing the first rotation axis 212g respectively. When the handle 32g is at the first position, the elastic member 35g exerts a pushing force on the handle 32g away from the first rotation axis 212g, causing the first protrusion 331g on the handle 32g to press tightly into the first slot 332g. When the handle 32g moves from the first position to the second position, rotate the handle 32g towards the elastic member 35g, causing the first protrusion 331g to disengage from the first slot 332g. Pull the handle 32g upwards while continuing to rotate it towards the elastic member 35g. The elastic member 35g is compressed. When the handle 32g reaches the second position, it again exerts a pushing force on the handle 32g away from the first rotation axis 212g, causing the second protrusion 341g on the handle 32g to press tightly into the second slot 342g. By setting up the elastic member 35g, not only can it prevent the rotation of the handle 32g at the first and second positions, improving the stability of the baffle 31g in both closed and open positions, but it also allows for free switching of the handle 32g between the first and second positions. This design is simple in structure and low in procurement cost.

It should be noted that in other embodiments, one end of the elastic member 35g may abut against and connect with the grass discharge pipe 21g, while the other end abuts against and connects with the handle 32g. This can similarly achieve the effect of blocking the handle 32g from rotating relative to the baffle 31g at the first position or the second position.

Referring to FIG. 89 to FIG. 92, in an embodiment of the lawn mower 100g, the switching mechanism 30g also includes a support seat 36g rotatably connected to the handle 32g. The elastic member 35g is pressed between the support seat 36g and the handle 32g. The support seat 36g is pressed against the baffle 31g under the elastic force of the elastic member 35g. One end of the support seat 36g in the longitudinal direction is rotatably connected to the second rotating shaft 214g, while the other end extends through the second mounting hole 213g to the outside of the grass discharge pipe 21g. The support seat 36g is located on the side of the handle 32g facing the first rotating shaft 212g. The side of the support seat 36g facing the handle 32g has a first supporting surface 362g, and the side of the handle 32g opposite to the support seat 36g has a second supporting surface 322g. In this embodiment, the elastic member 35g is fitted over the second rotating shaft 214g and rotatably connected to it. One end of the elastic member 35g abuts against and connects with the first supporting surface 362g, while the other end abuts against and connects with the second supporting surface 322g. By setting up the support seat 36g, the installation structure of the elastic member 35g can be simplified while providing stable support for it.

Referring to FIG. 89, in an embodiment of the lawn mower 100g, a movement guiding structure 37g is provided between the support seat 36g and the handle 32g to guide the movement between them. The type of movement guiding structure 37g can vary. For example, it can be a slide rail set on the support seat 36g with a corresponding slider on the handle 32g. When the handle 32g and support seat 36g move relative to each other, the slider slides along the rail, thus providing guidance. Alternatively, a guide groove 361g can be machined on the support seat 36g, with a guide block installed at the corresponding position on the handle 32g. When the handle 32g and support seat 36g move relative to each other, the guide block slides along the guide groove 361g, thus providing guidance. By setting up the movement guiding structure 37g, the probability of lateral deviation during the relative movement of the handle 32g and support seat 36g can be reduced, thereby improving the service life of the elastic member 35g set between them.

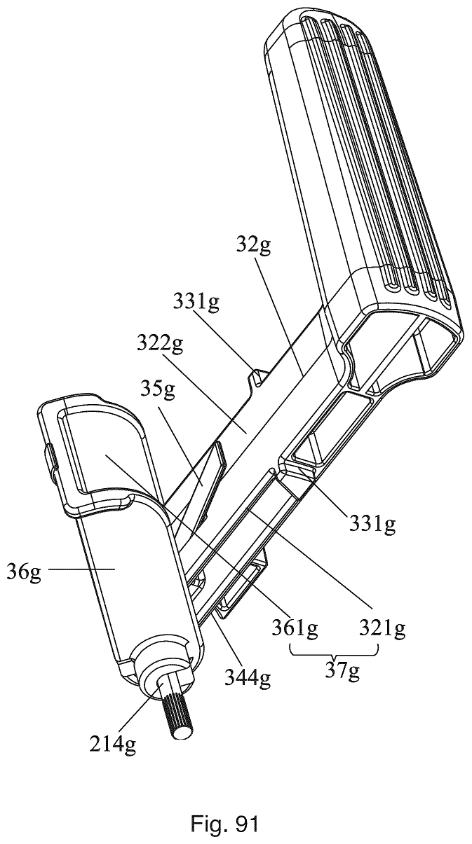

Please refer to FIG. 91, in an embodiment of the lawn mower 100g, the mobile guiding structure 37g includes a guiding groove 361g set on the support seat 36g and a guiding part 321g set on the handle 32g, with the guiding part 321g sliding along the guiding groove 361g. Specifically, the side of the support seat 36g facing the handle 32g forms an approximately U-shaped guiding groove 361g, with the groove opening facing the guiding part 321g of the handle 32g; the width of the guiding part 321g matches the width of the guiding groove 361g, and when the handle 32g rotates relative to the support seat 36g, the guiding part 321g slides along the guiding groove 361g. In other embodiments, the guiding groove 361g can also be set on the handle 32g, with the guiding part 321g set on the support seat 36g, sliding along the guiding groove 361g, which can similarly serve a guiding function.

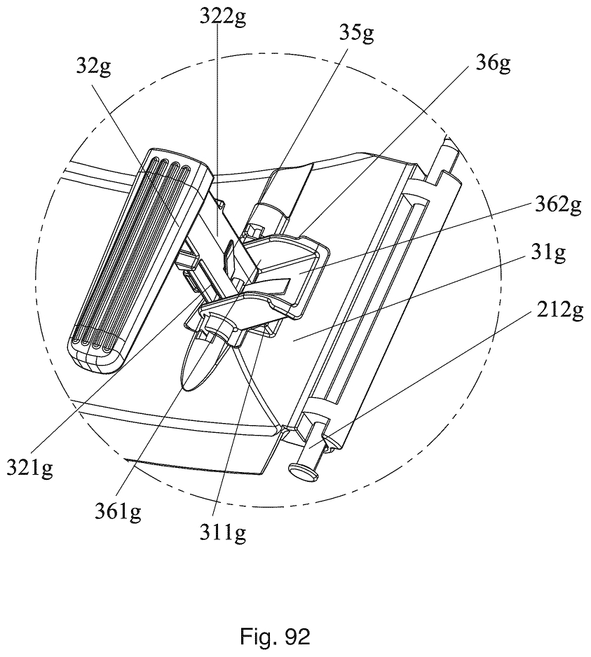

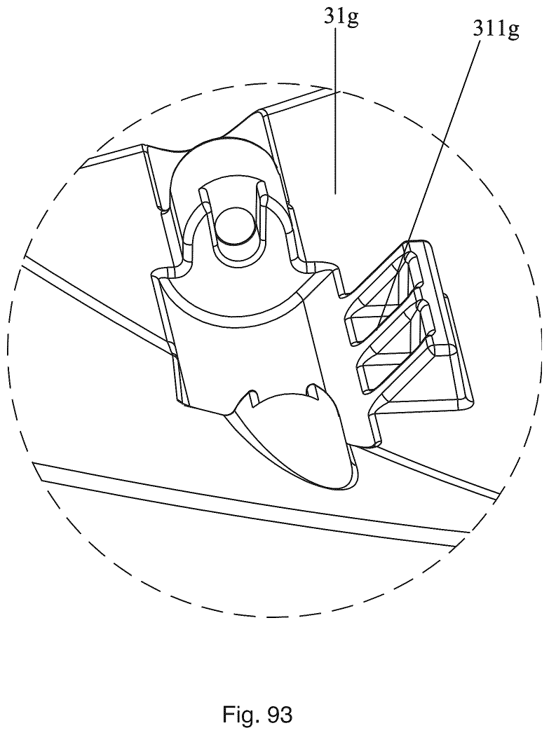

Please refer to FIG. 92 and FIG. 93, in an embodiment of the lawn mower 100g, the baffle plate 31g is provided with a supporting inclined surface 311g, and under the elastic force of the elastic member 35g, the support seat 36g abuts against the supporting inclined surface 311g. The supporting inclined surface 311g is located on the side of the support seat 36g facing the first rotation axis 212g, and the supporting inclined surface 311g is close to the rotation axis of the support seat 36g. By setting the supporting inclined surface 311g, it can, on one hand, limit the rotation of the support seat 36g, and on the other hand, increase the abutting area between the support seat 36g and the baffle plate 31g, thereby enhancing the support strength for the support seat 36g.

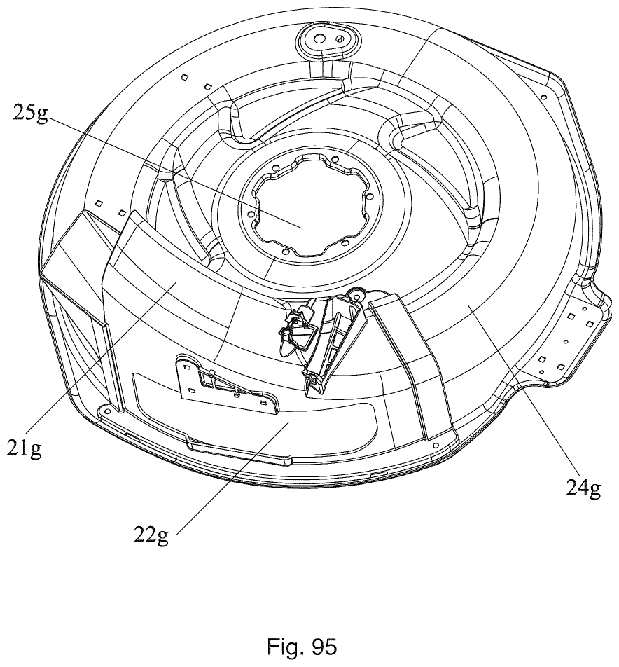

Typically, the grass-cutting chamber 25g has an open structure at the bottom, and during the grass-cutting operation of the lawn mower 100g, the grass clippings after cutting can be directly discharged to the working ground through the opening at the bottom of the grass-cutting chamber 25g. However, preferably, please refer to FIG. 95, in an embodiment of the lawn mower 100g, a side discharge opening 22g is also provided on the side wall of the housing 24g, with the side discharge opening 22g connected to the grass-cutting chamber 25g. The size and specific shape of the side discharge opening 22g are determined by the specific grass discharge requirements of the lawn mower 100g, which are not specifically limited here; in this embodiment, the position of the side discharge opening 22g on the housing 24g is close to the position of the grass discharge duct 21g, while in other embodiments, it can also be set in other positions. Preferably, please refer to FIG. 83, FIG. 89, and FIG. 95, in this embodiment, a cover 26g and a side baffle 23g are also set at the position of the side discharge opening 22g. The cover 26g is fixedly connected to the housing 24g above the side discharge opening 22g by means of, but not limited to, bolts, and the cover 26g extends in a direction away from the outer side wall of the housing 24g, to form a certain degree of shielding above the side discharge opening 22g, thereby reducing the probability of grass clippings and dust splashing during the discharge of grass clippings from the side discharge opening 22g, thus reducing dust generation during the grass discharge process. The side baffle 23g is rotatably connected to the housing 24g above the side discharge opening 22g, and the side baffle 23g can open or close the side discharge opening 22g.

In an embodiment of the lawn mower 100g, when the lawn mower 100g needs to perform non-grass collection operations, such as mulching or side discharge, the baffle 31g is in the closed position, with the first protrusion 331g engaged in the first slot 332g. When the lawn mower 100g needs to perform grass collection operations, the baffle 31g needs to be opened to connect the grass discharge chute 21g with the mowing chamber 25g. At this time, first rotate the handle 32g to disengage the first protrusion 331g from the first slot 332g, then pull the handle 32g upward, driving the baffle 31g to rotate from the closed position toward the open position. When the baffle 31g reaches the open position, rotate the handle 32g in the opposite direction to bring the second slot 342g close to the second protrusion 341g, then release the handle 32g. Under the gravity of the baffle 31g, the second slot 342g engages with the second protrusion 341g, securing the handle 32g in the second position and fixing the baffle 31g in the open position, thus enabling the rear grass collection mode of the lawn mower 100g. This lawn mower 100g only requires operation of the handle 32g to drive the movement of the baffle 31g within the grass discharge chute 21g, thereby achieving the opening or closing of the grass discharge chute 21g and enabling the conversion between grass collection and non-grass collection working modes of the lawn mower 100g. This operation is convenient with a simple structure, easy to operate, and during the conversion process, since there is no need to repeatedly disassemble and assemble components such as the baffle 31g, it saves time in switching between grass collection and non-grass collection working modes, further improving the working efficiency of the lawn mower 100g.

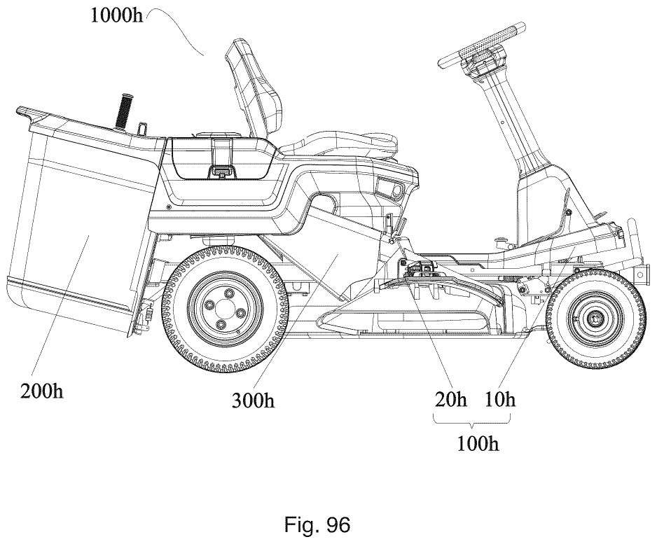

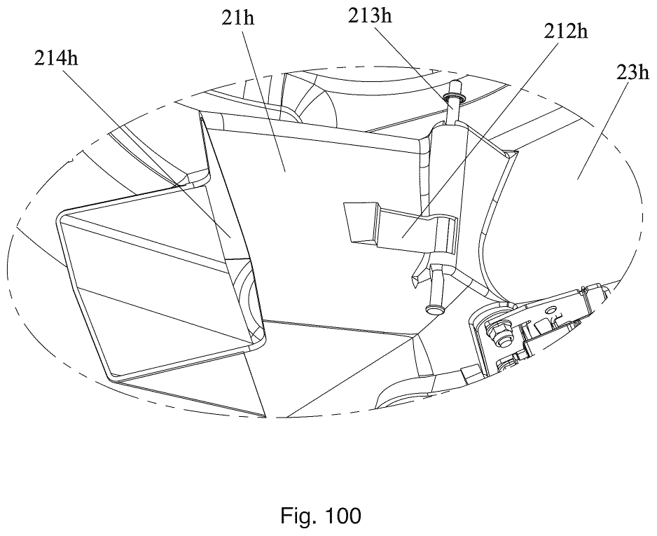

Please refer to FIG. 96 to FIG. 108. An embodiment provides a lawn mower 100h and a lawn mowing system 1000h. The lawn mower 100h includes a baffle 30h and a handle 40h set at the grass collection opening 214h. By operating the handle 40h, the baffle 30h can be opened or closed relative to the grass collection opening 214h, thereby achieving switching between different working modes of the lawn mower 100h. This saves time occupied during switching between grass collection and non-collection modes, improving the operating efficiency of the lawn mower 100h. Additionally, the presence of a first locking body 50h and a second locking body 60h ensures the stability of the baffle 30h in both closed and open states.

Please refer to FIG. 96. An embodiment provides a lawn mowing system 1000h, which includes a lawn mower 100h and a grass collection bag 200h. The grass collection bag 200h is installed on the lawn mower 100h and connected to it. The connection method can be the grass collection bag 200h having its own interface connected to the lawn mower 100h, or the lawn mower 100h extending an interface connected to the grass collection bag 200h, or additionally setting up a grass conveying pipe 300h with one end connected to the grass collection bag 200h and the other end connected to the lawn mower 100h, thereby conveying the grass clippings cut by the lawn mower 100h through the grass conveying pipe 300h to the grass collection bag 200h for centralized processing. In this embodiment, a grass conveying pipe 300h is set between the grass collection bag 200h and the grass collection opening 214h, with both ends of the grass conveying pipe 300h connected to the grass collection bag 200h and the grass collection opening 214h respectively. This lawn mowing system 1000h integrates the lawn mower 100h and grass collection bag 200h in one installation, resulting in a compact structure that can promptly and automatically process grass clippings generated during mowing, reducing the workload of on-site workers. It should be noted that the specific installation structure of the grass collection bag 200h and grass conveying pipe 300h on the frame 10h in this application can refer to existing structures, which will not be elaborated here.

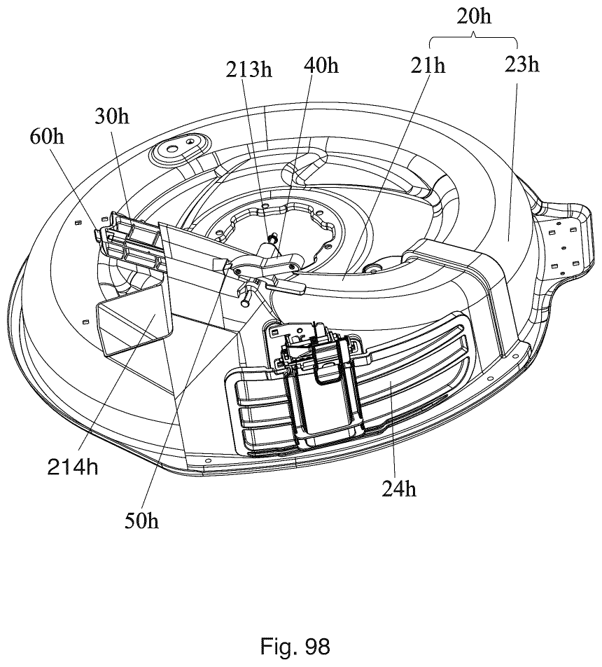

FIG. 96 and FIG. 98 further describe the lawn mower 100h of the above embodiment, which includes: a frame 10h, a mower deck 20h, a baffle 30h, a handle 40h, a first locking member 50h and a second locking member 60h. A walking mechanism is installed on the frame 10h, and a seat may or may not be installed on the frame 10h; in an embodiment, to improve the driving comfort of the operator, a seat is installed on the frame 10h; the specific structural form of the frame 10h is not limited. The walking mechanism is installed on the frame 10h to drive the frame 10h to walk, and may include components such as a drive unit and a power supply unit. The power supply unit provides energy for the drive unit, which can be a battery, a diesel engine, a gasoline engine, or a hybrid engine. The drive unit provides power for the rotation of the walking wheels, which can be an electric motor, an electric motor+reducer, an electric motor+gear rack transmission mechanism, or an electric motor+screw and nut transmission mechanism, or any transmission mechanism that can meet the requirements. The walking mechanism drives the frame 10h to perform corresponding walking actions. The mower deck 20h is installed on the frame 10h, and the installation position of the mower deck 20h on the frame 10h is not limited. For example, it can be installed at the front end of the frame 10h, in the middle of the frame 10h, or at the rear end of the frame 10h, as long as it meets the installation requirements for mowing operations.

Referring to FIG. 95 to FIG. 98, further describing the mower deck 20h, it includes a housing 23h and a cutter blade. A mowing chamber 22h is formed inside the housing 23h. The housing 23h is connected to the bottom of the frame 10h, and can be fixedly connected to the frame 10h in the height direction or movably connected to the frame 10h in the height direction. The specific connection method needs to be determined according to the operating conditions of the lawn mower 100h. A grass collection opening 214h communicating with the inside and outside of the mowing chamber 22h is provided on the side wall of the housing 23h. The grass collection opening 214h can be an opening structure integrally formed on the side wall of the housing 23h, or an additional connecting pipe can be provided on the side wall of the housing 23h, with the grass collection opening 214h opened on the connecting pipe. Preferably, in an embodiment, a discharge chute 21h is connected to the outer wall of the housing 23h, the discharge chute 21h is connected to the mowing chamber 22h, and the grass collection opening 214h is opened on the discharge chute 21h. The discharge chute 21h can be installed on the side wall or top wall of the mowing chamber 22h, which is not limited; in an embodiment, the discharge chute 21h is installed on the top wall of the mowing chamber 22h. The specific cross-sectional shape and area of the discharge chute 21h are not limited, as long as it allows the cut grass clippings to be smoothly discharged. The cutter blade is rotatably installed on the housing 23h and located inside the mowing chamber 22h. The rotatable installation method is not limited and can be rotatably installed through an electric motor, an electric motor+reducer, or an electric motor+gear transmission. When the cutter blade rotates, it cuts the grass in the mowing chamber 22h to achieve mowing operations.

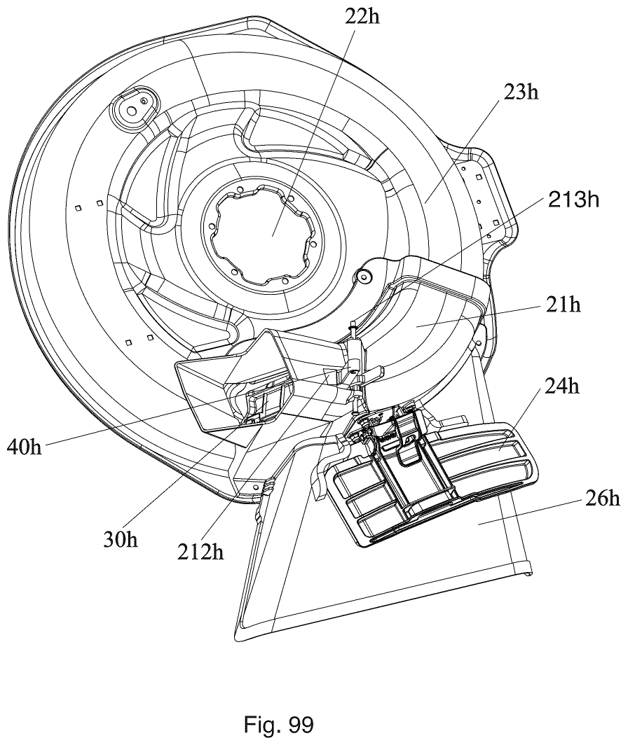

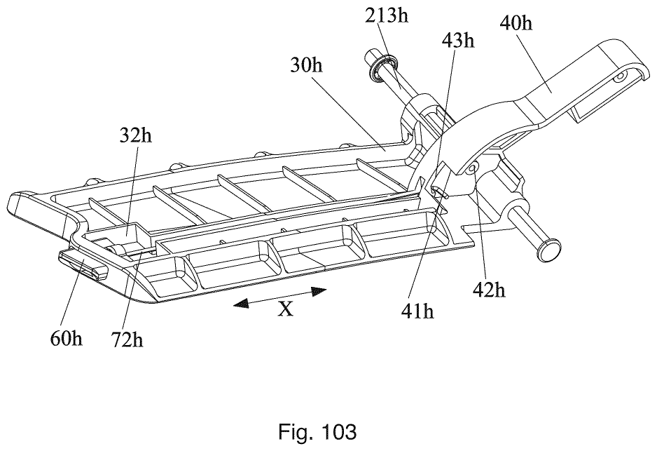

Referring to FIG. 99 to FIG. 103, an upper wall of the grass discharge chute 21h has a mounting through hole 212h. A first rotation shaft 213h is fixedly connected at the mounting through hole 212h. One end of the baffle plate 30h is rotatably connected to the first rotation shaft 213h, and the other end of the baffle plate 30h extends into the grass discharge chute 21h. The baffle plate 30h rotates inside the grass discharge chute 21h with the first rotation shaft 213h as the rotation axis, and opens or closes the grass discharge chute 21h. The specific shape of the baffle plate 30h is not limited, for example, it can be approximately cuboid, approximately elliptical, or approximately fan-shaped, or any shape that can achieve closing or opening of the grass collection opening 214h. Preferably, in an embodiment, the baffle plate 30h is an approximately cuboid structure. Along the length direction of the baffle plate 30h (as shown in the X-axis direction in FIG. 103), one end of the baffle plate 30h is rotatably connected to the first rotation shaft 213h, and the other end of the baffle plate 30h extends into the interior of the grass discharge chute 21h. The handle 40h is fixedly connected to the baffle plate 30h and is located at the end of the baffle plate 30h near the first rotation shaft 213h. The fixed connection method can be that the handle 40h is fixedly connected to the baffle plate 30h through fasteners such as bolts, or the handle 40h and the baffle plate 30h can be integrally formed. In an embodiment, the handle 40h and the baffle plate 30h are separately set, and the handle 40h is fixedly connected to the baffle plate 30h through fasteners such as bolts. It should be noted that in other embodiments, the first rotation shaft 213h can be rotatably connected at the mounting through hole 212h, and the baffle plate 30h is fixedly connected to the first rotation shaft 213h. When the baffle plate 30h rotates relative to the grass discharge chute 21h, the first rotation shaft 213h rotates relative to the mounting through hole 212h.

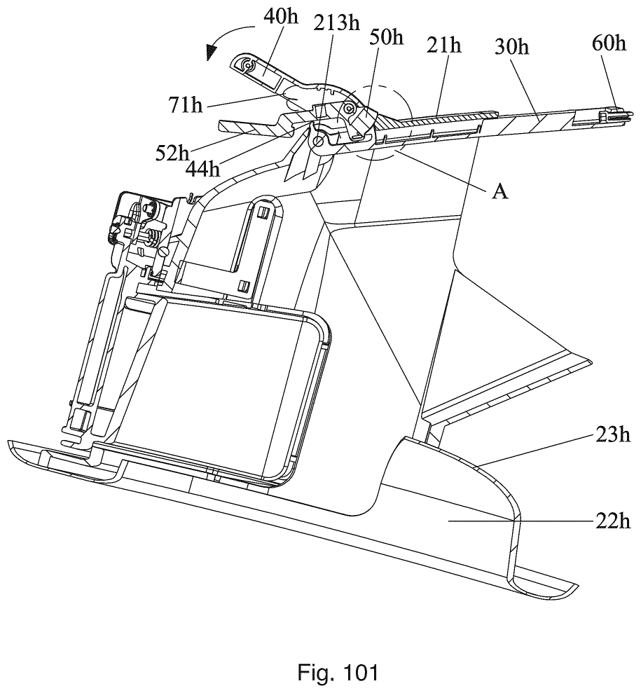

Specifically, one end of the handle 40h along the length direction is fixedly connected to the baffle plate 30h, and the other end of the handle 40h along the length direction passes through the mounting through hole 212h and extends to the outside of the grass discharge chute 21h. When rotating the handle 40h, the handle 40h drives the baffle plate 30h to rotate up and down inside the grass discharge chute 21h with the first rotation shaft 213h as the rotation axis. When rotating the handle 40h in the arrow direction shown in FIG. 101, the baffle plate 30h rotates towards the side close to the upper wall of the grass discharge chute 21h until the grass discharge chute 21h is opened to the maximum extent. When rotating the handle 40h in the direction opposite to the arrow direction shown in FIG. 101, the baffle plate 30h rotates towards the side away from the upper wall of the grass discharge chute 21h until the grass discharge chute 21h is closed to the maximum extent. In an embodiment, the first locking body 50h is rotatably connected to the handle 40h. There are multiple options for the rotatable connection method. For example, the first locking body 50h can be rotatably connected to the handle 40h through a rotation shaft, or a protruding column can be set on the handle 40h, and the first locking body 50h can have a pin hole, with the pin hole and the protruding column axle hole cooperating to achieve rotatable connection. In other embodiments, the first locking body 50h can also be rotatably connected to the baffle plate 30h. When the baffle plate 30h is in the open position, the first locking body 50h is engaged between the grass discharge chute 21h and the handle 40h, thereby achieving locking between the handle 40h and the grass discharge chute 21h to keep the baffle plate 30h in the open position.

Refer to FIG. 103 to FIG. 106. Along the length direction of the baffle 30h, the second locking body 60h is movably connected to the end of the baffle 30h away from the first locking body 50h. The movable connection can refer to the second locking body 60h being rotatably connected relative to the baffle 30h, or the second locking body 60h being horizontally slidably connected relative to the baffle 30h, or any combination of rotation and sliding connection. When the baffle 30h is in the closed position, the second locking body 60h cooperates with and presses against the wall of the grass discharge chute 21h, thereby achieving a locking connection between the baffle 30h and the grass discharge chute 21h to keep the baffle 30h in the closed position.

By setting up a handle 40h and a baffle 30h on the grass discharge chute 21h, and fixedly connecting the handle 40h with the baffle 30h, the baffle 30h can be rotated inside the grass discharge chute 21h by operating the handle 40h on the outside of the grass discharge chute 21h, achieving the opening or closing of the grass discharge chute 21h. This enables the conversion between grass collection and non-grass collection working modes of the lawn mower 120h. This structure is simple and convenient to operate, and during the conversion process, since there is no need to repeatedly disassemble and assemble components such as the baffle 30h, it can save time in switching between different working modes, further improving the working efficiency of the lawn mower 120h. At the same time, by setting up the first locking body 50h, an interlocking connection between the baffle 30h and the grass discharge chute 21h can be achieved to keep the baffle 30h in the open position. By setting up the second locking body 60h, the baffle 30h can cooperate with and press against the wall of the grass discharge chute 21h to keep the baffle 30h in the closed position. This arrangement can achieve locking of the baffle 30h relative to the grass discharge chute 21h in both closed and open positions, ensuring the stability of the baffle 30h in closing or opening the grass discharge chute 21h during the operation of the lawn mower 120h, thereby improving the stability of the lawn mower 120h's operational efficiency in different working modes.

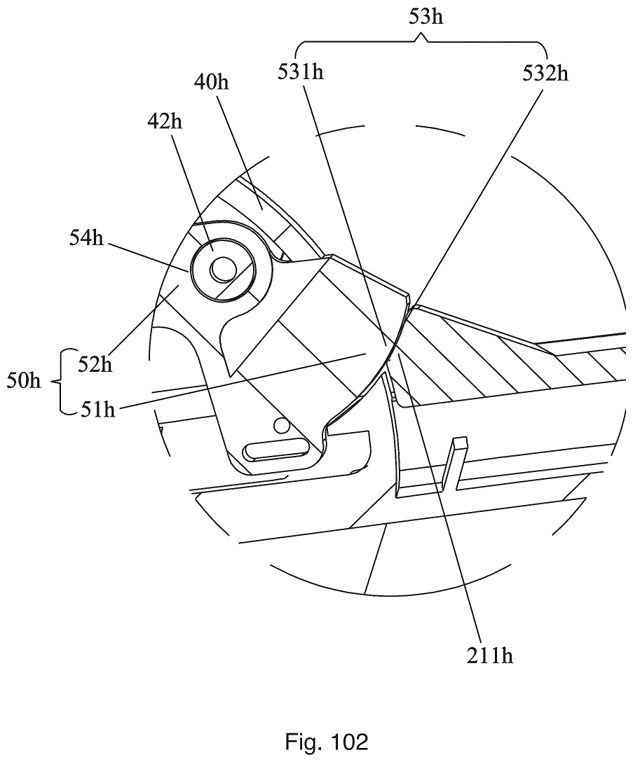

Referring to FIG. 102 to FIG. 105, in an embodiment of the lawn mower 100h, a first through-hole 54h is formed on the first locking body 50h. The direction of the first through-hole 54h can be consistent with the thickness direction of the first locking body 50h, or it can be set at an angle to the thickness direction of the first locking body 50h, among other directions. Preferably, in this embodiment, the first through-hole 54h penetrates through the thickness direction of the first locking body 50h and is consistent with the thickness direction of the first locking body 50h. A receiving cavity is formed on the handle 40h, and a protruding post 42h extending towards the interior of the receiving cavity is formed on the side wall of the handle 40h. The protruding post 42h is fitted through the first through-hole 54h, and the protruding post 42h rotates within the first through-hole 54h, achieving a rotational connection between the handle 40h and the first locking body 50h. The first locking body 50h includes a first pressing part 51h, which can be located inside the receiving cavity, outside the receiving cavity, or partly inside and partly outside the receiving cavity, among other configurations. Preferably, in this embodiment, referring to FIG. 101 and FIG. 102, the first pressing part 51h extends to the outside of the receiving cavity. A second pressing part 211h is provided on the side of the grass discharge chute 21h near the first locking body 50h, corresponding to the position of the first pressing part 51h. When the baffle 30h is in the open position, one end of the first pressing part 51h is pressed against the handle 40h, and the other end is pressed against the second pressing part 211h, thereby achieving relative fixation between the first locking body 50h, the handle 40h, and the grass discharge chute 21h to maintain the baffle 30h in the open position. Using this locking method, only rotating the first locking body 50h is needed to achieve fixation and release between the first locking body 50h, the handle 40h, and the grass discharge chute 21h, making operation convenient with a simple structure.

Referring to FIG. 103 to FIG. 105, in an embodiment of the lawn mower 100h, a first notch 43h is formed on the end of the handle 40h near the first pressing part 51h. The first pressing part 51h rotates within the first notch 43h, and the side wall of the first pressing part 51h slides along the side wall of the first notch 43h. A first stop 41h is formed on the bottom wall of the first notch 43h. When the first pressing part 51h is pressed against the second pressing part 211h, the side of the first pressing part 51h away from the second pressing part 211h is pressed against the first stop 41h. By providing the first stop 41h, a more stable and reliable pressing contact can be formed between the first locking body 50h, the handle 40h, and the grass discharge chute 21h, improving the stability of maintaining the baffle 30h in the open position. At the same time, because of the first notch 43h, it can also guide the rotation of the first locking body 50h, reducing lateral deviation during rotation, which can further improve the stability of the pressing contact between the first locking body 50h, the handle 40h, and the grass discharge chute 21h.

Please refer to FIG. 102, in an embodiment of the lawn mower 100h, when the first clamping part 51h and the second clamping part 211h are pressed against each other, the formed contact surface 53h is an arc-shaped contact surface 53h. The arc-shaped contact surface 53h includes a first contact surface 531h set on the first clamping part 51h and a second contact surface 532h set on the second clamping part 211h. Both the first contact surface 531h and the second contact surface 532h are coaxially arranged arc surfaces, and the axis of rotation of the arc surface coincides with the axis of the first through-hole 54h. When the first clamping part 51h and the second clamping part 211h are pressed against each other, the first contact surface 531h and the second contact surface 532h form an arc-shaped contact surface 53h, which can increase the contact area between the first clamping part 51h and the second clamping part 211h, thereby further enhancing the stability of the pressing contact between the first clamping part 51h and the second clamping part 211h.

Please refer to FIG. 101 to FIG. 105, in an embodiment of the lawn mower 100h, the first locking body 50h also includes a rotating arm 52h extending to the outside of the grass discharge tube 21h. The rotating arm 52h is fixedly connected to the first clamping part 51h, and the fixed connection method includes but is not limited to integral molding connection. The first through-hole 54h is located between the rotating arm 52h and the first clamping part 51h. The first through-hole 54h can be set on the rotating arm 52h or on the first clamping part 51h. Preferably, in this embodiment, the first through-hole 54h is set on the rotating arm 52h. The end of the rotating arm 52h away from the first through-hole 54h extends towards the outside of the grass discharge tube 21h, and there is an angle between the rotating arm 52h and the handle 40h along the circumferential direction of the first through-hole 54h. By setting the rotating arm 52h, changing the size of the angle between the rotating arm 52h and the handle 40h can achieve the pressing contact between the first clamping part 51h and the second clamping part 211h, making the rotation operation between the first locking body 50h and the handle 40h more convenient and effortless.

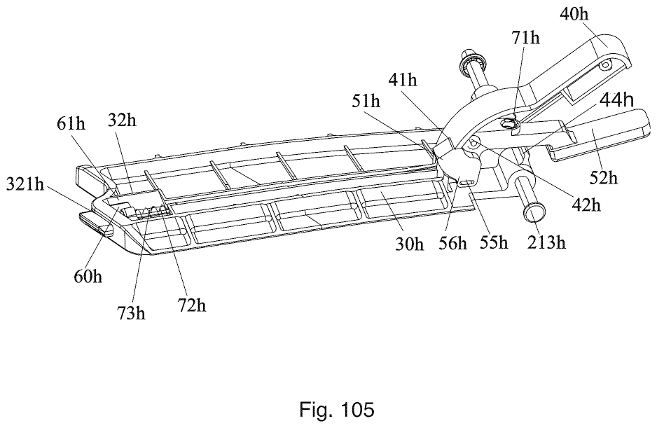

Refer to FIG. 105. In an embodiment of the lawn mower 100h, a first elastic reset member 71h is provided between the rotating arm 52h and the handle 40h. The first elastic reset member 71h can be any elastic reset member such as a tension spring, compression spring, leaf spring, or torsion spring, as long as it provides an elastic reset effect for the rotation between the rotating arm 52h and the handle 40h. In this embodiment, the first elastic reset member 71h is a compression spring. Along the compression direction of the compression spring, one end of the compression spring abuts against the rotating arm 52h, and the other end abuts against the handle 40h. When the first pressing portion 51h and the second pressing portion 211h are pressed against each other, the compression spring generates a supporting force between the handle 40h and the rotating arm 52h, causing the rotating arm 52h to move away from the handle 40h along the rotation direction, thereby generating a pre-pressing force between the first pressing portion 51h and the second pressing portion 211h, further enhancing the pressing force between the first pressing portion 51h and the second pressing portion 211h.

Refer to FIG. 101 and FIG. 105. Furthermore, the handle 40h is provided with a limiting portion 44h, which is located on the side of the rotating arm 52h away from the handle 40h along the rotation direction of the rotating arm 52h. The limiting portion 44h can be integrally formed with the handle 40h or fixed to the handle 40h by fasteners such as bolts. Preferably, in this embodiment, the limiting portion 44h is integrally formed with the handle 40h. The limiting portion 44h is located on the side of the first through-hole 54h away from the first pressing portion 51h. Under the action of the first elastic reset member 71h, at least a part of the rotating arm 52h on the side away from the handle 40h abuts against the limiting portion 44h. By providing the limiting portion 44h, the rotation angle of the rotating arm 52h can be limited, thereby restricting the pressing position of the first pressing portion 51h connected to the rotating arm 52h, ensuring stable pressing between the first pressing portion 52h and the second pressing portion 211h.

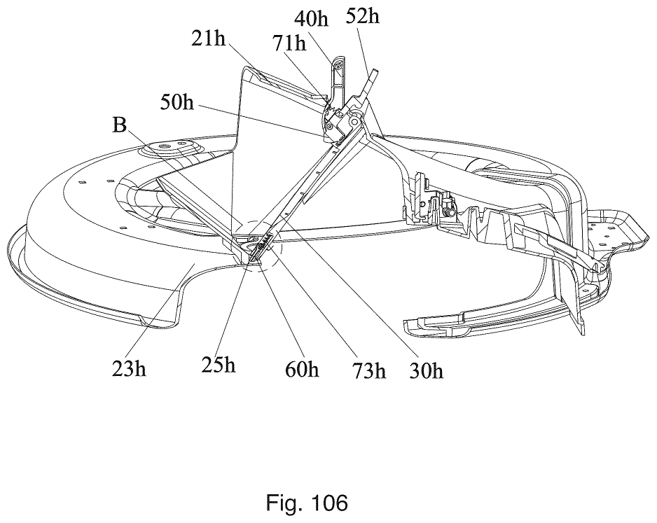

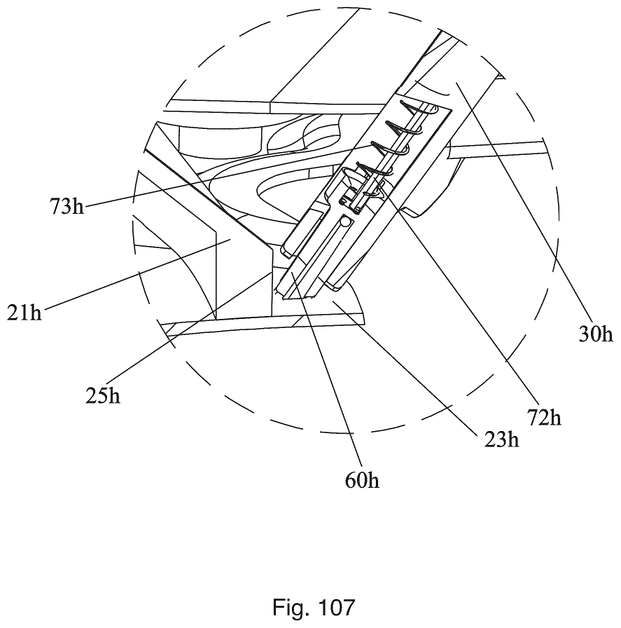

Please refer to FIG. 106 and FIG. 107. In an embodiment of the lawn mower 100h, a second slot 25h is provided at the connection between the grass discharge chute 21h and the housing 23h. The second locking member 60h is slidably connected to the baffle 30h and has an extended state that can engage with the second slot 25h and a retracted state that disengages from the second slot 25h. The specific cross-sectional shape of the second slot 25h is not limited, for example, it can be rectangular, triangular, or trapezoidal, as long as it can form an engaging and stopping effect on the inserted second locking member 60h. The second locking member 60h can be slidably connected to the baffle 30h through a rail-slider structure, or through a guide groove 32h and guide block structure, which is not specifically restricted. The extended state and retracted state of the second locking member 60h refer to the extension and retraction of the second locking member 60h along the length direction of the baffle 30h. When the baffle 30h needs to close the grass discharge chute 21h, press the rotating arm 52h to rotate it towards the side closer to the handle 40h, simultaneously driving the first pressing part 51h to rotate relative to the second pressing part 211h until the first pressing part 51h disengages from the second pressing part 211h, releasing the lock of the baffle 30h in the open position. Then rotate the handle 40h in the direction opposite to the arrow in FIG. 101, causing the handle 40h to drive the baffle 30h to rotate towards the lower wall of the grass discharge chute 21h until the baffle 30h rotates to the position of the second slot 25h. At this time, set the second locking member 60h to the extended state, engaging it into the second slot 25h, which can prevent the baffle 30h from shifting up and down during use, thereby keeping the baffle 30h in the closed position. When the baffle 30h needs to be released from the closed position, move the second locking member 60h again to set it to the retracted state, which will disengage the second locking member 60h from the slot, and rotating the baffle 30h can achieve the release of the baffle 30h from the closed position.

Please refer to FIG. 105, in an embodiment of the lawn mower 100h, a movement guiding structure is provided between the baffle 30h and the second locking body 60h to guide the movement between the second locking body 60h and the baffle 30h. The movement guiding structure can be of various types. For example, the movement guiding structure can be a sliding rail set on the baffle 30h with a sliding block set at the corresponding position of the second locking body 60h. When the second locking body 60h moves relative to the baffle 30h, the sliding block slides along the sliding rail, thus providing a guiding effect. It can also be a guide groove 32h machined on the baffle 30h with a guide block installed at the corresponding position of the second locking body 60h. When the second locking body 60h moves relative to the baffle 30h, the guide block slides along the guide groove 32h, thus providing a guiding effect. By setting up the movement guiding structure, the probability of lateral offset during the relative movement of the second locking body 60h and the baffle 30h can be reduced, thereby improving the positional accuracy of the extended and retracted states of the second locking body 60h, while also reducing the probability of jamming during the movement of the second locking body 60h relative to the baffle 30h.

Please refer to FIG. 105, in an embodiment of the lawn mower 100h, the movement guiding structure includes a guide groove 32h set on the baffle 30h and a guiding part 61h set on the second locking body 60h, with the guiding part 61h sliding along the guide groove 32h. Specifically, along the thickness direction of the baffle 30h, the guide groove 32h is located on the side of the baffle 30h facing the upper wall of the grass discharge chute 21h, and the guide groove 32h is an approximately rectangular groove structure with an open front end. A snap-fit opening 321h is formed at the front end of the guide groove 32h, and the second locking body 60h is installed in the guide groove 32h through the snap-fit opening 321h. The width dimension of the guide groove 32h matches the width dimension of the second locking body 60h, and guiding parts 61h are formed on both sides of the second locking body 60h in the width direction, with the guiding parts 61h on both sides sliding along the side walls of the guide groove 32h. In other embodiments, the guide groove 32h can also be set on the second locking body 60h and the guiding part 61h can be set on the baffle 30h, with the guiding part 61h sliding along the guide groove 32h, which can also provide a guiding effect.

Refer to FIG. 105. In an embodiment of the lawn mower 100h, the first locking body 50h is connected to the second locking body 60h through a connecting member 72h. The first locking body 50h rotates relative to the handle 40h to pull the second locking body 60h to slide within the baffle 30h. The first locking body 50h includes a connecting portion 56h, which is on the same side of the first through-hole 54h as the first pressing portion 51h, and is located below the first pressing portion 51h on the side closer to the baffle 30h. One end of the connecting member 72h is rotatably connected to the connecting portion 56h. The rotatable connection can be achieved by providing an installation hole in the connecting portion 56h, with the end of the connecting member 72h rotatably installed in the installation hole. Alternatively, an installation hole can be provided at the end of the connecting member 72h, with a pin installed at the corresponding position of the connecting portion 56h, rotatably connected within the installation hole. The other end of the connecting member 72h is fixedly connected to the second locking body 60h. The fixed connection method is not limited and can be a snap-fit connection or a bolt connection, etc. The specific structure of the connecting member 72h is not limited and can be a metal wire structure, a profile member, or a plastic rod, etc., as long as it can pull the second locking body 60h to slide relative to the baffle 30h when the first locking body 50h rotates relative to the handle 40h. By setting up the connecting member 72h, the operator can rotate the first locking body 50h to drive the connecting portion 56h to rotate, thereby pulling the connecting member 72h to move, which in turn pulls the second locking body 60h to slide within the baffle 30h. This structure is simple and easy to operate.

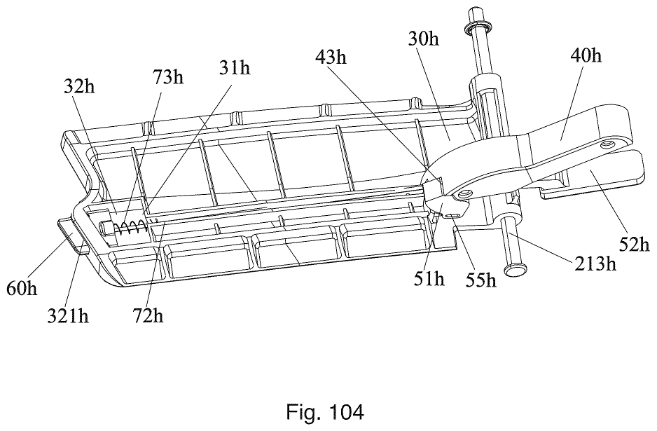

Refer to FIG. 104 and FIG. 105. In an embodiment of the lawn mower 100h, the connecting member 72h has a metal wire structure. A slot 55h is formed in the connecting portion, and one end of the connecting member 72h is hooked into the slot 55h, while the other end is threadedly connected to the second locking body 60h. Along the length direction of the baffle 30h, a second stop portion 31h is set at the end of the guide slot 32h away from the second locking body 60h. A second elastic reset member 73h is set between the second stop portion 31h and the second locking body 60h. When the connecting member 72h is in a tightened state, i.e., when the second locking body 60h is in a retracted state, the second elastic reset member 73h stores elastic potential energy. When the connecting member 72h is in a relaxed state, i.e., when the second locking body 60h is in an extended state, the second elastic reset member 73h releases elastic potential energy. The second elastic reset member 73h can be a compression spring, tension spring, or torsion spring, etc. In this embodiment, the second elastic reset member 73h is a compression spring, fitted over the exterior of the connecting member 72h, with one end abutting against the second stop portion 31h and the other end abutting against the second locking body 60h. When the rotating arm 52h rotates towards the side closer to the handle 40h, the connecting member 72h is tightened, thereby pulling the second locking body 60h to retract, and the second elastic reset member 73h is compressed to store elastic potential energy. When the rotating arm 52h rotates towards the side away from the handle 40h, the connecting member 72h returns to a relaxed state, and the second locking body 60h returns to an extended state under the action of the elastic potential energy of the second elastic reset member 73h.

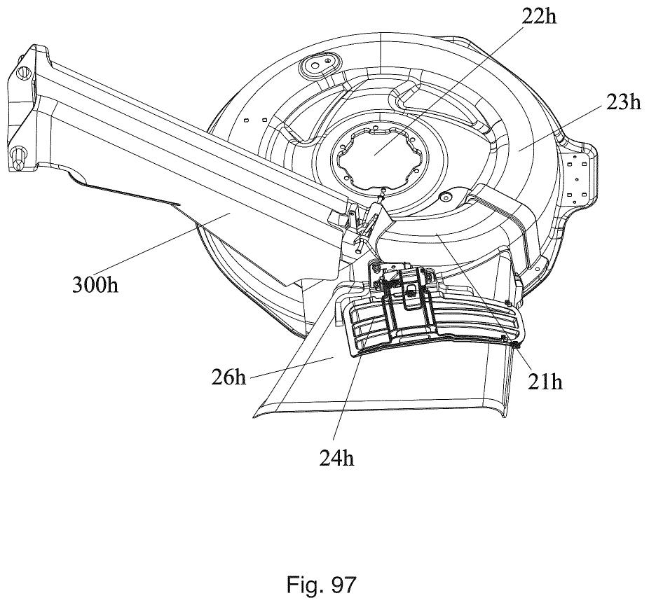

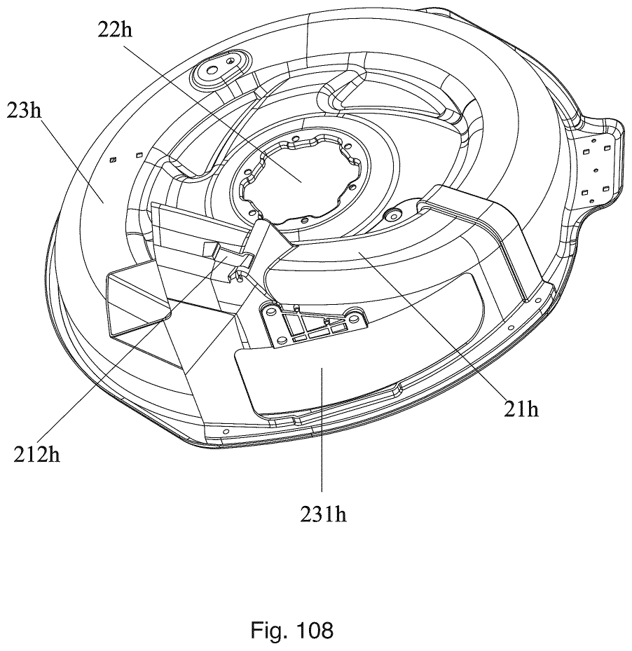

Generally, the bottom of the mowing chamber 22h is an open structure. During the mowing operation of the lawn mower 100h, grass clippings after cutting can be directly discharged to the working surface through the opening at the bottom of the mowing chamber 22h. However, preferably, referring to FIG. 97, FIG. 98 and FIG. 108, in an embodiment of the lawn mower 100h, the side wall of the housing 23h is also provided with a side discharge port 231h, which is in communication with the mowing chamber 22h. The size and specific shape of the side discharge port 231h are determined by the specific grass discharge requirements of the lawn mower 100h, which are not specifically limited here. In this embodiment, the opening position of the side discharge port 231h on the housing 23h is close to the position of the grass discharge tube 21h. In other embodiments, it can also be opened in other positions. Preferably, referring to FIG. 97 to FIG. 99, in this embodiment, a shield cover 26h and a side baffle 24h are also provided at the position of the side discharge port 231h. The shield cover 26h is fixedly connected to the housing 23h above the side discharge port 231h by means of, but not limited to, bolts. The shield cover 26h extends in a direction away from the outer side wall of the housing 23h to form a certain degree of shielding above the side discharge port 231h, thereby reducing the probability of grass clippings and dust scattering during the discharge of grass clippings from the side discharge port 231h, thus reducing dust generation during grass discharge. The side baffle 24h is rotatably connected to the housing 23h above the side discharge port 231h, and the side baffle 24h can open or close the second grass discharge port.

In an embodiment, when the lawn mower 100h needs to perform grass collection operations, assuming the baffle 30h is initially in the closed position. At this time, rotate the rotating arm 52h towards the side closer to the handle 40h, causing the connecting member 72h to be tightened, which in turn pulls the second locking body 60h to retract, disengaging the second locking body 60h from the second notch 25h, while both the first elastic reset member 71h and the second elastic reset member 73h are compressed. Then, rotate the handle 40h in the direction indicated by the arrow in FIG. 101, causing the handle 40h to drive the baffle 30h to rotate upwards until the baffle 30h maximally opens the grass discharge chute 21h. At this point, release the rotating arm 52h, and under the action of the first elastic reset member 71h, the rotating arm 52h rotates away from the handle 40h until it abuts against the limiting portion 44h, while driving the first clamping portion 51h to gradually engage from bottom to top between the second clamping portion 211h and the first stop portion 41h of the handle 40h, until finally the first locking body 50h, grass discharge chute 21h, and handle 40h are interlocked and fixed, thereby maintaining the baffle 30h in the open position. When the lawn mower 100h does not need to perform grass collection operations, rotate the rotating arm 52h again towards the side closer to the handle 40h, disengaging the first clamping portion 51h from the second clamping portion 211h. Subsequently, rotate the handle 40h in the direction opposite to the arrow in FIG. 101, causing the handle 40h to drive the baffle 30h to rotate downwards until the baffle 30h rotates to the position of the second notch 25h. At this point, release the rotating arm 52h, and under the action of the first elastic reset member 71h, the rotating arm 52h rotates away from the handle 40h, allowing the connecting member 72h to return to a relaxed state. The second locking body 60h, under the elastic potential energy of the second elastic reset member 73h, returns to the extended state, engaging into the second notch 25h, thereby maintaining the baffle 30h in the closed position. This process can be repeated to achieve the conversion of the baffle 30h between open and closed states.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings.

The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

1. A lawn mower apparatus, comprising:
a frame;
a cutting deck, wherein the cutting deck is mounted on the frame, wherein the cutting deck forms a grass cutting chamber internally, wherein the grass cutting chamber has a first grass discharge opening;
a cutting blade, wherein the cutting blade is rotatably mounted within the grass cutting chamber for performing grass cutting operations; and
a switching mechanism, wherein the switching mechanism is mounted on the cutting deck, wherein the switching mechanism has a first state and a second state, wherein in the first state, the switching mechanism closes the first grass discharge opening to prevent grass clippings from discharging through the first grass discharge opening, wherein in the second state, the switching mechanism opens the first grass discharge opening to allow grass clippings to discharge through the first grass discharge opening for grass collection operations.

2. The lawn mower apparatus of claim 1, wherein the switching mechanism comprises a baffle plate and a rotating shaft, wherein the rotating shaft is rotatably mounted on the cutting deck, wherein the baffle plate is fixedly connected to the rotating shaft, wherein when rotated to a first position, the baffle plate blocks the first grass discharge opening, wherein when rotated away from the first position, the baffle plate opens the first grass discharge opening.

3. The lawn mower apparatus of claim 2, wherein a positioning structure is provided between the baffle plate and the first grass discharge opening.

4. The lawn mower apparatus of claim 2, wherein the switching mechanism further comprises a handle, wherein the handle is located on an outer wall of the first grass discharge opening, wherein the handle is fixedly connected to the rotating shaft.

5. The lawn mower apparatus of claim 4, wherein the switching mechanism further comprises a first limiting portion, wherein when the baffle plate is in the first position, the handle abuts against the first limiting portion to prevent the baffle plate from leaving the first position.

6. The lawn mower apparatus of claim 4, wherein the switching mechanism further comprises a second limiting portion, wherein a supporting portion is provided at the first grass discharge opening, wherein when the baffle plate is in a second position, the baffle plate abuts against the supporting portion, wherein the handle abuts against the second limiting portion to limit the baffle plate in the second position.

7. The lawn mower apparatus of claim 4, wherein the handle comprises a first connecting portion and a second connecting portion, wherein one end of the first connecting portion is fixedly connected to the rotating shaft, wherein the second connecting portion is foldably connected to another end of the first connecting portion.

8. The lawn mower apparatus of claim 7, wherein an elastic member is provided between the first connecting portion and the second connecting portion, wherein the elastic member provides a supporting force when the second connecting portion is opened relative to the first connecting portion.

9. The lawn mower apparatus of claim 1, wherein the cutting deck further has a second grass discharge opening, wherein the second grass discharge opening is in communication with the grass cutting chamber.

10. The lawn mower apparatus of claim 1, wherein the second part is electrically connected to a plug-in terminal.

11. The lawn mower apparatus of claim 10, wherein a first support plate is provided on the steering wheel bracket, wherein the plug-in terminal is detachably mounted on the first support plate.

12. The lawn mower apparatus of claim 1, wherein the steering wheel is connected to the steering wheel bracket through a steering wheel shaft, wherein the steering wheel shaft is fixedly connected to the steering wheel, wherein a wire harness fixing frame is provided on the steering wheel shaft.

13. The lawn mower apparatus of claim 1, wherein a support frame is fixedly mounted on the steering wheel bracket, wherein the second part is positioned above the support frame and abuts against a top wall of the support frame.

14. The lawn mower apparatus of claim 13, wherein an elongated hole is provided on a top portion of the support frame, wherein the second part has a mounting portion with a mounting hole, wherein the mounting hole is connected to the elongated hole through a connecting member.

15. The lawn mower apparatus of claim 14, wherein a side of the mounting hole penetrates through a side wall of the mounting portion to accommodate position adjustment of the connecting member within the mounting hole.

16. The lawn mower apparatus of claim 1, wherein the display component comprises a display screen, wherein display icons showing the status of the lawn mower apparatus are provided on the display screen.

17. The lawn mower apparatus of claim 16, wherein the display component comprises control buttons provided around the periphery of the display screen.

18. The lawn mower apparatus of claim 1, wherein the switching mechanism comprises a baffle plate, a handle, and a locking component, wherein the baffle plate is rotatably mounted within the cutting deck and has a first position that opens the first grass discharge opening and a second position that closes the first grass discharge opening, wherein the handle is rotatably mounted on an outer wall of the cutting deck and drives the baffle plate to rotate, wherein the locking component is provided on the baffle plate and/or the cutting deck and locks the baffle plate in the first position and the second position respectively.

19. The lawn mower apparatus of claim 18, wherein a first opening and a cover plate are provided on the cutting deck, wherein the first opening is in communication with the first grass discharge opening, wherein the baffle plate is positioned below the first opening, wherein the cover plate is capable of covering the first opening.
